(19) United States
(12) Patent Application Publication
(10) Pub. No.: US 2009/0145398 A1
(43) Pub. Date: Jun. 11, 2009

(54) INTERNAL COMBUSTION ENGINES WITH SURCHARGING AND SUPRAIGNITION SYSTEMS

(76) Inventor: ZOLTAN A. KEMENY, Tempe, AZ (US)

Correspondence Address: MICHAEL WINFIELD GOLTRY, 4000 N. CENTRAL AVENUE, SUITE 1220, PHOENIX, AZ, 85012, US

(21) Appl. No.: 12/266,895

(22) Filed: Nov. 7, 2008

Related U.S. Application Data
(60) Provisional application No. 60/986,323, filed on Nov. 8, 2007.
(60) Provisional application No. 61/027,585, filed on Feb. 11, 2008.
(60) Provisional application No. 61/068,818, filed on Mar. 11, 2008.

(51) Int. Cl. F02B 47/02; F02M 25/07

(52) U.S. Cl. 123/25 C; 123/568.11; 123/52.1

(57) ABSTRACT

An internal combustion engine includes first and second cylinder assemblies each to repeatedly carry out a combustion cycle including intake, compression, combustion, and exhaust processes. In a surcharging system of the invention, the first cylinder assembly is coupled to the second cylinder assembly in gaseous communication to apply a charge of exhaust gas produced from a first combustion cycle of the first cylinder assembly to a compression process of a second combustion cycle of the second cylinder assembly. In a supraignition system of the invention, the first cylinder assembly is coupled to the second cylinder assembly in gaseous communication to apply a charge of ignition gas produced from a first combustion cycle of the first cylinder assembly to a compression process of a second combustion cycle of the second cylinder assembly. Buffer vessels coupled in gaseous communication with corresponding cylinder assemblies are also used in surcharging and supraignition processes.

### FIELD OF THE INVENTION

This invention relates to internal combustion engines and, more particularly, to systems and methods for improving the efficiency of the combustion cycles of piston assemblies of internal combustion engines.

### BACKGROUND OF THE INVENTION

Gasoline and diesel internal combustion engines utilize the exothermic chemical process of combustion of an ignition gas in the form of an air-fuel mixture to act against a reciprocating piston in a combustion chamber of a cylinder of a cylinder or piston assembly to impart rotation to a crank shaft operatively coupled to the piston. Almost all vehicle engines utilize a four-process, or four-stroke combustion cycle to convert fuel into motion, which includes the intake process or stroke, the compression process or stroke, the expansion or combustion process or stroke, and the exhaust process or stroke. The expansion or combustion process or stroke is the power process or stroke of the combustion cycle.

In a four-stroke gasoline engine, the combustion cycle begins with the piston at the top of the cylinder defining the minimum volume of the combustion chamber in the cylinder. At this starting position, the piston moves from the top of the cylinder to the bottom of the cylinder to intake ignition gas, which is the intake process or intake stroke. When the piston is at the bottom of its intake stroke and the end of the intake process, the volume of the combustion chamber in the cylinder is maximized and is filled with a charge of ignition gas. At the bottom of the intake stroke or process, the piston commences the compression stroke or process moving from the bottom of the cylinder to the top of the cylinder defining the minimum volume of the combustion chamber in the cylinder compressing the charge of ignition gas in the combustion chamber of the cylinder. When the piston reaches the top of its compression stroke completing the compression process, the compressed charge of ignition gas is ignited with a spark from a spark plug, and the resulting explosion acts against the piston initiating the combustion stroke or process driving the piston down in the combustion stroke or process of the piston from the top of the cylinder to the bottom of the cylinder. When the piston reaches the bottom of its combustion stroke to complete the combustion stroke or process at the bottom of the cylinder defining the maximum volume of the combustion chamber, the combustion chamber is filled with exhaust gas and the piston commences the exhaust stroke or process moving from the bottom of the cylinder to the top of the cylinder to exhaust the exhaust gas from the cylinder into the exhaust system or tailpipe, at which point the intake stroke or process of the next four-stroke cycle commences and this process continues as before. Accordingly, in a gasoline engine, fuel is mixed with air to form ignition gas, which is compressed by pistons and ignited by sparks from spark plugs. Diesel engines also utilize this four-stroke four-process combustion cycle. In a diesel engine, however, the air is compressed first, and then the fuel is injected. Because air heats up when compressed, the fuel ignites when it is injected into the cylinder. Two-stroke engines also operate under the four-process combustion cycle consisting of the intake, compression, combustion, and exhaust processes, but only through two strokes of the piston rather than four strokes as in a conventional four-stroke engine. Some engines, such as Seiliger or Sabathe engines, utilize a dual or mixed combustion cycle, which is a thermal cycle that is a combination of the Otto cycle and the Diesel cycle.

The measure of engine efficiency usually involves a comparison of the total chemical energy in the fuel, and the useful energy abstracted from the fuel in the form of kinetic energy. The most fundamental and abstract discussion of engine efficiency is the thermodynamic limit for abstracting energy from the fuel defined by a thermodynamic cycle. The most comprehensive is the empirical fuel economy of the total engine system for accomplishing a desired task.

Internal combustion engines are primarily heat engines. As such, the phenomenon that limits their efficiency is described by the thermodynamic cycles. None of these cycles exceed the limit defined by the Carnot cycle, which states that the overall thermal efficiency is dictated by the difference between the lower and upper operating temperatures of the engine. A terrestrial engine is usually and fundamentally limited by the upper thermal stability derived from the material used to make up the engine. All metals and metal alloys eventually melt or decompose and there is significant researching into ceramic materials that can be made with higher thermal stabilities and desirable structural properties. Higher thermal stability allows for greater temperature difference between the lower and upper operating temperatures, thus greater thermodynamic efficiency.

The thermodynamic limits assume that the engine is operating in ideal conditions. Engines run best at specific loads and rates as described by their power curve. For example, a car cruising on a highway is usually operating significantly below its ideal load, because the engine is designed for the higher loads desired for rapid acceleration. The applications of engines are used as contributed drag on the total system reducing overall efficiency, such as wind resistance designs for vehicles. These and many other losses result in the actual fuel economy of the engine that is usually measured in the units of miles per gallon or kilometers per liter for automobiles. The distance traveled for each gallon of fuel consumed represents a meaningful amount of work and the volume of hydrocarbon implies a standard energy content. Most internal combustion engines have a thermodynamic limit of approximately 40%. Even when aided with turbochargers and stock efficiency aids, most engines retain an average efficiency of about 18%-20%.

Many attempts have been made to increase the efficiency of internal combustion engines. In general, practical engines are always compromised by trade-offs between different properties such as efficiency, weight, power, heat, response, exhaust emissions, or noise. Sometimes economy also plays a role in not only in the cost of manufacturing the engine itself, but also manufacturing and distributing the fuel. Increasing the engines' efficiency brings better fuel economy but only if the fuel cost per energy content is the same.

Although skilled artisans have devoted considerable research and development resources toward systems designed to reduce fuel consumption and fuel combustion emissions in internal combustion engines, little if any attention has been directed toward simply toward improving the combustion cycle in order to improve engine efficiency, reduce harmful fuel consumption, and reduce fuel combustion emissions.

### SUMMARY OF THE INVENTION

It is an object of the present invention to improve the fuel combustion, thermodynamic efficiency, and power output of the combustion cycle of the cylinder or piston assemblies of an internal combustion engine to obtain more usable work from the engine utilizing surcharging and supraignition systems and methods constructed and arranged in accordance with the principle of the invention by harvesting the engine's exhaust gas and ignition gas between cylinder assembles for pressure, heat, and combustion dilution to improve the combustion cycle. Surcharging is a special form of internal turbocharging which does not alter charging properties. Supraignition is a form of homogeneous compression ignition, or a mechanically triggered volumetric ignition.

In first and second cylinder assemblies of an internal combustion engine each to repeatedly carry out a combustion cycle including intake, compression, combustion, and exhaust processes, improvements therein according to the principle of the invention include the first cylinder assembly coupled to the second cylinder assembly in gaseous communication to apply a charge of exhaust gas produced from a first combustion cycle of the first cylinder assembly to a compression process of a second combustion cycle of the second cylinder assembly. This process is exhaust gas surcharging or bypass exhaust gas surcharging. In another embodiment, the improvements include the first cylinder assembly coupled to the second cylinder assembly in gaseous communication to apply a charge of ignition gas from the first cylinder assembly produced during a first combustion cycle of the first cylinder assembly to a compression and/or combustion process of a second combustion cycle of the second cylinder assembly. This process is ignition gas surcharging, supraignition, bypass ignition gas surcharging, or bypass supraignition.

In a cylinder assembly of an internal combustion engine to repeatedly carry out a combustion cycle including intake, compression, combustion, and exhaust processes, improvements therein according to the principle of the invention include a buffer vessel coupled in gaseous communication with the cylinder assembly to receive and retain a charge of exhaust gas produced from a first combustion cycle of the first cylinder assembly, and apply the retained charge of exhaust gas to the compression process of a second combustion cycle of the cylinder assembly. This process is another embodiment of exhaust gas surcharging consisting of buffered exhaust gas surcharging of buffered surcharging. A buffer vessel used in buffered exhaust gas surcharging may be referred to as a surcharging buffer or surcharging buffer vessel. In another embodiment, the improvements a buffer vessel coupled to the cylinder assembly in gaseous communication to receive and retain a charge of ignition gas produced from a first combustion cycle of the cylinder assembly, and apply the retained charge of ignition gas to the compression and/or combustion process of a second combustion cycle of the cylinder assembly. This process is another embodiment of ignition gas surcharging or supraignition, namely, buffered supraignition. A buffer vessel used in buffered supraignition may be referred to as a supraignition buffer or supraignition buffer vessel.

It is an object of the present invention to alter the combustion cycle of an internal combustion engine, to improve fuel combustion and thermal efficiency to gain more usable work from the engine. According to the principle of the invention, surcharging burns un-combusted gas in exhaust gas, including retained warm exhaust gas, produced from an initial combustion stroke to effectively reduce the exhaust gas, such as by approximately 50% or more. The invention also provides internal automatic volume ignition timed by one or more valves, without spark or hot rod, utilizing hot retained exhaust gas from a previous or adjacent combustion cycle, all without the use of an electromechanical control system or external regulation. Furthermore, low pressure fuel injection provided at a surcharging cite provides improved combustion by ensuring surface ignition, in accordance with the principle of the invention. A buffer pressure assist system is also provided, which provides choking and boosting, in addition to a fuel sweat-smolder ignition and rotary sleeve valve stacking. Also, water injection is provided to gain more power and to cool exhaust gases to cool the engine to increase the thermal efficiency of the engine. Ionization of retained hot exhaust gas in a buffer chamber is provided to at least partially convert the retained hot exhaust gas to a plasma, which ignites even more effectively.

Engine modifications made according to the principle of the invention produce an engine that is less noisy and that runs cooler as compared to conventional internal combustion engines, and that provides skilled artisans with a platform from which various design choices may be made. An engine formed with modifications according to the invention can run on any liquid fuel or gaseous fuel without significant adjustments, and are approximately 15-75% more efficient than their unmodified counterpart engines, and emit approximately 50-99% less environmentally harmful exhaust gases, all without reductions in engine torque, engine power, and overall engine performance.

When water injection is used according to the principle of the invention, without recycling any condensation in part, engine efficiency is further increased on the order of approximately 15-30%. Moreover, the provision of water injection cleans from the engine soot and other particulate by-products produced from fuel combustion. Modifications relating to water injection are such that engine corrosion is prevented, and steam produced is prevented from contacting lubricating engine oil. If desired, alcohol may be added to the water prior to injecting into the engine to prevent the water from freezing in cold environments. In any case, water and alcohol are consumable or secondary fuels.

Engine modifications made according to the principle of the invention do not add significantly to the overall engine weight, including new engine construction incorporating improvements according to the principle of the invention, and engines retrofitted with improvements according to the principle of the invention, and no specialized skill is required to incorporate the improvements with new and retrofit engines. Moreover, introduction of the improvements according to the principle of the invention is smooth and quick, both with new engine construction and retrofit engines. Most of the engine modifications relating to exhaust gas and ignition gas surcharging, including supraignition, involve adding ports in cylinder walls, adding and positioning valves in specific locations and incorporating specified manifolds, pipes, conduits and/or chambers, all of which are discussed infra.

Low pressure fuel injection upon bypassing or buffering forming an exemplary embodiment of the invention also contributes to increased engine efficiency and improved combustion efficiency. To accommodate peak engine performance, a solution of alcohol and water utilized in an injecting system according to the principle of the invention is implemented. Fuel sweating smoldering ignition is also provided according to the principle of the invention, in addition to ionization of the jet-gas in a buffer to improve ignition and fuel combustion, including fuel combustion quality and speed. Further, keyed stack sleeve rotary valve technology is introduced to facilitate building exemplary embodiments of the invention.

Engines constructed in accordance with the principle of the invention are nimble and flexible and powerful, are efficient, provide exemplary torque, and are highly reliable and have no turbo lag, are fuel efficient, emit clean exhaust, and run cool and quiet.

### BRIEF DESCRIPTION OF THE DRAWINGS

Referring to the drawings:

FIG. 1 is a schematic diagram of an exhaust gas bypass surcharging system including pairs of cylinder assemblies of an internal combustion engine, each of the pairs of cylinder assemblies coupled in gaseous communication to provide exhaust gas bypass surcharging therebetween in accordance with the principle of the invention;

FIG. 2 is a schematic diagram of the system of FIG. 1 constructed with fuel injection features;

FIG. 3 is a schematic diagram of the system of FIG. 1 constructed with water injection features;

FIGS. 4A and 4B are schematic diagrams of stages of operation of a single cylinder exhaust gas buffer bypass surcharging system of an internal combustion engine constructed and arranged in accordance with the principle of the invention;

FIGS. 5A and 5B are schematic diagrams of stages of operation of the system of FIGS. 4A and 4B constructed with fuel injection features;

FIGS. 6A and 6B are schematic diagrams of stages of operation of the system of FIGS. 4A and 4B constructed with water injection features;

FIG. 7 is a schematic diagram of a single cylinder exhaust gas buffer bypass surcharging system of an internal combustion engine, with an adjustable volume buffer vessel, constructed and arranged in accordance with the principle of the invention

FIG. 8 is a schematic diagram of single cylinder exhaust gas buffer bypass surcharging system of an internal combustion engine constructed and arranged in accordance with the principle of the invention;

FIG. 9 is a schematic diagram of a single cylinder exhaust gas buffer bypass surcharging system of an internal combustion engine, with an adjustable volume buffer vessel, constructed and arranged in accordance with the principle of the invention;

FIG. 10 is a fragmented schematic diagram of a venturi-injection buffer bypass supercharging system constructed and arranged in accordance with the principle of the invention;

FIG. 11 is a fragmented schematic diagram of a ball valve at a ported bypass constructed and arranged in accordance with the principle of the invention;

FIG. 12 is a schematic diagram of a valve controlled cylinder interconnect exhaust gas bypass surcharging system of an internal combustion engine constructed and arranged in accordance with the principle of the invention;

FIG. 13 is a schematic diagram of the system of FIG. 12 constructed with fuel injection features;

FIG. 14 is a schematic diagram of the system of FIG. 12 constructed with water injection features;

FIGS. 15A and 15B are schematic diagrams of stages of operation of a valve controlled single cylinder exhaust gas buffer bypass surcharging system of an internal combustion engine constructed and arranged in accordance with the principle of the invention;

FIGS. 16A and 16B are schematic diagrams of the system of FIGS. 15A and 15B constructed with fuel injection features;

FIGS. 17A and 17B are schematic diagrams of the system of FIGS. 15A and 15B constructed with water injection features;

FIG. 18 is a schematic diagram of a valve controlled cylinder interconnect ignition gas bypass surcharging system of an internal combustion engine constructed and arranged in accordance with the principle of the invention;

FIG. 19 is a schematic diagram of a valve controlled cylinder interconnect exhaust gas bypass surcharging system of an internal combustion engine constructed and arranged in accordance with the principle of the invention;

FIG. 20 is a schematic diagram of the system of FIG. 19 constructed with catalytic converter and fuel and water injection systems;

FIG. 21 is a schematic diagram of a valve controlled cylinder interconnect ignition gas bypass surcharging system of an internal combustion engine constructed and arranged in accordance with the principle of the invention;

FIGS. 22A and 22B are schematic diagrams of stages of operation of a single cylinder valve controlled ignition gas buffer bypass surcharging system of an internal combustion engine constructed and arranged in accordance with the principle of the invention;

FIGS. 23 is a schematic diagram of the system of FIGS. 22A and 22B constructed with fuel and water injection features;

FIG. 24 is a schematic diagram of the system of FIGS. 22A and 22B constructed with an adjustable volume ignition buffer vessel;

FIGS. 25A and 25B are schematic diagrams of a single cylinder valve controlled exhaust gas and ignition gas buffer bypass surcharging system of an internal combustion engine constructed and arranged in accordance with the principle of the invention;

FIG. 26 is a schematic diagram of a cylinder interconnect valve controlled exhaust gas and ignition gas buffer bypass surcharging system of an internal combustion engine constructed and arranged in accordance with the principle of the invention;

FIG. 27 is a schematic diagram of a buffer choking assembly constructed and arranged in accordance with the principle of the invention;

FIG. 28 is a schematic diagram of an alternate embodiment of a buffer choking assembly constructed and arranged in accordance with the principle of the invention;

FIG. 29 is a schematic diagram of yet a further embodiment of a buffer choking assembly constructed and arranged in accordance with the principle of the invention;

FIG. 30 is a schematic diagram of smolder plug assembly constructed and arranged in accordance with the principle of the invention;

FIG. 31 is a schematic diagram of an ionized ignition gas buffer assembly constructed and arranged in accordance with the principle of the invention;

FIG. 32 is a schematic diagram of another embodiment of ionized ignition gas buffer assembly constructed and arranged in accordance with the principle of the invention;

FIG. 33 is a schematic representation of a valve insert constructed and arranged in accordance with the principle of the invention;

FIG. 34 is a schematic representation of another embodiment of a valve insert constructed and arranged in accordance with the principle of the invention;

FIG. 35 is a schematic representation valve insert stack assembly of the valve inserts of FIGS. 33 and 34;

FIG. 36 is a perspective view of yet another embodiment of a valve insert constructed and arranged in accordance with the principle of the invention;

FIG. 37 is a perspective view of yet a further embodiment of a valve insert constructed and arranged in accordance with the principle of the invention;

FIG. 38 is a schematic diagram of surcharge manifold assembly incorporated with a cylinder assembly of an internal combustion engine;

FIG. 39 is a schematic representation of a rotary valve surcharge assembly of the surcharge manifold assembly of FIG. 38;

FIG. 40 is a graphical representation illustrating a comparison between a diagram of a constant volume ignition pressure vs. volume (P-V) Otto cycle of a spark ignition engine, and a diagram of a pressure vs. volume (P-V) Seiliger cycle of operation of the same engine modified with ignition gas surcharging and exhaust gas surcharging according to the principle of the invention;

FIG. 41 is a diagrammatic illustration of a surcharging system including a heat pump operatively coupled between surcharging and ignition vessels;

FIG. 42 is a diagrammatic illustration of a cylinder head system of an internal combustion engine with a nested surcharging and ignition chamber constructed and arranged in accordance with the principle of the invention;

FIG. 43 is a sectional view taken along line 43-43 of FIG. 42;

FIG. 44 is a sectional view taken along line 44-44 of FIG. 43;

FIG. 45 is a sectional view taken along line 45-45 of FIG. 44;

FIG. 46 is a pressure vs. volume (P-V) diagram illustrating fuel consumption characteristics of an internal combustion engine modified with surcharging according to the teachings of the invention;

FIG. 47 is a pressure vs. volume (P-V) diagram of performance characteristics of a diesel engine modified with surcharging according to the principle of the invention;

FIG. 48 is a schematic diagram of a manifold cylinder assembly constructed and arranged in accordance with the principle of the invention;

FIG. 49 is a schematic top plan view of the manifold cylinder assembly of FIG. 48;

FIG. 50 is a schematic top plan view of a modified cam assembly to provide short duration surcharge and gas ignition valve openings;

FIG. 51 is a schematic side view of the modified cam assembly of FIG. 50;

FIG. 52 is a diagram of cylinder pressure-to-crank or pressure vs. crank angle of a preferred embodiment with surcharging, gas ignition, and direct injection;

FIG. 53 is a pressure vs. volume (P-V) diagram of a surcharging process according to the principle of the invention;

FIG. 54 is a schematic diagram of a surcharge or gas-ignition valve constructed and arranged in accordance with the principle of the invention;

FIG. 55 is a sectional view taken along line 55-55 of FIG. 54;

FIG. 56 is a schematic representation of a buffer chamber assembly with a hydrogenating and/or oxygenating system, constructed and arranged in accordance with the principle of the invention;

FIG. 57 is a schematic representation of a buffer chamber assembly with a steam electrolysis or thermolysis system, constructed and arranged in accordance with the principle of the invention;

FIG. 58A is a prior art pressure vs. volume (P-V) plot of the combustion cycle of a conventional four stroke diesel engine;

FIG. 58B is a pressure vs. volume (P-V) plot of the combustion cycle of the four stroke diesel engine plotted in FIG. 58A modified with surcharging according to the principle of the invention;

FIG. 58C is a pressure vs. volume (P-V) plot of the combustion cycle of a four stroke diesel engine plotted in FIG. 58A modified with surcharging and supraignition according to the principle of the invention;

FIG. 59A is a prior art pressure vs. volume (P-V) plot of the combustion cycle of a conventional two stroke diesel engine;

FIG. 59B is a pressure vs. volume (P-V) plot of the combustion cycle of the two stroke diesel engine plotted in FIG. 59A modified with surcharging according to the principle of the invention;

FIG. 59C is a pressure vs. volume (P-V) plot of the combustion cycle of the two stroke diesel engine plotted in FIG. 59A modified with surcharging and supraignition according to the principle of the invention;

FIG. 60A is a prior art pressure vs. volume (P-V) plot of the combustion cycle of a conventional four stroke petrol engine in which the volume (V) is normalized to full cylinder volume and P is scaled in atmosphere;

FIG. 60B is a pressure vs. volume (P-V) plot of the same four stroke petrol engine plotted in FIG. 60A yet modified with surcharging according to the principle of the invention;

FIG. 60C is a pressure vs. volume (P-V) plot of the same four stroke petrol engine plotted in FIG. 60A yet modified with supraignition and one shot of fuel injection into the ignition chamber according to the principle of the invention;

FIG. 60D is a pressure vs. volume (P-V) plot of the same four stroke petrol engine plotted in FIG. 60A yet modified with supraignition and multiple shots of fuel injection into the ignition chamber according to the principle of the invention;

FIG. 60E is a pressure vs. volume (P-V) plot of the same four stroke petrol engine plotted in FIG. 60A yet modified with surcharging and supraignition according to the principle of the invention;

FIG. 60F is a pressure vs. volume (P-V) plot of the same four stroke petrol engine plotted in FIG. 60A yet modified with surcharging and duel or mixed ignition;

FIG. 61A is a prior art diagrammatic representation of an internal combustion engine with turbocharging;

FIG. 61B is a prior art diagrammatic representation of an internal combustion engine with supercharging according to the principle of the invention;

FIG. 61C is a diagrammatic representation of an internal combustion engine modified with an internal buffer for use in surcharging and supraignition in accordance with the principle of the invention;

FIG. 61D is a diagrammatic representation of an internal combustion engine modified with internal buffers for use in surcharging and supraignition in accordance with the principle of the invention; and

FIG. 61E is a diagrammatic representation of an internal combustion engines each having an internal buffer for use in surcharging and supraignition in accordance with the principle of the invention, whereby the engines are buffers to one another.

### DETAILED DESCRIPTION OF PREFERRED EMBODIMENTS

The above problems and others are at least partially solved and the above objects and others realized in internal combustion engines modified surcharging, including exhaust gas surcharging and/or ignition gas surcharging or supraignition. Exemplary embodiments of the invention are designed to improve the thermodynamic efficiency of the combustion cycles of the cylinder or piston assemblies of an internal combustion engine, whether a two-stroke or four-stroke gasoline engine or diesel engine. According to the principle of the invention, a surcharging embodiment of the invention includes exhaust gas surcharging, which involves harvesting a charge of exhaust gas produced from the combustion cycle of a cylinder assembly, and applying the harvested charge of exhaust gas to a charge of ignition gas in the compression stroke of a cylinder assembly. Another embodiment of exhaust gas surcharging involves harvesting exhaust gas from the combustion cycle of a cylinder assembly, holding or retaining the harvested exhaust gas, and then subsequently putting the retained exhaust gas to use in the combustion cycle of a cylinder assembly. In exhaust gas surcharging, the harvested exhaust gas may be applied to the combustion cycle of the cylinder assembly from which it was harvested from, or to the combustion cycle of a different cylinder assembly.

According to the principle of the invention, another embodiment of surcharging is ignition gas surcharging or supraignition, which involves harvesting ignition gas from a charge of ignition gas in the combustion cycle of a cylinder assembly, and applying the harvested ignition gas to a charge of ignition gas in the compression and/or combustion process or stroke of a cylinder assembly. In another embodiment of ignition gas surcharging or supraignition, ignition gas is harvested from the combustion cycle of a cylinder assembly, held or maintained, such as in a vessel, and then subsequently put to use in the combustion cycle of a cylinder assembly. In ignition gas surcharging or supraignition, the harvested ignition gas may be applied to the combustion cycle of the cylinder assembly from which it was harvested from, or to the combustion cycle of a different cylinder assembly. Exhaust gas surcharging and ignition gas surcharging or supraignition can be carried out with gasoline and diesel engines, in accordance with the principle of the invention.

In a further and more specific aspect, a basic modification to an internal combustion engine according to the principle of the invention is the addition of the supercharging in the form of surcharging using exhaust gas, including warm exhaust gas, in direct mixture with the comparatively cold intake gas or ignition gas in the compression and combustion processes of a combustion cycle. The exhaust gas is buffered or bypassed. In an embodiment where the exhaust gas is buffered, the exhaust gas is harvested, contained or held, such as in a vessel, and then bypassed or otherwise applied to the compression process of a combustion cycle of a cylinder assembly of an internal combustion engine. In a straight bypass embodiment, the exhaust gas is harvested from one cylinder assembly and applied or otherwise bypassed directly into the compression process of a combustion cycle of another cylinder assembly of an internal combustion engine. The gas is warm because it is already expanded to the full volume of the cylinder and thus cooled from hot to warm. The temperature of the warm gas, however, is still high enough to instantly vaporize injected water or oil or other liquid fuel. The buffering includes letting the warm gas charge (fill up) and discharge (empty off) relative to a buffer vessel, which is connected in gaseous communication to the cylinder of the cylinder assembly by a conduit or pipe or by a bore or a passageway in the cylinder wall. The buffer vessel charging and discharging is enabled or controlled by one or more valves formed between the buffer vessel and the cylinder of the cylinder assembly.

In a particular embodiment of this invention, the valve is formed by a porthole in the cylinder wall at or adjacent to the bottom-dead-center (“BDC”) position of the piston of the cylinder assembly, in a way that it is just uncovered by the piston at the BDC position of the piston and the piston opens and closes this porthole in response to movement of the piston between its BDC position at the bottom or lower end of the cylinder and its top-dead-center (“TDC”) position at the top or upper end of the cylinder. The buffer vessel has a volume. In one embodiment, the volume of the buffer vessel is fixed. In another embodiment, the volume of the buffer vessel is adjustable. Adjusting the volume of the buffer vessel adjusts the ratio of the warm and hot gas mixing upon buffering. Upon the buffering, the warm gas encroaches into the cold one, because its pressure is the higher of the two. The surcharging occurs when the warm exhaust gas is let into the cold intake gas, increasing the pressure and temperature of the cold intake gas. When the buffer volume is approximately equal to the full cylinder volume and the buffering flow is not chocked significantly, such as with an inlet valve, approximately half of the warm gas is pressed into the cylinder. Then, that half of the exhaust gas is recycled for burning one more time, which results in less polluting emission. Part or all of the exhaust gas retained in the buffer vessel empties, when the exhaust gas is pushed off from the cylinder by the piston. Now the piston need not compress so hard the intake/exhaust gas mixture, because it already has elevated pressure due to the surcharge at buffering. Thus, the so modified engine can have smaller compression ratio and still be more efficient than an unmodified counterpart engine. This allows for more air or oxidizing gas in the combustion cycle, and thus allows for a leaner fuel-to-air mixture, which results in fuel savings and a cooler running engine. The piston of the cylinder or piston assembly may need to be extended and may need a second set of rings at the bottom piston perimeter, so warm gas is prevented from escaping into the crankshaft housing and coming into contact with the lubricating engine oil.

In another preferred embodiment, the valve or buffer valve is the same or similar to the intake or exhaust valves, which commonly are popper valves on camshaft, located on the cylinder head. The bypassing is the same as described above. This embodiment of the invention avoids having to alter the piston design and employs technology common for such purpose. The great advantage of the described buffered surcharging is that it is applicable to single cylinder engines of which the small engines are numerous in sports, marine, gardening, agriculture and in many portable consumer products, including two-stroke and four-stroke, single-cylinder internal combustion engines.

Another embodiment of surcharging involves coupling opposed cylinder assemblies in gaseous communication to transfer exhaust gas from the combustion cycle of one of the cylinder assemblies into the compression process of a combustion cycle of another cylinder assembly. In a particular example, adjacent or distant cylinders of first and second cylinder assemblies in a row of cylinder assemblies operating a common crank shaft are coupled together in gaseous communication, in which a piston of a the first cylinder assembly is at its BDC position at the end of its intake stroke or process in preparation for its compression stroke or process, while the piston of a second cylinder assembly is at its BDC position at the end of its combustion stroke or process in preparation for its exhaust stroke or process. In such a pair of cylinders coupled together in gaseous communication, the cylinder of the second cylinder assembly serves as the buffer for the cylinder of the first cylinder assembly. Thus the combined operation of the first and second cylinder assemblies is similar to the buffered surcharging with buffer vessel described above. However, this embodiment of the invention eliminates the need for separate buffer vessels, for otherwise each the cylinders in this pair of first and second cylinder assemblies would otherwise need a buffer vessel. In a 4-cylinder, four-stroke engine, two such coupled pairs of cylinder assemblies can be formed and utilized. In yet a further embodiment, four cylinders of four corresponding cylinder assemblies are connected in gaseous communication by a common pipe or conduit, which receives, retains, and applies in cylinder exhaust gas in alternating flows between the various cylinders of the cylinder assemblies.

Another aspect of the invention involves connecting a pair of cylinders of cylinder assemblies in gaseous communication with a conduit, pipe or small volume vessel, e.g., a buffer or buffer vessel, cast into the engine head block, and controlling the gas bypass with bypass valves, such as poppet valves. Yet another aspect of the invention involves coupling four or more cylinders of cylinder assemblies in gaseous communication with bypass pipes or chambers, which receive and retain exhaust gas between the several cylinders in reciprocating or cyclic flows of exhaust gas between the several cylinders. In these examples, exhaust gas is harvested, held, and cycled between the combustion cycles of the several cylinders and thus recycled in the combustion cycles to improve the thermodynamic efficiency of the combustion cycles while at the same time reducing overall gaseous emissions. One great advantage of the bypassed engines is that it needs no additional buffer vessel, thus it is small, lightweight and economical. Internal combustion engines formed with modifications made according to these examples are lightweight and require no separate buffer vessels.

Yet another aspect of the invention concerns timed engine ignition with retained hot exhaust gas, which is infused, injected or otherwise jet infused into the compression and/or combustion process, i.e., compressed intake gas, through a timed valve. This implementation of the invention can be provided in buffered bypass and bypassed volume jet ignitions.

An exemplary embodiment of the invention calls for a small buffer vessel connected to a cylinder head in gaseous communication, such as by a short conduit or pipe or a passageway formed in the engine block and that is formed with a timed valve or ignition valve to regulate gas flow between the buffer vessel and the cylinder head. This ignition valve may be a poppet valve, similar to the intake or exhaust valves on common camshaft, or rotary sleeve-valve or ball-valve. This is the preferred embodiment for single cylinder engines, but can be repeated for any cylinder in a multi cylinder engine. Multi cylinder engines however can use a common buffer.

Another aspect of the invention is used in even numbered multi-cylinder internal combustion engines, in which corresponding pairs cylinders having pistons reciprocating at the same phase, process or stroke are coupled in gaseous communication to a single common buffer vessel or chamber by a common pipe or manifold or passageway or chamber to cycle hot gas infusion between the corresponding pairs of cylinders, which hot gas infusion is controlled with timed valves. In another embodiment used in even numbered multi-cylinder internal combustion engines, all of the cylinders having pistons reciprocating at the same phase, process or stroke are coupled in gaseous communication to a single common buffer vessel or chamber by a common pipe or manifold or passageway or chamber to cycle hot gas infusion between the corresponding pairs of cylinders, which hot gas infusion is controlled with timed valves.

The timing of buffer and bypass ignition is such that the buffer or bypass valve opens upon or shortly before the piston reaches the top-dead-center position and closes shortly after departing from the top-dead-center position. During this volume ignition process, retained hot gas infuses into the cylinder and ignites the entire volume of the compressed ignition gas in the cylinder. Shortly after, however, fresh hot exhaust gas flows back to the buffer at higher pressure and temperature. The retained hot gas gets somewhat tired, losing some pressure and temperature, before it is used for ignition. In case of bypass ignition however, the hot gases move only in one direction while the bypass valves are open in coupled cylinders. Here too, like in bypass surcharging, one cylinder serves as a buffer for another cylinder to which it is coupled in gaseous communication. Again, this results in a light-weight and fuel efficient small volume engine. However, such bypass ignition requires some piston phase difference of the coupled cylinders and therefore, it is only feasible in internal combustion engines having large numbers of cylinder assemblies, such as eight cylinder assemblies, ten cylinder assemblies, twelve cylinder assemblies, sixteen cylinder assemblies, thirty-two cylinder assemblies, etc.

Engine modifications made according to the principle of the invention, which can be made to gasoline and diesel engines, produce numerous improved engine types. A Type 1 engine is a buffer surcharged engine. A Type 2 engine is a bypass surcharged engine. A Type 3 engine is a buffer jet-ignited or jet-ignition engine. A Type 4 engine is a bypass jet-ignited or jet-ignition engine. A Type 5 engine is a buffer surcharged engine with buffer jet ignition. A Type 6 engine is a bypass surcharged engine with bypass jet ignition. An engine can also be formed with buffer surcharging and bypass jet ignition, or with bypass surcharging together with buffer jet ignition. A Type 7 engine is a bypass surcharging engine with buffer-ignition.

The Type 1 engine can be provided with ports to form a Type 1-A engine, and with valves to form a Type 1-B engine. The Type 2 engine can be provided with cylinder ports to form a Type 2-A engine, and with timed valves to form a Type 2-B engine. The Type 2-A engine can pairs of cylinders coupled in gaseous communication to form a Type 2-A-2 engine, and with multiple even numbered cylinders coupled in gaseous communication in a row to form a Type 2-A-2N engine. Similarly, the Type 2-B engine can be provided with pairs of cylinders coupled in gaseous communication to form a Type 2-B-2 engine, and with multiple even numbered cylinders coupled in gaseous communication in a row to form a Type 2-B-2N engine.

The Type 3 engine can be provided as a single cylinder, single buffer engine to form a Type 3-1 engine, or a multiple cylinder multiple buffer engine to form a Type 3-N engine, or a multiple cylinder single buffer engine to form a Type 3-N-1 engine.

The Type 4 engine can be provided with pairs of bypassed cylinders in a block of eight or more cylinders to form a Type 4-8 engine, and with multiple even-number cylinders bypassed with a common vessel or pipe or chamber to form a Type 4-8N-1 engine.

While other engine configurations and combinations may be provided according to the principle of the invention, the embodiments and aspects described above are exceptionally practical and cost-efficient. For instance, the configurations and combinations can be extended to the Type 5 and Type 6 engines. Exemplary combinations include an valve-operated Type 5-A engine, which is a combination of the Type 2-B-2 and Type 3-N-1 engines, as well as the Type 5-B engine, which is a combination of the Type 2-B-2N and Type 3-N-1 engines.

The buffer or bypass surcharging can be augmented with the injection of water or a water/alcohol mixture into the buffer vessel or bypass chamber just prior to or right upon buffer gas infusion to the compression process or intake gas or ignition gas closed in the corresponding cylinder, or into the buffer or bypass chamber at buffering or bypass. Such water or water/alcohol mixture instantly forms steam and further pushes on the intake gas, while cooling and cleaning the engine. Another implementation of such water injection is upon or right after the buffer or bypass valve closes after buffer or bypass jet ignition. The injection can be directed either to the buffer or bypass vessel or directly into the cylinder. Such water instantly forms steam, which cools and cleans the engine and further pushes down on the piston in power stroke. The water is then consumable and thus may be used only to boost engine torque and power at peak demands or at times to flush the engines.

Buffer or bypass surcharging may also be augmented with the injection of oil or other liquid or gaseous fuel into the buffer vessel or bypass chamber just prior to or right upon the infusion of buffer gas into the intake gas or ignition gas closed in the cylinder, or into the buffer or bypass chamber right at buffering or bypass. In such a configuration, the intake gas may be just air. If, for instance, dense oil is injected with a low pressure injector right over the piston head, and right upon the surcharging buffering or bypass, then the oil will evaporate instantly and the engine will assume a greater economy and reliability. Another opportunity for such fuel injection is upon or right after the buffer or bypass valve closes after buffer or bypass jet ignition. The injection can be directed either to the buffer or bypass vessel or directly into the cylinder. Fuel can also be injected directly into the surcharging buffer chamber or into the ignition chamber. Upon the bypassing, the fuel injection can be injected right inside the bypass pipe or inlet, taking advantage of the venturi effect. The fuel injection, however can oppose the buffering or bypassing, so the fuel meets upstream gases for better and quicker atomization or mixing.

In lieu of fuel injection, in a particular embodiment fuel is diffused through a porous plug formed of a matrix of ceramic or metal, sintered powder-metal, or compressed metal wires. The diffusion can be maintained during the entire compression process, phase, or stroke. Fuel may be continually pressed through the entire combustion cycle of a cylinder assembly, or through only the intake, compression and combustion processes, phases, or strokes, in which smoldering fuel burning in the combustion process maintains high expansion pressure, thereby increasing engine power and efficiency. This ignition process is smoldering jet ignition.

Cylinder compression ratios can be varied without altering piston stroke but with altering cylinder volume. Buffering achieves this by adding a fixed or variable volume buffer vessel in gaseous communication to any cylinder. Water or fuel injection may be applied to the cylinder and/or buffer vessel to assist the buffering as described above, which is exemplary of relief buffering.

In particular embodiments of the invention, bypass and buffer vessels are fitted with auxiliary chocking pistons or throttle plate, as well as with catalytic converters and spring loaded pistons. Jet ignition buffer vessels may also be fitted with auxiliary electrodes, which can strip out charges from hot retained gas to ionize the hot retained gas. Such ionized gas ignites with more vigor and completeness and contributes to more uniform and longer-lasting fuel burning. Such ionization can also be achieved by electromagnets wrap around the vessels. Both high static voltage and pulsed coil or core electrode currents can assist such ionization. Ionized ignition gas contains plasma, thus this ignition is a form of plasma ignition. Such ignition is called ionized jet ignition or plasma jet ignition.

Buffer or bypass surcharging increases engine operating efficiency by approximately 15-30% and reduces engine operating temperature. Buffer or bypass jet ignition increases engine operating efficiency by approximately 15-30%. Combining buffer bypass surcharging with buffer or bypass jet ignition increases engine operating efficiency by approximately 30-60% and reduces engine operating temperature by approximately 10-15%. The addition of water injection at buffer surcharging adds a further 15% boost in engine efficiency, while injection after buffer or bypass ignition adds an additional 25% boost in engine efficiency. Fuel injection at surcharging or ignition buffering or bypassing adds an additional 5% boost in engine efficiency, and eliminates the need for a separate carburetor. Thus, overall, when all the proposed engine modification techniques are employed, engine efficiency and power can be improved by 50-100%. Engine modifications made according to the principle of the invention prevent engine knocking, reduce the need for enhanced engine control, reduce engine dependence on catalytic converters, have improved torque or power output, have longer operating ranges, are fuel-efficient, and are easy to implement both in new engines and in retrofitting existing engines. Modifications made to gasoline and diesel engines according to the principle of the invention amplify the benefits of gasoline and diesel engines and suppress the deficiencies of gasoline and diesel engines.

Ensuing embodiments of the invention relate to the combustion cycle of and, more particularly, to improving the efficiency of the combustion cycle in cylinder assemblies to provide improved power, improved fuel efficiency, and improved overall engine performance. Improvement in the combustion cycle is achieved by surcharging and supraignition. Surcharging includes capturing exhaust gas produced from the combustion cycle of a cylinder assembly, applying the captured exhaust gas and uncombusted or fresh gas into the cylinder of a cylinder assembly in the combustion stroke of the cylinder assembly to form a charge of surcharging gas in the cylinder, and igniting the surcharging gas in the cylinder in the combustion stroke of the cylinder assembly. Supraignition includes capturing uncombusted or fresh gas from a cylinder assembly in the compression stroke of the cylinder assembly, applying the captured uncombusted or fresh gas into the cylinder of a cylinder assembly in the compression stroke of the cylinder assembly compressing a charge of uncombusted or fresh gas to form a charge of supraignition gas in the cylinder, and igniting the supraignition gas in the cylinder in the combustion stroke of the cylinder assembly. Surcharging systems and methods and supraignition systems and methods, each of which may be considered an engine modification, are utilized in internal combustion engines, including four stroke and two stroke gasoline and diesel internal combustion engines, in accordance with the invention.

In sum, set forth in this disclosure are gasoline and diesel engine modifications with internal buffered and/or bypassed surcharging and/or volume ignition, which may be augmented with water and/or fuel injection into buffer/bypass chambers/ducts/manifolds, and/or with volume adjustable buffering and/or relief buffering. Furthermore, choked buffering, throttled buffering, pressurized elastic buffering, sweating-smoldering fueling, ignition gas ionization and rotary sleeve valve stacking may also be used in conjunction with gasoline and diesel engines modified according to the teachings of the invention. Gasoline and diesel engines modified according to the principle of the invention exhibit improved engine operating efficiency, torque, power and fuel consumption, operate at a lower operating temperature compared to unmodified engines, demand no monitoring and control, and emit lower quantities of exhaust gases. Gasoline and diesel engines modified in accordance with the principle of the invention can run on any liquid or gaseous fuel without modifications or significant adjustments and have a thermal efficiency 20-60% greater than unmodified engines. Gasoline and diesel engines modified in accordance with the principle of the invention have a nimbleness and flexibility and power gasoline engines, the efficiency and strength or torque of diesel engines, and the fuel flexibility and steadiness and economy and reliability of the Stuart engines, all without compromise in other key engine parameters.

Ensuing embodiments of the invention are concerned with the combustion cycles of cylinder assemblies of internal combustion engines, including gasoline internal combustion engines and diesel internal combustion engines. From a fundamental standpoint, the combustion cycle of a cylinder or piston assembly of a gasoline engine includes intake, compression, combustion, and exhaust processes. The combustion cycle of a four-stroke gasoline engine begins with the piston at the top of the cylinder defining the minimum volume of the combustion chamber in the cylinder. At this starting position, the piston moves from the top of the cylinder to the bottom of the cylinder to intake ignition gas. When the piston is at the bottom of its intake stroke, the volume of the combustion chamber in the cylinder is maximized and is filled with a charge of ignition gas. This is the intake stroke or process. At the bottom of the intake stroke, the piston commences the compression stroke moving from the bottom of the cylinder to the top of the cylinder defining the minimum volume of the combustion chamber in the cylinder compressing the charge of ignition gas in the combustion chamber of the cylinder in the compression process. When the piston reaches the top of its compression stroke in the compression process, the compressed charge of ignition gas is ignited with a spark from a spark plug, and the resulting explosion acts against the piston initiating the combustion stroke or process driving the piston down in the combustion stroke of the piston from the top of the cylinder to the bottom of the cylinder. When the piston reaches the bottom of its combustion stroke in the combustion process at the bottom of the cylinder defining the maximum volume of the combustion chamber, the combustion chamber is filled with exhaust gas and the piston commences the exhaust stroke in the exhaust process moving from the bottom of the cylinder to the top of the cylinder to exhaust the exhaust gas from the cylinder into the exhaust system or tailpipe, at which point the intake process of the next four-stroke combustion cycle commences and this process continues as before. Accordingly, in a gasoline engine, fuel is mixed with air to form ignition gas, which is compressed by pistons and ignited by sparks from spark plugs. Diesel engines also utilize this combustion cycle. In a diesel engine, however, the air is compressed first, and then the fuel is injected. Because air heats up when compressed, the fuel ignites when it is injected into the cylinder. Two-stroke engines also operate under the four-process combustion cycle consisting of the intake, compression, combustion, and exhaust processes, but only through two strokes of the piston rather than four strokes as in a conventional four-stroke engine. Engine modifications set forth in this disclosure can be made to four-stroke and two-stroke internal combustion engines. According to this disclosure, it is to be understood that the term “stroke” may be used interchangeably with the term “process” in denoting a stage, stroke, or phase of a combustion cycle.

Although surcharging according to the principle of the invention is an entirely different process than supercharging, the thermodynamic process of surcharging according to the principle of the invention is similar to the thermodynamic process of supercharging. One difference is that supercharging boost induction pressure consumes energy from the engine and it does not add recycled exhaust gas to dilute combustion. Supercharging is also considerably more expensive and complicated to implement compared to surcharging. Surcharging improves the overall thermodynamic efficiency of the combustion cycle, and increases the overall volumetric efficiency of the combustion cycle, which refers to the engine's ability to produce power at a given engine displacement and size. Surcharging thus allows engine size to be reduced by approximately 15%, which saves space and weight thereby improving overall fuel consumption. With respect to improving fuel consumption, implementation of surcharging produces a 6-90% reduction in pollute emissions due to a multiple burning of recycled exhaust gas, namely, exhaust gas captured from one combustion cycle and applied to the combustion process of another combustion cycle. Water injection in conjunction with surcharging cools combustion process and thus cools the engine while increasing pressure and thus compression thereby improving engine power. This contributes to improved volumetric and thermal efficiency in the combustion process.

The thermodynamic process of recycled exhaust gas injection is very similar to homogenous compression charge ignition, which dieselizes the spark ignition petrol engine. However, recycled exhaust gas injection does improve the overall thermodynamic efficiency of the combustion cycle, and increases the overall volumetric efficiency of the combustion cycle. At the same compression ratio, a diesel engine is always more efficient than a petrol engine and thus merging the two is beneficial to the petrol engine. Water injection right after the closure of the ignition gas valve is similarly beneficial, as it cools the engine and the steam pushes down on the piston, further increasing the power of the combustion process. Gas injection also recycles exhaust gas, and reduces pollute emissions by approximately 33-90%.

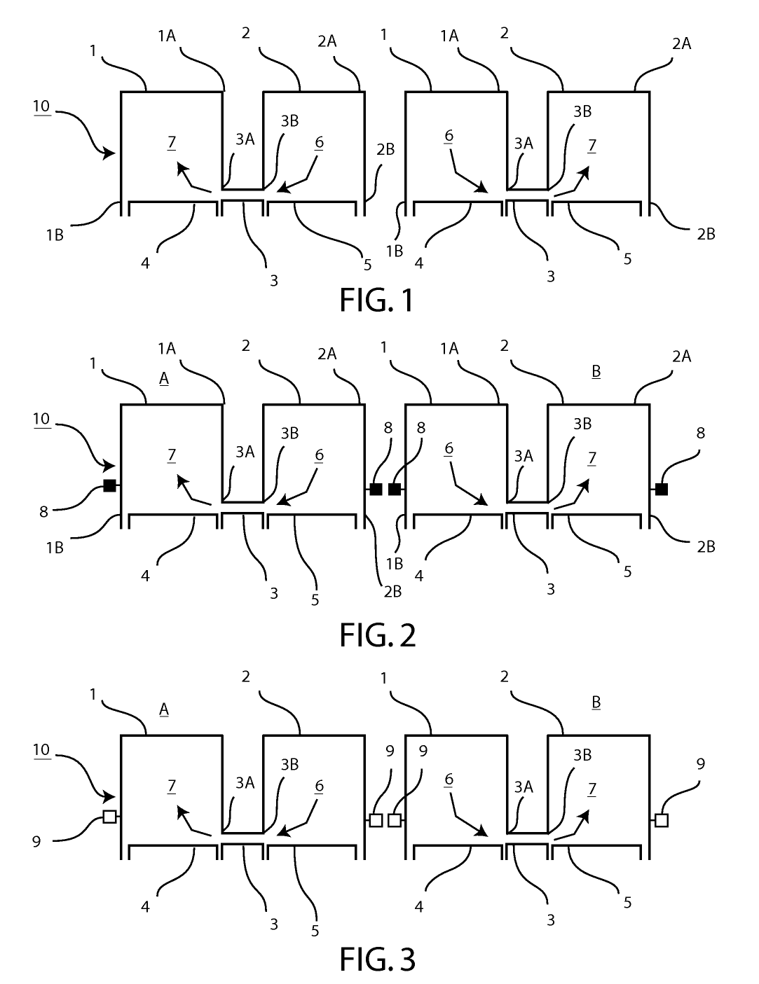

Turning now to the drawings, in which like reference characters indicate corresponding elements throughout the several views, attention is first directed to FIG. 1, in which there is illustrated a schematic diagram of an exhaust gas surcharging system 10, constructed and arranged in accordance with the principle of the invention, used in conjunction with the cylinders of an internal combustion engine, such as a gasoline engine or a diesel engine. System 10 is a multi-cylinder system of a multi-cylinder internal combustion engine including two pairs A and B of cylinder or piston assemblies being exemplary of a four-cylinder system used in a four-cylinder engine.

Pairs A and B of cylinders each include a cylinder 1 operatively coupled in gaseous communication to an opposed cylinder 2, in accordance with the principle of the invention. With respect to each of pairs A and B of cylinders, cylinder 1 is formed with a reciprocating piston 4, which together form a reciprocating cylinder or piston assembly, and cylinder 2 is formed with a reciprocating piston 5, which together form a reciprocating cylinder or piston assembly. Piston 4 reciprocates in cylinder 1 in a combustion cycle including four phases or processes including the intake, compression, combustion, and exhaust phases or processes. The combustion cycle thus includes the intake process where piston 4 moves from top or upper end 1A of cylinder 1 at the start of its intake stroke to the end of its intake stroke at the bottom or lower end 1B of cylinder 1, the compression process where piston 4 moves up from the start or bottom of its compression stroke at lower end 1B of cylinder to the end of its compression stroke at upper end 1A of cylinder 1 to compress a charge of ignition gas in the combustion chamber of cylinder 1, the combustion process where the charge of ignition gas is ignited forcing piston 4 down from the start of its combustion stroke at upper end 1A of cylinder 1 to the end of its combustion stroke at lower end 1B of cylinder 1, and the exhaust process where piston 4 moves from the start of its exhaust stroke at lower end 1B of cylinder to the end of its exhaust stroke at upper end 1A of cylinder 1 exhausting or otherwise pushing out the exhaust created from the combustion out of the charge of exhaust gas in cylinder 1. Piston 5 reciprocates in cylinder 2 in the same manner between the top or upper end 2A of cylinder 2 and the bottom or lower end 2B of cylinder 2 between the intake stroke, the compression stroke, the combustion stroke, and the exhaust stroke that characterize and form the intake, compression, combustion, and exhaust processes or phases of the combustion cycle. Pistons 4 and 5 are each coupled to a crankshaft (not shown) with a connecting rod (not shown) in a conventional and well-known manner. In this embodiment, a conduit or pipe 3 is used to operatively couple cylinder 1 to cylinder 2 in gaseous communication, in this embodiment at the bottom or lower ends 1B and 2B of cylinders 1 and 2. If desired, a manifold may be used to operatively couple cylinder 1 to cylinder 2. In other embodiments, cylinders 1 and 2 may share a common cylinder wall, and the operative coupling therebetween provided by a bore hole formed in the common cylinder wall.

The operation of pair A of cylinders 1 and 2 is now discussed from an initial starting position consisting of piston 5 positioned at the end of its combustion stroke at the bottom or lower end 2B of cylinder 2 below port opening 3B into pipe 3 from cylinder 2 in preparation for the exhaust stroke, and piston 4 is positioned at the end of its intake stroke at the bottom or lower end 1B of cylinder 1 below port opening 3A into pipe 3 from cylinder 1 in preparation for the compression stroke. At this initial starting position of cylinders 1 and 2 of pair A of cylinders 1 and 2, combustion of a charge of ignition gas has occurred in cylinder 2, in which a corresponding charge of warm exhaust gas denoted at 6 produced from the ignition gas combustion in cylinder 2 flows from cylinder 2 into cylinder 1 through pipe 3, where it meets and mixes with comparatively cold intake gas in cylinder 1 denoted at 7. The warm exhaust gas denoted at 6 is exhaust bypass gas, which flows from cylinder 2 to cylinder 1 through pipe 3 because the warm exhaust gas in cylinder 2 has higher pressure than the comparatively cold intake gas in cylinder 1. The flow of warm exhaust gas 6 from cylinder 2 to cylinder 1 through pipe 3, namely, the application of warm exhaust gas 6 from cylinder 2 to cylinder 1, is exhaust gas bypass surcharging, in accordance with the principle of the invention.

At this point in the operation of pair A of cylinders 1 and 2, cylinder 2 is relieved of a volume or charge of exhaust gas, which is applied to cylinder 1 from pipe 3 as a charge of exhaust bypass gas. Because cylinder 2 is relieved of a volume of exhaust gas at the bottom of the combustion stroke of piston 5, there is an initial pressure drop or reduction in cylinder 2 before piston 5 initiates its exhaust stroke, which pressure reduction cools the exhaust gas in cylinder 2, in accordance with the principle of the invention. Because cylinder 1 is provided or otherwise charged with a volume or charge of exhaust gas from cylinder 2 through pipe 3 at the bottom of the intake stroke of piston 4 in the exhaust gas bypass surcharging that mixes with the intake gas to form surcharged gas, there is an initial pressure increase in cylinder 1 before piston 4 initiates its compression stroke to compress the surcharged gas, which pressure increase produces a pressure pre-charging in cylinder 1 before piston 4 initiates its compression stroke, in accordance with the principle of the invention.

With cylinder 2 relieved of exhaust gas with piston 5 at the bottom of the compression stroke and with cylinder 1 charged with a corresponding volume of exhaust gas from cylinder 2 thereby pre-pressurizing cylinder 1 and also warming the intake gas in cylinder 1 to produce a charge of surcharged gas consisting of a mixture of the intake gas and a volume of exhaust gas, piston 5 initiates its exhaust stroke moving upwardly away from the bottom or lower end 2B of cylinder 2 to the top or upper end 2A of cylinder 2, and piston 4 initiates its compression stroke moving upwardly away from the bottom or lower end 1B of cylinder 1 to the top or upper end 1B of cylinder 1, whereby pistons 5 and 4 move across the respective port openings 3A and 3B into pipe 3 at and through the bottom of cylinders 2 and 1, respectively, isolating pipe 3 from cylinders 2 and 1 in turn isolating cylinder 2 from cylinder 1 stopping or otherwise preventing gas flow from cylinder 2 to cylinder 1. The movement of pistons 5 and 4 across the respective port openings 3A and 3B into pipe 3 at and through the bottom of cylinders 2 and 1, respectively, isolating pipe 3 from cylinders 2 and 1 in turn isolating cylinder 2 from cylinder 1 stopping or otherwise preventing gas flow from cylinder 2 to cylinder 1 is valving between cylinders 2 and 1, including one valve formed by and between piston 5 and port opening 3A and another valve formed by and between piston 4 and port opening 3B. It is to be understood that this valving formed between a piston interacting with a port opening to form a valve, which is ported piston valving, is present in various embodiments of the invention throughout this disclosure, and that the foregoing discussion of this form of valve or valving applies in every respect whenever present in this disclosure and will not be further discussed.

At this point, the volumes of both cylinders 2 and 1 are now approximately equal to full cylinder volume, and piston 5 continues movement through its exhaust stroke exhausting exhaust gas and piston 4 continues movement through its compression stroke compressing the surcharged gas. In the movement of piston 5 through its exhaust stroke, the exhaust gas in cylinder 2, which is precooled as a result of the pressure reduction in cylinder produced by the exhaust gas bypass surcharging according to the principle of the invention, is exhausted through the corresponding exhaust valve (not shown) associated with cylinder 2 and into the exhaust system or tail pipe. As piston 4 moves along its compression stroke it compresses the surcharged gas in cylinder 1, in which the initial warming of the intake gas in cylinder 1 and the pre-pressurization of the intake gas in cylinder 1 at the end of the previous intake stroke of piston 4 produced by the intake of the warm exhaust gas from cylinder 2 in the exhaust gas bypass surcharging increases the resulting temperature of the intake gas in cylinder 1 and the resulting gas pressurization of the gas in cylinder 1 through the movement of piston 4 through its compression stroke. At the top of the compression stroke of piston 4 the temperature of the intake gas is increased and the pressure in cylinder 1 is increased by heat and the volume of bypass gas introduced into cylinder 1 resulting from the exhaust gas bypass surcharging. Because heat and compression make the explosion more powerful, this increased heat and pressure of the intake gas in cylinder 1 at the top of the compression stroke of piston 4 from the exhaust gas bypass surcharging produces a more powerful, efficient, and complete explosion of the introduced ignition gas in cylinder 1 thereby producing a more powerful and efficient combustion stroke of piston 4, in accordance with the principle of the invention. Piston 5 now moves from its top position at the end of its exhaust stroke and downwardly along its intake stroke and piston 4 moves downwardly along its combustion stroke in which the exhaust gas bypass surcharging then takes place from cylinder 1 to cylinder 2 through pipe 3 when pistons 4 and 5 pass below the respective port openings 3A and 3B into pipe 3 recoupling cylinders 1 and 2 in gaseous communication, in which warm exhaust gas passes from cylinder 1 to cylinder 2 through pipe 3 relieving cylinder 1 of a volume of the exhaust gas and charging cylinder 2 with a volume of the exhaust bypass gas from cylinder 1 and this exhaust gas bypass surcharging process so continues between cylinders 1 and 2, in accordance with the principle of the invention. During surcharging, both the intake and exhaust valves (not shown) are closed.

Pressure on pistons 5 and 4 at their bottom positions prior to initiation of their respective exhaust and compression strokes does not exert torque on the crankshaft to which pistons 5 and 4 are attached in exhaust gas bypass surcharging. The exhaust gas bypass surcharging herein described does have significant benefits. First, the exhaust gas, before leaving the engine, is relieved of pressure which cools the exhaust gas. Second, mixing cool intake gas with warm exhaust gas or bypass gas produced from the exhaust gas bypass surcharging between opposed cylinders pre-compresses and pre-warms the intake gas, which thus improves the efficiency of the resulting piston combustion stroke and saves fuel, in accordance with the principle of the invention. Mixing intake gas with bypass gas does not reduce the amount of oxidant in the intake air. The recycled particulates in the bypass gas actually help initiate disperse burning upon ignition. Pair B of cylinders functions identically to the function of pair A of cylinders, except that the cycle of exhaust gas bypass surcharging is simply reversed, such that when exhaust gas bypass surcharging is occurring from cylinder 1 to cylinder 2 in pair A of cylinders 1 and 2, exhaust gas bypass surcharging is occurring from cylinder 2 to cylinder 1 in pair B of cylinders 1 and 2. The fuel saving is a result of the elevated pressure and temperature of the compressed mix, which now requires less added pressure induced by spark ignition.

The cylinder assemblies of gas and diesel engines can be modified to use the structure specified by system 10. The system of FIG. 1 can be used in two cylinder applications, four cylinder applications, six-cylinder applications, or other even-numbered multi-cylinder application, and may be used in conjunction with valved two-stroke engines or four-stroke engines with combustion cycles including intake, compression, combustion, and exhaust processes or phases. This is the case will all embodiments of the invention set forth in this specification. Two stroke engines will require valved bypass rather than ported valve bypass.

FIG. 2 is a schematic diagram of the system of FIG. 1 constructed with fuel injection features, in which the system in FIG. 2 is denoted generally by the reference character 30. In FIG. 2, a fuel injection system 8 is incorporated with side A of cylinders 1 and 2, and side B of cylinders 1 and 2. Referencing side A, fuel injection system 8 is formed with cylinder 1 and provides fuel injection into cylinder 1 in the compression stroke of piston 4. In side B, fuel injection system is formed with cylinder 2 and provides fuel injection into cylinder 2 in the compression stroke of piston 5. Fuel injection system 8 in side A of cylinders 1 and 2 provides for better and quicker fuel-gas mixing and warming up in cylinder 1 and better and more efficient and more powerful combustion in cylinder 1 and a more powerful combustion stroke of in piston 4 thereby increasing engine power. Fuel injection system 8 in side B of cylinders 1 and 2 provides for better and quicker fuel-gas mixing and warming up in cylinder 2 and better and more efficient and more powerful combustion in cylinder 2 and a more powerful combustion stroke of in piston 5 thereby increasing engine power. If desired, fuel injection systems 8 can each be configured to inject merely air to provide further increased pressurization and excess air for fuel oxidation and better and more powerful explosion in the combustion cycle to increase engine power. A fuel injection system 8 is also be provided with cylinder 2 of pair A of cylinders 1 and 2, and with cylinder 1 of pair B of cylinders 1 and 2, and the operation is the same as with cylinder 1 at side A.

The increased engine power produced by the provision of fuel injection systems 8 can be used at selected times as needed to provide increased power when needed or desired, such as initial engine start, during engine acceleration, take-off from idle or stop, etc. As such, fuel injection systems 8 in conjunction with side A of cylinders 1 and 2, and fuel injection systems 8 in conjunction with side B of cylinders 1 and 2 may be inactive during normal engine run, and activated at specified cleaning times or when increased engine power is required. Activation of fuel injection systems 8 can be made manually, such as through activation of a switch operatively coupled to fuel injection systems 8, or by the engine's computer system working in conjunction with an actuator operatively coupled to the fuel injection systems 8.

Attention is now directed to FIG. 3, in which there is seen a schematic diagram of the system of FIG. 1 constructed with water injection features, in which the system in FIG. 3 is denoted generally by the reference character 50. In FIG. 3, side A of cylinders 1 and 2 includes a water injection system 9, and side B of cylinders 1 and 2 includes a water injection system 9. In this embodiment, water injection system 9 is formed with cylinder 2 of side A of cylinders 1 and 2, and water injection system 9 is formed with cylinder 1 of side B of cylinders 1 and 2. The water utilized in conjunction with system 50, which is housed in a tank, can be furnished with a desired volume percent of alcohol, ethanol, or other clean-burning liquid to prevent the water from freezing in cold temperatures. The added alcohol, ethanol, or the like can burn and thus serves as fuel, in accordance with the principle of the invention.

Water injection system 9 in side A of cylinders 1 and 2 injects water into cylinder 2 during the compression stroke of piston 5, which instantly evaporates and converts to steam in the combustion stroke of piston 5, which increases the pressure of exhaust gas 6 thereby increasing the pre-pressurization of cylinder 1 in the bypass surcharging thereby increasing the power of combustion in cylinder 1 improving the power of the combustion stroke of piston 4 thereby increasing engine power. Water injection system 9 in side B of cylinders 1 and 2 injects water into cylinder 1 during the compression stroke of piston 4, which instantly evaporates and converts to steam in the combustion stroke of piston 4, which increases the pressure of exhaust gas 6 thereby increasing the pre-pressurization of cylinder 2 in the bypass surcharging thereby increasing the power of combustion in cylinder 2 improving the power of the combustion stroke of piston 5 thereby increasing engine power. The steam produced from this embodiment of the invention also cleans cylinders 1 and 2 and pistons 4 and 5 of pairs A and B, in accordance with the principle of the invention. For cleaning purposes, water injection may be provided at selected intervals, as needed. Again, the steam pressure increases the intake-gas pre-compression pressure and thus increases the power of the consecutive piston stroke, in accordance with the principle of the invention. The increased engine power produced by the provision of water injection systems 9 can be used at selected times as needed, such as during engine acceleration, take-off, etc. As such, water injection system 9 in conjunction with side A of cylinders 1 and 2, and water injection system 9 in conjunction with side B of cylinders 1 and 2 may be inactive during normal engine run, and activated at specified cleaning times or when increased engine power is required. Activation of water injection systems 9 can be made manually, such as through activation of a switch operatively coupled to water injection systems 9, or by the engine's computer system working in conjunction with an actuator operatively coupled to the water injection systems 9. In FIG. 3, a water injection system 9 is also formed with cylinder 1 of side A of cylinders 1 and 2, and a water injection system 9 is formed with cylinder 2 of side B of cylinders 1 and 2, and the operation is the same as before. The best time to inject water is at the end of the compression stroke or cycle, just prior to the combustion or expansion process or stroke.

The provision of coupling opposed cylinders of an internal combustion engine in gaseous communication as described above in conjunction with FIGS. 1-3 to provide exhaust gas bypass surcharging between the opposed cylinders to recycle exhaust gas between the opposed cylinders to cause more powerful cylinder combustions to provide more powerful piston combustion strokes provides improved engine efficiency on the order of approximately 15-20%, and provides a corresponding reduction in fuel usage to attain the increased engine efficiency. The timing of conventional engines modified to incorporate either of the embodiments discussed in conjunction with FIGS. 1-3 may require adjustments, such as to the intake and exhaust valves, so bypassing exhaust gas between opposed cylinders in the exhaust gas bypass surcharging will not escape through the intake or exhaust valves.

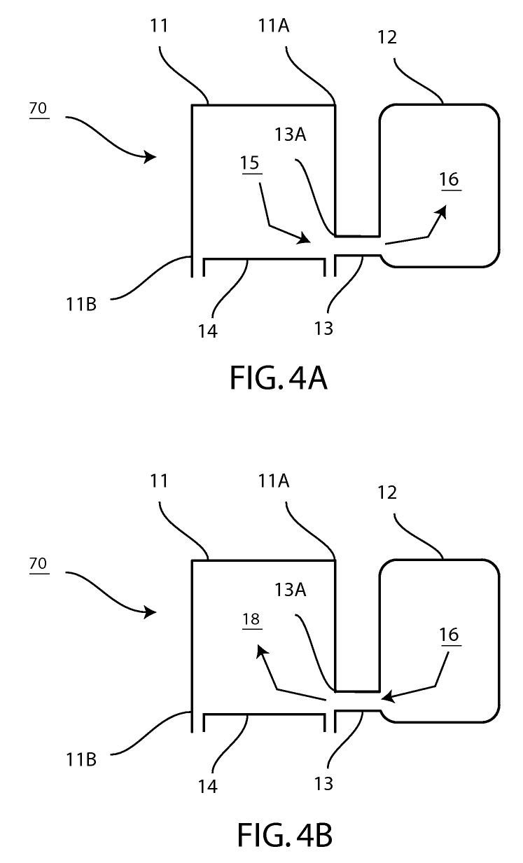

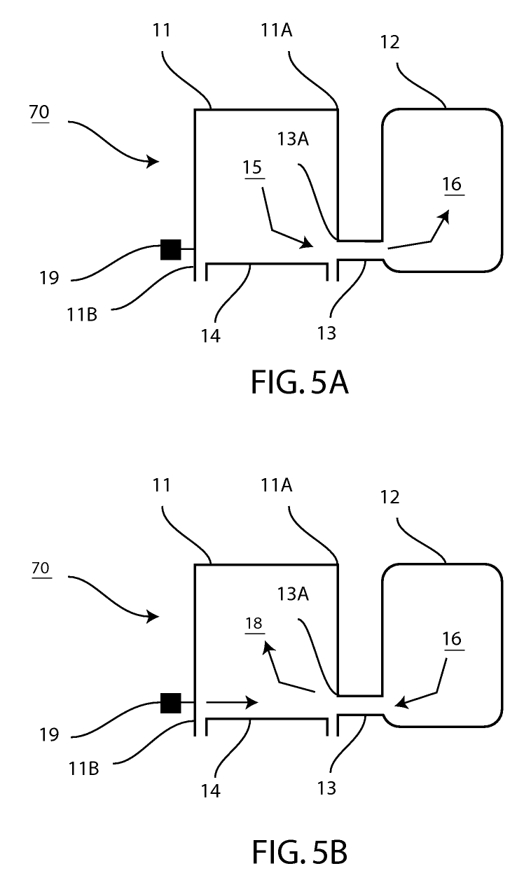

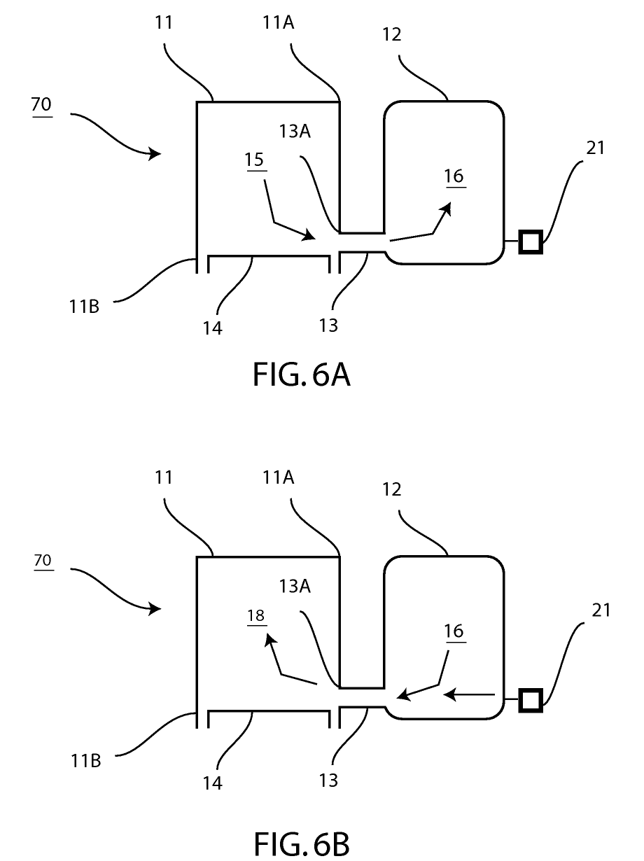

Attention is now directed to FIGS. 4A, 4B, 5A, 5B, 6A, and 6B, in which FIGS. 4A and 4B are schematic diagrams of stages of operation of a single cylinder exhaust gas buffer bypass surcharging system 70 of an internal combustion engine constructed and arranged in accordance with the principle of the invention, FIGS. 5A and 5B are schematic diagrams of stages of operation of the system 70 of FIGS. 4A and 4B constructed with fuel injection features, and FIGS. 6A and 6B are schematic diagrams of stages of operation of the system 70 of FIGS. 4A and 4B constructed with water injection features. Referencing FIG. 4A, system 70 includes a cylinder assembly including a cylinder 11, formed in an engine block or cylinder block, having a top or upper end 11A and an opposed bottom or lower end 11B, and a piston 14 reciprocated therein, which together form a reciprocating cylinder or piston assembly. Piston 14 reciprocates in cylinder 11 in a four stroke combustion cycle characterized by the four processes as in a conventional four-stroke combustion cycle as described above in conjunction with the embodiments specified in FIGS. 1-3, which processes including the intake, compression, combustion, and exhaust processes. Piston 14 is coupled to a crankshaft (not shown) with a connecting rod (not shown) in a conventional and well-known manner.

In this embodiment, the bottom or lower end 11B of cylinder 11 is coupled in gaseous communication to a buffer vessel 12. In this embodiment, a conduit or pipe 13 is used to operatively couple cylinder 11 to buffer vessel 12 in gaseous communication at the bottom or lower end of cylinder 11. If desired, a manifold may be used to operatively couple cylinder 11 to buffer vessel 12. Cylinder 11 and buffer vessel 12 may share a common cylinder wall, and the operative coupling therebetween provided by a bore hole formed in the common cylinder wall between cylinder 11 and buffer vessel 12.

The operation of system 70 is now discussed from an initial starting position illustrated in FIG. 4A consisting of piston 14 positioned at the bottom of its combustion stroke at the bottom or lower end 11B of cylinder 11 at the end of combustion process below port opening 13A into pipe 13 from cylinder 11 in preparation for the exhaust stroke or process. At this initial starting position of cylinder 11, combustion has occurred in cylinder 11 and warm exhaust gas denoted at 15 is produced from fuel combustion in cylinder 11, which flows from cylinder 11 into buffer vessel 12 through pipe 13. The warm exhaust gas 15, which may also be referred to as bypass gas or bypass exhaust gas, flows from cylinder 11 to buffer vessel 12 through pipe 13 because the warm exhaust gas 15 in cylinder 11 has higher pressure than the pressure of the comparatively cool gas in buffer vessel 12. The flow of warm exhaust gas 15 from cylinder 11 to buffer vessel 12 through pipe 13, which is the application of warm exhaust gas 15 to buffer vessel 12 from cylinder 11, is a form of bypass surcharging consisting of exhaust gas buffer bypass surcharging, in accordance with the principle of the invention.

At this point in the operation of cylinder 11, cylinder 11 is relieved of a volume of warm exhaust gas, which is received by buffer vessel 12 from pipe 13. The warm exhaust gas received by buffer vessel 12 from cylinder 11 through pipe 13 is exhaust buffer gas 16. Because cylinder 11 is relieved of a volume of exhaust gas at the bottom of the combustion stroke of piston 14, there is an initial pressure reduction in cylinder 11 before piston 14 initiates its exhaust stroke in the exhaust process, which pressure reduction cools the exhaust gas in cylinder 11.

With cylinder 11 relieved of exhaust gas with piston 14 at the bottom of the combustion stroke, buffer vessel 12 is charged with a corresponding volume of warm exhaust gas or exhaust bypass gas from cylinder 11 which is exhaust gas buffer bypass surcharging. From this point, piston 14 continues its exhaust stroke moving upwardly away from the bottom or lower end 11B of cylinder 11 toward the top or upper end 11A of cylinder 11 in the exhaust process, whereby piston 14 moves across port opening 13A into pipe 13 at and through the bottom of cylinder 11 isolating pipe 13 from cylinder 11 in turn isolating cylinder 11 from buffer vessel 12 stopping gas flow from cylinder 11 to buffer vessel 12 through pipe 13 sealing exhaust buffer gas 16 in buffer vessel 12. The volume of cylinder 11 at this stage of operation is now approximately equal to full cylinder volume, and piston 14 continues movement through its exhaust stroke from port opening 13A. In the movement of piston 14 through its exhaust stroke, the exhaust gas in cylinder 11, which is precooled as a result of the pressure reduction in cylinder 11 produced by the buffer bypass surcharging according to the principle of the invention, is exhausted through the corresponding exhaust valve (not shown) associated with cylinder 11 and into the exhaust system or tail pipe. Piston 14 moves along its exhaust stroke and into the following intake stroke in the intake process as illustrated in FIG. 4B.

As piston 14 moves along its intake stroke from its top position at the top or upper end 11A of cylinder 11 to its bottom position at the bottom or lower end 11B of cylinder 11 taking in intake gas 18 in the intake process, piston 14 passes by port opening 13A into pipe 13 at the bottom or lower end 11B of cylinder 11. Because intake gas 18 in cylinder 11 taken in during the intake stroke of piston 14 is comparatively cooler than the exhaust buffer gas 16 maintained in buffer vessel 12, the exhaust buffer gas 16 in buffer vessel 12 passes into cylinder 11 through pipe 13 from buffer vessel 12 when piston 14 passes by port opening 13A into pipe 13 in the intake stroke of piston 14 recoupling cylinder 11 in gaseous communication with buffer vessel 12 in accordance with the principle of the invention, which exhaust buffer gas 16 passing into cylinder 11 initially warms the intake gas 18 in cylinder 11 and also pre-pressurizes cylinder 11, in accordance with the principle of the invention. Exhaust buffer gas 16 flows from buffer vessel 12 to cylinder 11 through pipe 13 because exhaust buffer gas 16 in buffer vessel 12 is comparatively warmer than intake gas 18 in cylinder 11 and thus has higher pressure than intake gas 18 in cylinder 11. The flow of exhaust buffer gas 16 from buffer vessel 12 to cylinder 11 through pipe 13 is exhaust gas buffer bypass surcharging, in accordance with the principle of the invention. Because buffer vessel 12 is relieved of a volume of the exhaust buffer gas 16 and cylinder 11 is provided or otherwise charged with a corresponding volume of exhaust buffer gas 16 from buffer vessel 12, there is an initial warming of intake gas 18 in cylinder 11 and an initial pressure increase in cylinder 11 before piston 14 initiates its compression stroke in the compression process, which warming of the intake gas 18 in cylinder 11 produces a pre-warming of intake gas 18 in cylinder 11 and which pressure increase produces a pressure pre-charging in cylinder 11 before piston 14 initiates its compression stroke in the compression process.

With buffer vessel 12 relieved of a volume of exhaust buffer gas 16 and cylinder 11 charged with a corresponding volume of exhaust buffer gas 16 from buffer vessel 12 thereby pre-pressurizing cylinder 11 and also pre-warming intake gas 18 in cylinder 11, piston 14 initiates its compression stroke in the compression process moving upwardly away from the bottom or lower end 11B of cylinder 11 to the top or upper end 11A of cylinder 11, whereby piston 14 moves across port opening 13A into pipe 13 at and through the bottom or lower end 11B of cylinder 11, isolating pipe 13 from cylinder 11 and in turn isolating cylinder 11 from buffer vessel 12 stopping gas flow from buffer vessel 12 to cylinder 11.

At this point, the volume of cylinder 11 is now approximately equal to full cylinder volume, and buffer vessel 12 is substantially relieved of exhaust buffer gas 16 and is cooled due to the pressure reduction in buffer vessel 12 due to the evacuation of exhaust buffer gas 16 in the exhaust gas buffer bypass surcharging. Piston 14 continues movement through its compression stroke, and as piston 14 moves along its compression stroke it compresses the gas, including the exhaust buffer gas 16, in cylinder 11, in which the initial warming of intake gas 18 in cylinder 11 and the pre-pressurization of intake gas 18 in cylinder 11 at the end of the prior intake stroke of piston 14 produced by the intake of the exhaust buffer gas 16 from buffer vessel 12 in the exhaust gas buffer bypass surcharging increases the resulting temperature of intake gas 18 in cylinder 11 and the resulting gas pressurization of the gas in cylinder 11 through the movement of piston 14 through its compression stroke in the compression process. At the top of the compression stroke of piston 14 at the top or upper end 11A of cylinder 11 the temperature of intake gas 18 is increased and the pressure in cylinder 11 is increased by heat and the volume of exhaust buffer gas 16 introduced into cylinder 11 resulting from the exhaust gas buffer bypass surcharging. Because heat and compression makes the explosion more powerful, this increased heat and pressure of intake gas 18 in cylinder 11 at the top of the compression stroke of piston 14 at the top or upper end 11A of cylinder 11 produces a more powerful, efficient, and complete explosion of the introduced gas in cylinder 11 thereby producing a more powerful and efficient combustion stroke of piston 14, in accordance with the principle of the invention. At this point, piston 14 moves downwardly along its combustion stroke in the combustion process in which the buffer bypass surcharging takes place between cylinder 11 and buffer vessel 12 when piston 14 passes below port opening 13A into pipe 13 at the bottom or lower end 11B of cylinder 11 recoupling cylinder 11 to buffer vessel 12 in gaseous communication, in which warm exhaust gas passes from cylinder 11 to buffer vessel 12 through pipe 13 relieving cylinder 11 of a volume of the warm exhaust gas and charging buffer vessel 12 with a volume of the exhaust gas from cylinder and this process of exhaust gas buffer bypass surcharging between cylinder 11 and buffer vessel 12 so continues through the next combustion cycle.

The interaction between the reciprocal movement of piston 14 across port opening 13A into pipe 13 at and through the bottom of cylinder 11 opening and closing/isolating pipe 13 relative to cylinder 11 is valving, or otherwise a valve, between cylinder 11 and buffer vessel 12, and this valving discussion applies whenever present in this disclosure.

System 70 can be used in a multi-cylinder internal combustion engine, or a single cylinder internal combustion engine. The volume of buffer vessel 12 is approximate to the volume of cylinder 11 when piston 14 is at the bottom of its combustion cycle at the bottom or lower end of cylinder 11. The volume of buffer vessel 12 can be varied as may be desired for adjusting the resulting combustion stroke in the buffer bypass surcharging.

FIGS. 5A and 5B are schematic diagrams of stages of operation of the ported single cylinder buffer surcharging system 70 of FIG. 4 constructed with fuel injection features. In FIGS. 5A and 5B, cylinder 11 includes a fuel injection system 19, and provides fuel injection into cylinder 11 in the compression stroke of piston 14 in the compression process. Fuel injection system 19 provides for better and quicker fuel-gas mixing and warming up in cylinder 11 and better and more efficient and more powerful combustion in cylinder 11 and a more powerful combustion stroke of in piston 14 thereby increasing engine power. If desired, fuel injection system 19 can each be configured to inject merely air to provide further increased pressurization and excess air for fuel oxidation and better explosion in the combustion cycle thereby increasing engine power.

The operation of system 70 in FIGS. 5A and 5B will be discussed from an initial starting position illustrated in FIG. 5A, which is the same starting position as described in detail in conjunction with FIG. 4A. FIG. 5B is the same operational stage of system 70 as described in detail in FIG. 4B, in which piston 14 moves along its exhaust stroke in the exhaust process and into the following intake stroke in the intake process, in which the exhaust buffer gas 16 in buffer vessel 12 passes into cylinder 11 through pipe 13 from buffer vessel 12 when piston 14 passes by port opening 13A into pipe 13 in the intake stroke of piston 14, which exhaust buffer gas 16 passing into cylinder 11 initially warms the intake gas 18 in cylinder 11 and also pre-pressurizes cylinder 11, in accordance with the principle of the invention. Fuel injection system 19 injects fuel into cylinder 11 during the initiation of the following compression stroke of piston 14, which increases the overall pressure in cylinder providing a more powerful explosion in cylinder 11 and a more powerful combustion stroke of piston 14.

The increased engine power produced by the provision of fuel injection system 19 can be used at selected times as needed, such as during times of acceleration, take-off, etc. As such, fuel injection system 19 may be inactive during normal engine run, and activated at specified cleaning times or when increased engine power is required. Activation of fuel injection system 19 can be made manually, such as through activation of a switch operatively coupled to fuel injection systems 19, or by the engine's computer system working in conjunction with an actuator operatively coupled to the fuel injection system 19.

FIGS. 6A and 6B are schematic diagrams of stages of operation of the ported single cylinder buffer surcharging system 70 of FIG. 4 constructed with water injection features. In FIGS. 6A and 6B, buffer vessel 12 includes a water injection system 21. The water utilized in conjunction with system 70, which is housed in a tank, can be furnished with a desired volume percent of alcohol, ethanol, or other clean-burning liquid to prevent the water from freezing in cold temperatures. The added alcohol, ethanol, or the like can burn and thus serves as fuel, in accordance with the principle of the invention.

The operation of system 70 in FIGS. 6A and 6B will be discussed from an initial starting position illustrated in FIG. 6A, which is the same starting position as described in detail in conjunction with FIG. 4A. FIG. 6B is the same operational stage of system 70 as described in detail in FIG. 4B, in which piston 14 moves along its exhaust stroke in the exhaust process and into the following intake stroke in the intake process. Water injection system 21 in buffer vessel 12 injects water into buffer vessel 12 in the intake stroke of piston 14, which instantly evaporates and converts to steam increasing the pressure of exhaust buffer gas 16 thereby increasing the pre-pressurization of cylinder 11 in the buffer bypass surcharging thereby increasing the power of combustion in cylinder 11 improving the power of the combustion stroke of piston 14 thereby increasing engine power. The steam produced from this embodiment of the invention also cleans buffer vessel 12, piston 14, and cylinder 11, in accordance with the principle of the invention. For cleaning purposes, water injection may be provided at selected intervals, as needed. Again, the steam pressure increases the intake-gas pre-compression pressure and thus increases the power of the consecutive piston stroke in cylinder 11 and saves fuel, in accordance with the principle of the invention. The increased engine power produced by the provision of water injection system 21 can be used at selected times as needed, such as during times of acceleration, take-off, etc. As such, water injection system 21 in conjunction with buffer vessel 12 may be inactive during normal engine run, and activated at specified cleaning times or when increased engine power is required. Activation of water injection system 21 can be made manually, such as through activation of a switch operatively coupled to water injection system 21, or by the engine's computer system working in conjunction with an actuator operatively coupled to the water injection system 21.

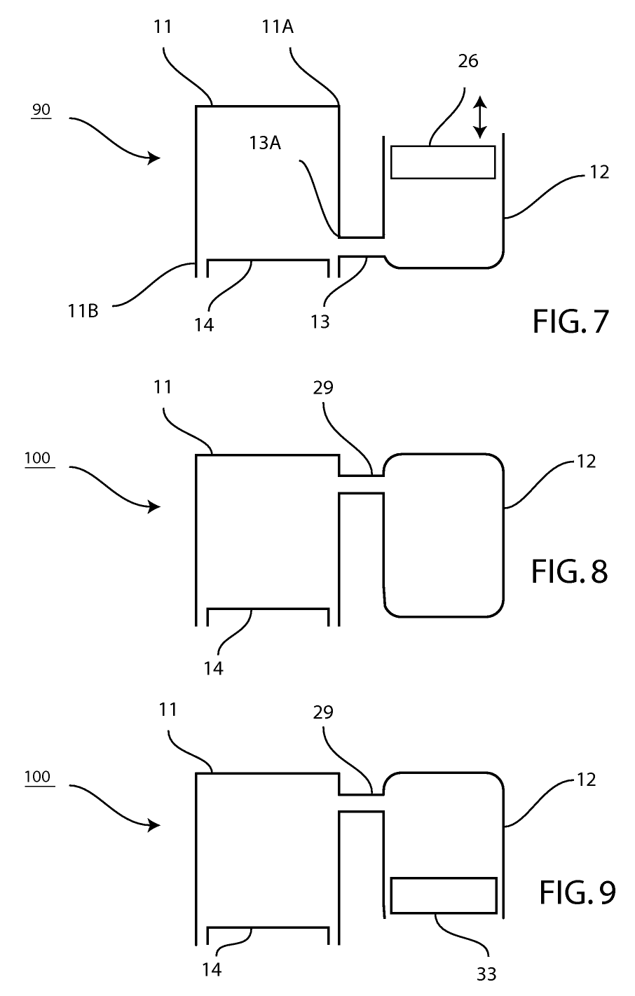

Adjustment of buffer vessel 12 can be made to adjust the resulting effect made to in the combustion stroke of piston 14 in cylinder 11, if desired, and the embodiment denoted at 90 illustrates this aspect of the invention. In FIG. 7 there is illustrated a single cylinder exhaust gas buffer bypass surcharging system 90 of an internal combustion engine constructed and arranged in accordance with the principle of the invention, which incorporates an adjustable volume buffer bypass chamber. Like system 70, system 90 shares cylinder 11, piston 14, conduit or pipe 13, and buffer vessel 12. The operation of system 90 is the same as system 70, and the discussion of the structure and operation of system 70 applies to system 90. However, in system 90 buffer vessel is formed with a buffer closure piston 26. Piston 26 is adjustable to adjust the volume of buffer vessel 12, and after moved or otherwise adjusted to a desired position or location to define a selected volume of buffer vessel 12 is secured in place, such as by one or more set screws or servo mechanisms of the like, to define a selected volume of buffer vessel 12. Piston 26 is adjustable simply by releasing it from a given fixed location, moving it to a new location to define a desired volume of buffer vessel 12, and then affixed in place. By adjusting piston 26, the volume of buffer vessel 12 may be adjusted as needed to provide a desired degree of buffer bypass surcharging in cylinder 11, in accordance with the principle of the invention.

The compression ratio of cylinder 11 can also be reduced in a single cylinder exhaust gas buffer bypass surcharging system 100 of an internal combustion engine as illustrated in FIG. 8. In common with system 70, system 100 illustrated in FIG. 8 shares cylinder 11, piston 14, and buffer vessel 12. In this embodiment, cylinder 11 is coupled in gaseous communication to buffer vessel 12 with a conduit or pipe 29 at the top or upper end 11A of cylinder 11. The operation of system 100 is the same as system 70, with the exception that the coupling of cylinder 11 in gaseous communication to buffer vessel 12 with pipe 29 at the top or upper end 11A of cylinder 11 prevents piston 14 from cutting off the gaseous communication between cylinder 11 and buffer vessel 12 thereby yielding constant gaseous communication between buffer vessel 12 and cylinder 11. As such, the compression ratio of cylinder 11 is reduced.

Referencing FIG. 9, system 100 of FIG. 8 is illustrated with a buffer closure piston 33 formed in buffer vessel 12 forming an adjustable volume buffer vessel. Like piston 26 discussed in conjunction with the embodiment denoted in FIG. 7, piston 33 is adjustable or otherwise capable of being moved to a selected position or location to define a selected volume of buffer vessel 12, and is secured in place, such as by one or more set screws or servo mechanisms of the like, at a specified position or location to define a selected volume of buffer vessel 12. Piston 33 is adjustable simply by releasing it from a given fixed location, moving it to a new location to define a desired volume of buffer vessel 12, and then affixed in place. By adjusting piston 33, the volume of buffer vessel 12 may be adjusted as needed or as the engine load dictates to provide a desired degree of buffer bypass surcharging in cylinder 11.

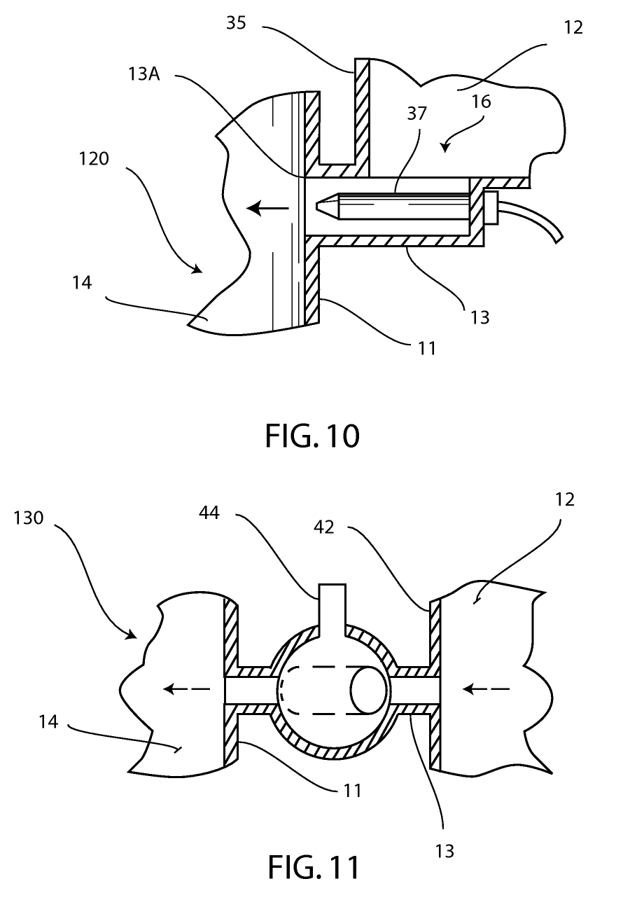

In a buffer bypass surcharging system constructed and arranged in accordance with the principle of the invention, the various embodiments of which are illustrated in FIGS. 4A-9, a fuel injection system or a water injection system can be located proximate to the conduit or pipe coupling the cylinder in gaseous communication with the buffer vessel, and this aspect of the invention is illustrated in FIG. 10 in which there is seen a fragmented schematic diagram of a venturi-injection buffer bypass supercharging system 120 that, in common with system 70 discussed previously, includes cylinder 11, piston 14, buffer vessel 12, and conduit or pipe 13 including port opening 13A into pipe at cylinder 11. The operation of system 120 is the same as that of system 70, with the additional provision of an injection system 37 formed in, or otherwise extending into, pipe 13. In this embodiment, as exhaust buffer gas 16 from buffer vessel 12 evacuates from buffer vessel 12 into cylinder 11 through pipe 13 in the exhaust gas buffer bypass surcharging a venturi effect is created in the flowing exhaust buffer gas 16 in pipe 13, and injection system 37 injects liquid, such as fuel in the embodiment where injection system 37 is a fuel injection system and water in the embodiment where injection system 37 is a water injection system, into exhaust buffer gas 16 flowing through pipe 13. As the liquid is injected into exhaust buffer gas 16 flowing through pipe, the flowing exhaust buffer gas 16 picks of the liquid, whereby the venturi turbulence formed in the flowing buffer gas helps to atomize the liquid and in which the flow of exhaust buffer gas 16 conveys the fluid to cylinder 11. The operation of cylinder 11 of system 120 in conjunction with fuel injection is as discussed in conjunction with the embodiment in FIGS. 5A and 5B, and the operation of cylinder 11 in system 120 in conjunction with water injection is as discussed in conjunction with the embodiment in FIGS. 6A and 6B.

In an exhaust gas buffer bypass surcharging system constructed and arranged in accordance with the principle of the invention, the various embodiments of which are illustrated in FIGS. 4A-10, the pipe coupling the cylinder in gaseous communication with the buffer vessel can be furnished with a closure or valve used to close the pipe, such as at engine start-up or at other times during operation of the engine in which exhaust gas buffer bypass surcharging is not desired to provide valve controlled buffer bypass surcharging. This aspect of the invention is illustrated in FIG. 11, in which there is seen a fragmented, schematic diagram of a ball valve at a ported bypass. In common with system 70 discussed previously, in FIG. 11 there is illustrated cylinder 11, piston 14, buffer vessel 12, and conduit or pipe 13, and the operation is the same as that of system 70, with the additional provision of a ball valve 44 formed in pipe 13, which is movable between a first position opening pipe 13 coupling cylinder 11 to buffer vessel 12 in gaseous communication, and a closed position closing pipe 13 isolating cylinder 11 from buffer vessel 12 interrupting gas flow from buffer vessel 12 to cylinder 11. Operation of valve 44 can be made manually, such as through activation of a switch operatively coupled to valve 44, or by the engine's computer system working in conjunction with an actuator operatively coupled to the valve 44 which opens and closes valve as needed, such as when the engine is started and when increased engine power is needed.

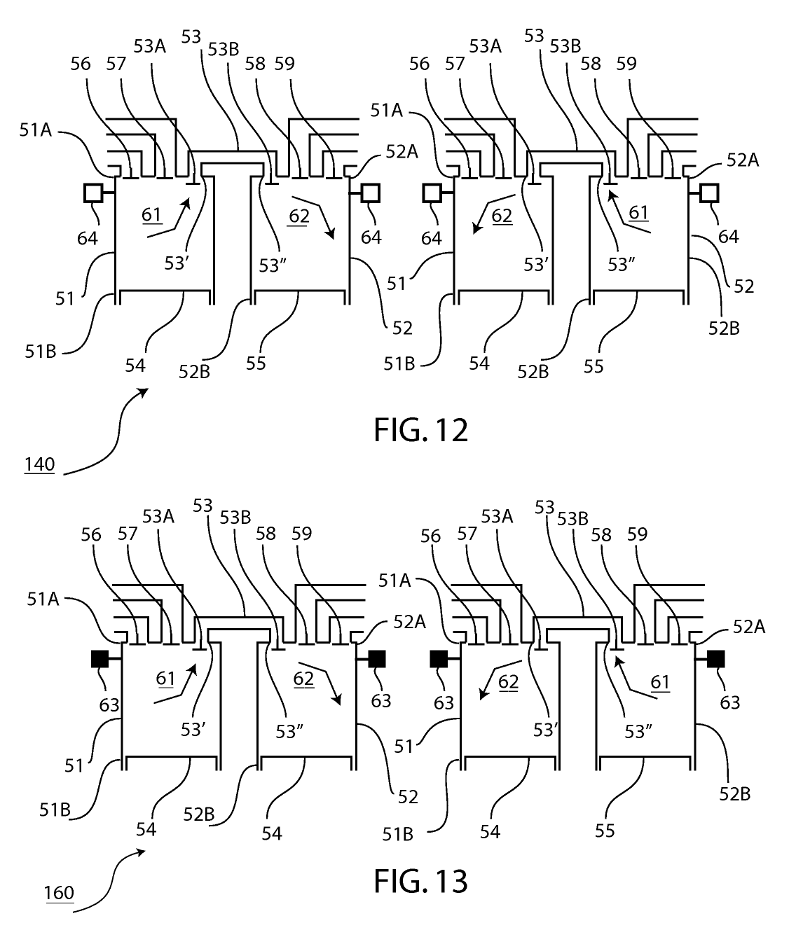

Reference is now made to FIG. 12, in which there is seen a schematic diagram of a valve controlled cylinder interconnect exhaust gas bypass surcharging system 140 of an internal combustion engine constructed and arranged in accordance with the principle of the invention. System 140 is a multi-cylinder system of an internal combustion engine and includes two pairs A and B of substantially identical cylinders formed in a cylinder block or engine block being exemplary of a four-cylinder system used in a four-cylinder engine being exemplary of a four-cylinder system to be used in a four-cylinder engine or otherwise a multi-cylinder engine having at least four cylinders. Pairs A and B of cylinders each include a cylinder 51 operatively coupled in gaseous communication to an opposed cylinder 52, in accordance with the principle of the invention. With respect to each of pairs A and B of cylinders, cylinder 51 is formed with a reciprocating piston 54, which together form a reciprocating cylinder or piston assembly, and cylinder 52 is formed with a reciprocating piston 55, which together form a reciprocating cylinder or piston assembly. Piston 54 reciprocates in cylinder 52 in a combustion cycle characterized by four strokes or processes as in a conventional four-stroke combustion cycle, which strokes or processes include the intake stroke or process where an exhaust valve 57 to cylinder 51 closes and an intake valve 56 to cylinder 51 opens up letting in air and piston 54 moves down to the bottom of its stroke to the bottom or lower end 51B of cylinder 51, the compression stroke or process where intake and exhaust valves 56 and 57 close and piston 54 moves back up to the top of its stroke at the top or upper end 51A of cylinder 51 and compresses the air, the combustion stroke or process where as piston 54 reaches the top of its stroke at the top or upper end 51A of cylinder 51 and fuel is injected at just the right moment and ignited forcing piston 54 back down to the bottom of its stroke at the bottom or lower end 51B of cylinder 51, and the exhaust stroke or process where intake valve 56 remains closed and exhaust valve 57 opens and piston 54 moves back to the top of its stroke at the top or upper end 51A of cylinder 51 pushing out the exhaust created from the combustion through exhaust valve 57 into the exhaust system or tail pipe. Piston 55 reciprocates in cylinder 52 in the same manner between the intake stroke in the intake process where an exhaust valve 58 to cylinder 52 closes and an intake valve 59 to cylinder 52 opens up letting in air and piston 55 moves down to the bottom of its stroke to the bottom or lower end 52B of cylinder 52, the compression stroke in the compression process where intake and exhaust valves 59 and 58 close and piston 55 moves back up to the top of its stroke at the top or upper end 52A of cylinder 52 and compresses the air, the combustion stroke in the combustion process where as piston 55 reaches the top of its stroke at the top or upper end 52A of cylinder 52 and fuel is injected at just the right moment and ignited forcing piston 55 back down to the bottom of its stroke at the bottom or lower end 52B of cylinder 52, and the exhaust stroke in the exhaust process where intake valve 59 remains closed and exhaust valve 58 opens and piston 55 moves back to the top of its stroke at the top or upper end 52A of cylinder 52 pushing out the exhaust created from the combustion through exhaust valve 58 into the tail pipe. Pistons 54 and 55 are each coupled to a crankshaft (not shown) with a connecting rod (not shown) in a conventional and well-known manner.

In system 140, a conduit or pipe 53 operatively couples cylinder 51 to cylinder 52 in gaseous communication, which, in this embodiment, is at the top ends 51A and 52A of cylinders 51 and 52. A valve 53A is formed in port opening 53′ to pipe 53 at cylinder 51, and a valve 53B is formed in port opening 53″ to pipe 53 at cylinder 52, which together regulate gas flow between cylinders 51 and 52.

The operation of pair A of cylinders 51 and 52 is now discussed from an initial starting position of pistons 54 and 55. The initial starting position of piston 54 consists of piston 54 positioned at the bottom of its combustion stroke at the bottom or lower end 51B of cylinder 51 in preparation for the exhaust stroke in the exhaust process, in which combustion has occurred in cylinder 51 and warm exhaust gas denoted at 61 is produced from fuel combustion in cylinder 51, intake valve 56 to cylinder 51 is closed, an exhaust valve 57 to cylinder 51 is open, and valve 53A to pipe 53 is open. The initial starting position of piston 55 consists of piston 55 positioned at the bottom of its intake stroke at the bottom or lower end 52B of cylinder 52 in preparation for the compression stroke in the compression process, intake gas 62 is drawn into cylinder 52 through intake valve 59, that is now closed, an exhaust valve 58 to cylinder 52 is closed, and valve 53B to pipe 53 is open.

At the initial positions of pistons 54 and 55 as described above, exhaust gas 61 in cylinder 51 is warm and of high pressure and intake gas 62 in cylinder 52 is cold and of low pressure, which forms a pressure differential across cylinders 51 and 52 to cause warm exhaust gas 61, or bypass gas, to pass into cylinder 52 through pipe 53, where it meets and mixes with cold intake gas 62 in cylinder 52. A volume of the warm exhaust gas denoted at 61 flows from cylinder 51 to cylinder 52 through pipe 53 through open valves 53A and 53B because the warm exhaust gas 61 in cylinder 51 has higher pressure than the cold intake gas 62 in cylinder 52. The flow of warm exhaust gas 61 from cylinder 51 to cylinder 52 through pipe 53 is bypass surcharging in the form of exhaust gas bypass surcharging, in accordance with the principle of the invention.

At this point in the operation of cylinders 51 and 52, cylinder 51 is relieved of a volume of exhaust gas 61 or bypass gas, which is received by cylinder 52 from pipe 53. Because cylinder 51 is relieved of a volume of exhaust gas 61 at the bottom of the combustion stroke of piston 54 at the bottom or lower end 51B of cylinder 51, there is an initial pressure reduction in cylinder 51 before piston 54 initiates its exhaust stroke, which pressure reduction cools the exhaust gas 61 in cylinder 2. Because cylinder 52 is provided or otherwise charged with a volume of exhaust gas 61 from cylinder 51 through pipe 53 at the bottom of the intake stroke of piston 55, which is exhaust gas bypass surcharging, there is an initial pressure increase in cylinder 52 before piston 55 initiates its compression stroke, which pressure increase produces a pressure pre-charging in cylinder 52 before piston 55 initiates its compression stroke in the compression process.

With cylinder 51 relieved of exhaust gas 61 with piston 54 at the bottom of the compression stroke and with cylinder 52 charged with a corresponding volume of exhaust gas 61 from cylinder 51 thereby pre-pressurizing cylinder 52 and also warming the intake gas 62 in cylinder 52, valves 53A and 53B to pipe 53 close isolating cylinder 51 from cylinder 52 preventing gas flow therebetween, exhaust valve 57 is open and piston 54 initiates its exhaust stroke in the exhaust process moving upwardly away from the bottom of cylinder 51 to the top or upper end 51A of cylinder 51, and piston 55 initiates its compression stroke in the compression process moving upwardly away from the bottom of cylinder 52 to the top or upper end 52A of cylinder 52

At this point, the volumes of both cylinders 51 and 52 are now approximately equal to full cylinder volume, and piston 54 continues movement through its exhaust stroke and piston 55 continues movement through its compression stroke. In the movement of piston 54 through its exhaust stroke, the exhaust gas 61 in cylinder 51, which is precooled as a result of the pressure reduction in cylinder 51 produced by the bypass surcharging according to the principle of the invention, is exhausted through the corresponding exhaust valve 57 associated with cylinder 51 and into the exhaust system or tail pipe. As piston 55 moves along its compression stroke it compresses the intake gas 62, including the bypass gas, in cylinder 52, in which the initial warming of the intake gas 61 in cylinder 52 and the pre-pressurization of the intake gas 62 in cylinder 52 at the end of the prior intake stroke of piston 55 produced by the intake of the volume of the warm exhaust gas 61 from cylinder 51 in the bypass surcharging increases the resulting temperature of the intake gas 62 in cylinder 52 and the resulting gas pressurization of the intake gas 62 in cylinder 52 through the movement of piston 55 through its compression stroke in the compression process. At the top of the compression stroke of piston 55 in the compression process the temperature of the intake gas 62 is increased and the pressure in cylinder 52 is increased thus by heat and the volume of bypass gas introduced into cylinder 52 resulting from the bypass surcharging. Because heat and compression make the explosion more powerful, this increased heat and pressure of the intake gas 62 in cylinder 52 at the top of the compression stroke of piston 55 in the compression process from the bypass surcharging produces a more powerful, efficient and complete explosion of the introduced gas in cylinder 52 thereby producing a more powerful and efficient combustion stroke of piston 55 in the combustion process and saves fuel, in accordance with the principle of the invention. At this point, valves 53A and 53B between pipe 53 and cylinders 51 and 52 are closed, exhaust valve 57 to cylinder 51 is closed and exhaust valve 58 to cylinder 52 is closed, intake valve 56 to cylinder 51 is open, intake valve 59 to cylinder 52 is closed, and piston 54 moves from its top position and downwardly along its intake stroke in the intake process intaking cold intake gas into cylinder 51, and piston 55 moves downwardly along its combustion stroke, whereby as pistons 54 and 55 approach their respective bottom positions valves 53A and 53B to pipe 53 open allowing warm exhaust gas to flow from cylinder 52 to cylinder 51 through pipe 53 providing the exhaust gas bypass surcharging from cylinder 52 to cylinder 51, and this combustion process so continues between cylinders 51 and 52 in accordance with the principle of the invention.

The exemplary benefits of the exhaust gas bypass surcharging in system 140 are those discussed above in the previous embodiments. Pair B of cylinders 51 and 52 functions identically to the function of pair A of cylinders, except that the cycle of exhaust gas bypass surcharging is simply reversed, such that when exhaust gas bypass surcharging is occurring from cylinder 51 to cylinder 52 in pair A of cylinders 51 and 52, exhaust gas bypass surcharging is occurring from cylinder 52 to cylinder 51 in pair B of cylinders 51 and 52. Gas and diesel engines can be modified to use the structure specified by system 140.

FIG. 13 is a schematic diagram of the system of FIG. 12 constructed with fuel injection features, in which the system in FIG. 2 is denoted generally by the reference character 160. In the present embodiment, cylinders 51 and 52 of sides A and B are each furnished with a fuel injection system 63. The provision of fuel injection systems 63 defines system 160 as an in-bypass fuel-injection system (BFI). Fuel injection systems 63 each inject fuel into the respective cylinder in the compression cycle of the corresponding piston thereby increasing the pressure of the gas in the compression stroke of the corresponding piston for better and quicker fuel-gas mixing and warming up due to the pressure increase and thereby providing a more powerful explosion and a more powerful piston compression stroke thereby increasing engine power. If desired, fuel injection systems 63 can each be configured to inject merely air to provide further increased pressurization and excess oxidant to produce a better explosion in the combustion cycle thereby increasing engine power.

The increased engine power produced by the provision of fuel injection systems 63 can be used at selected times as needed, such as during times of acceleration, take-off, etc. As such, fuel injection systems 63 may be inactive during normal engine run, and activated at specified cleaning times or when increased engine power is required. Activation of fuel injection systems 63 can be made manually, such as through activation of a switch operatively coupled to fuel injection systems 63, or by the engine's computer system working in conjunction with an actuator operatively coupled to the fuel injection systems 63. In the present embodiment, cylinders 52 and 51 of sides A and B, respectively are each also furnished with a fuel injection system 63 and the operation is the same as before.

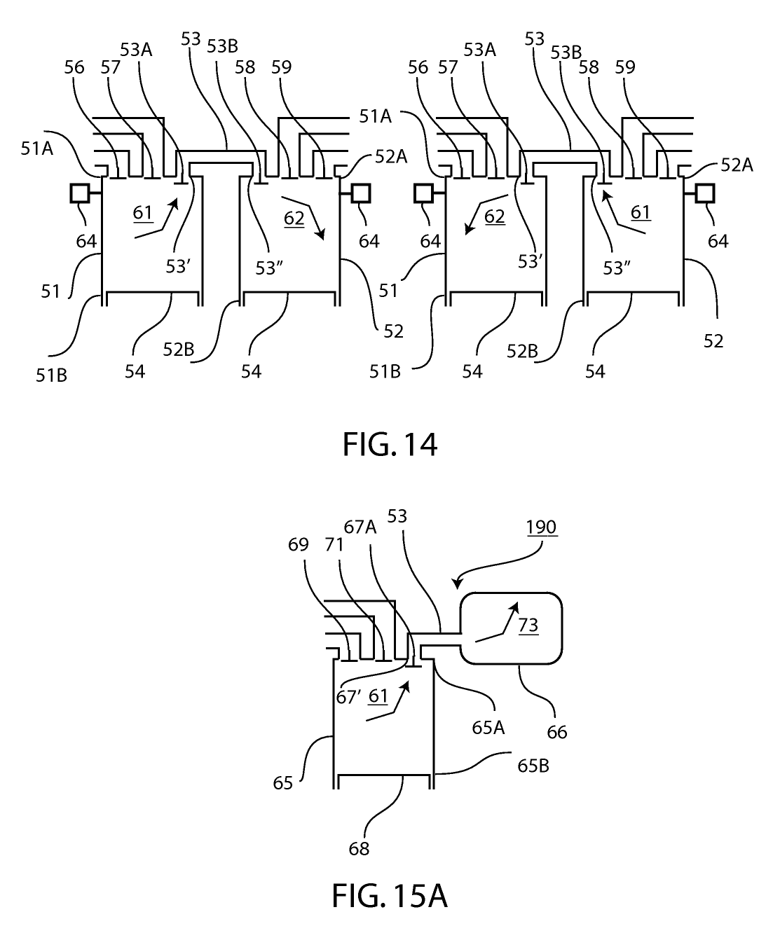

Attention is now directed to FIG. 14, in which there is seen a schematic diagram of the system of FIG. 12 constructed with water injection features, in which the system in FIG. 14 is denoted generally by the reference character 170. In this embodiment, cylinders 51 and 52 of sides A and B of cylinders 51 and 52 are each formed with a water injection system 64. The water utilized in conjunction with each water injection system 64, which is housed in a tank, can be furnished with a desired volume percent of alcohol, ethanol, or other clean-burning liquid to prevent the water from freezing in cold temperatures. The added alcohol, ethanol, or the like can burn and thus serves as fuel, in accordance with the principle of the invention.

Water injection systems 64 each inject water into the respective cylinder in the compression cycle which instantly evaporates and converts to steam in the combustion stroke of the corresponding piston, which increases the pressure of the intake gas thereby increasing the pre-pressurization of the corresponding cylinder in the compression stroke of the corresponding piston thereby increasing the power of combustion in the cylinder improving the power of the combustion stroke of the corresponding piston thereby increasing engine power. The steam produced from this embodiment of the invention also cleans the cylinders and pistons in system 170, in accordance with the principle of the invention. For cleaning purposes, water injection may be provided at selected intervals, as needed. Again, the steam pressure increases the intake-gas pre-compression pressure and thus increases the power of combustion and the power of the consecutive piston stroke, in accordance with the principle of the invention. The increased engine power produced by the provision of water injection systems 64 can be used at selected times as needed, such as during times of acceleration, take-off, etc. As such, water injection systems may be inactive during normal engine run, and activated at specified cleaning times or when increased engine power is required. Activation of water injection systems 64 can be made manually, such as through activation of a switch operatively coupled to water injection systems 64, or by the engine's computer system working in conjunction with an actuator operatively coupled to the water injection systems 64. The provision of water injection systems 64 defines system 170 as an in-bypass water-injection system. In this embodiment, cylinders 52 and 51 of sides A and B of cylinders 51 and 52 are each also formed with a water injection system 64 and the operation is the same as described above. The best time for water injection is just prior to spark or compression ignition.

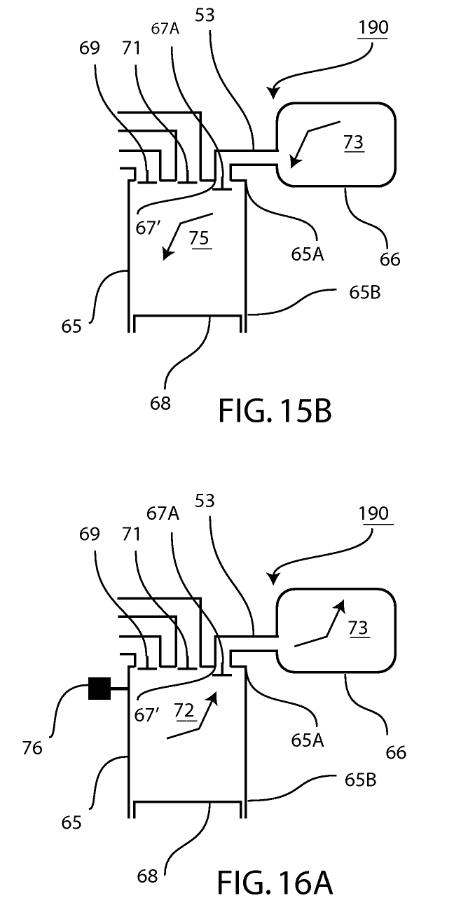

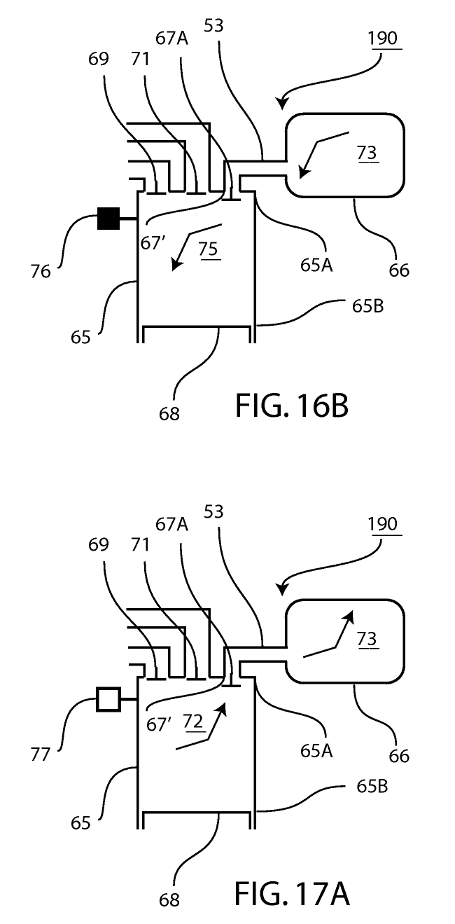

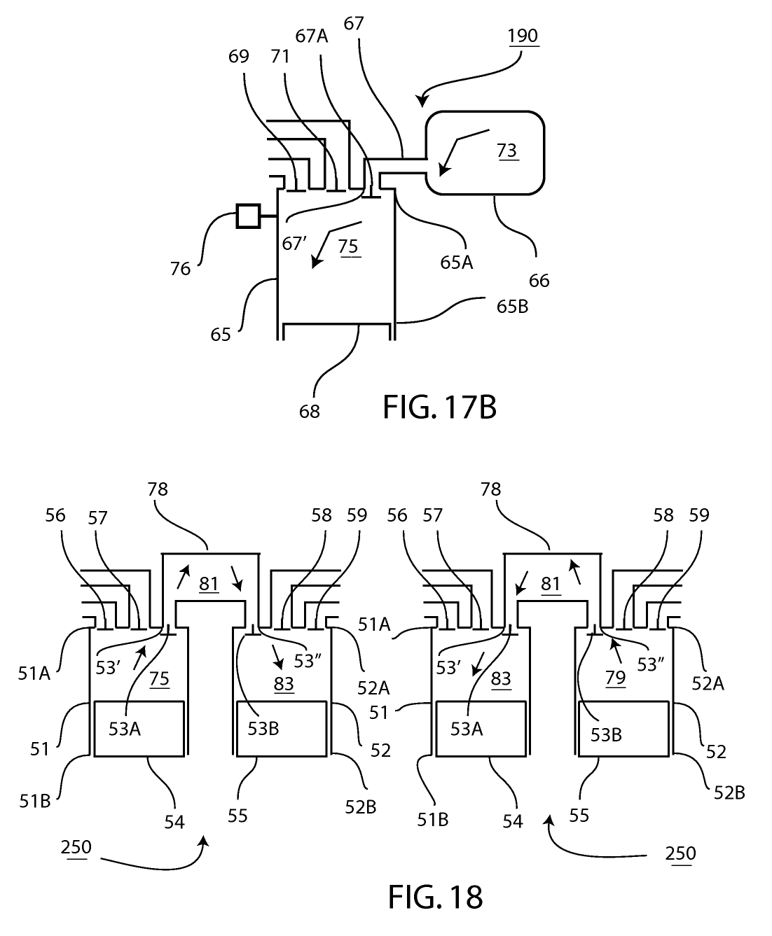

Attention is now directed to FIGS. 15A, 15B, 16A, 16B, 17A, and 17B, in which FIGS. 15A and 15B are schematic diagrams of stages of operation of a valve controlled single cylinder exhaust gas buffer bypass surcharging system 190 of an internal combustion engine constructed and arranged in accordance with the principle of the invention, FIGS. 16A and 16B are schematic diagrams of stages of operation of system 190 of FIGS. 15A and 15B constructed with fuel injection features, and FIGS. 17A and 17B are schematic diagrams of stages of operation of system 190 of FIGS. 15A and 15B constructed with water injection features.

Referencing FIG. 15A, system 190 includes a cylinder assembly, formed in a cylinder block or engine block, including a cylinder 65 and a piston 68 reciprocated therein, which together form a reciprocating cylinder or piston assembly, and a buffer vessel 66 operatively coupled to cylinder 65 in gaseous communication. Piston 68 reciprocates in cylinder 65 in a combustion cycle, as in prior embodiments, characterized by four strokes or processes as in a conventional four-stroke combustion cycle, which strokes include the intake stroke in the intake process where an exhaust valve 71 to cylinder 65 is closed and an intake valve 69 to cylinder 65 is open letting in air and piston 68 moves down to the bottom of its stroke to the bottom or lower end 65B of cylinder 65, the compression stroke in the combustion process where intake and exhaust valves 69 and 71 are closed and piston 68 moves back up to the top of its stroke at the top or upper end 65A of cylinder 65 and compresses the air, the combustion stroke in the combustion process where as piston 68 reaches the top of its stroke at the top or upper end 65A of cylinder 65 and fuel is injected at just the right moment and ignited forcing piston 68 back down to the bottom of its stroke at the bottom or lower end 65B of cylinder 65, and the exhaust stroke in the exhaust process where intake valve 69 remains closed and exhaust valve 71 opens and piston 68 moves back to the top of its stroke at the top or upper end 65B of cylinder 65 pushing out the exhaust created from the combustion into the exhaust system or tail pipe through open exhaust valve 71. Piston 68 is coupled to a crankshaft (not shown) with a connecting rod (not shown) in a conventional and well-known manner.

In system 190, a conduit or pipe 67 operatively couples cylinder 65 to buffer vessel 66 in gaseous communication, which, in this embodiment, is at the top end of cylinder 65. A valve 67A is formed in port opening 67′ to pipe 67 at cylinder 65 to regulate gas flow between cylinder 65 and buffer vessel 66.

The operation of system 190 will be discussed from an initial starting position illustrated in FIG. 15A consisting of piston 68 positioned at the bottom of its combustion stroke at the bottom or lower end 65B of cylinder 65 at the end of the combustion process in preparation for the exhaust stroke in the exhaust process, in which combustion has occurred in cylinder 65 and warm exhaust gas denoted at 72 is produced from fuel combustion in cylinder 65, intake valve 69 to cylinder 65 is closed, exhaust valve 71 to cylinder 65 is open, and valve 67A to pipe 67 leading to buffer vessel 66 is open. A volume of the warm exhaust 72 flows from cylinder 65 to buffer vessel 66 through pipe 67 because the warm exhaust gas 72 in cylinder 65 has higher pressure than the pressure of the comparatively cool gas in buffer vessel 66. The flow of warm exhaust gas 72 from cylinder 65 to buffer vessel 66 through pipe 67 is bypass surcharging in the form of exhaust gas buffer bypass surcharging, in accordance with the principle of the invention.

At this point in the operation of cylinder 65, cylinder 65 is relieved of a volume of warm exhaust or bypass gas 72, which is received by buffer vessel 66 from pipe 67. The warm exhaust gas received by buffer vessel 66 from cylinder 65 through pipe 67 is buffer gas 73. Because cylinder 65 is relieved of a volume of exhaust gas 72 at the bottom of the combustion stroke of piston 68, there is an initial pressure reduction in cylinder 65 before piston 68 initiates its exhaust stroke, which pressure reduction cools the exhaust gas 72 in cylinder 65.

With cylinder 65 relieved of a volume of warm exhaust gas 72 with piston 68 at the bottom of the compression stroke, buffer vessel 66 is charged with a corresponding volume of warm exhaust gas or bypass gas 73 from cylinder 65. From this point, valve 67A closes isolating cylinder 65 from buffer vessel 66 thereby capturing buffer gas 73 in buffer vessel 66, intake valve 69 is closed and exhaust valve 71 opens and piston 68 continues its exhaust stroke in the exhaust process moving upwardly away from the bottom of cylinder 65 to the top of cylinder 65. The volume of cylinder 65 at this stage of operation is now approximately equal to full cylinder volume, and piston 68 continues movement through its exhaust stroke in the exhaust process. In the movement of piston 68 through its exhaust stroke, the exhaust gas 72 in cylinder 65, which is precooled as a result of the pressure reduction in cylinder 65 produced by the exhaust gas buffer bypass surcharging according to the principle of the invention, is exhausted through the corresponding exhaust valve 71 associated with cylinder 65 and into the tail pipe. Piston 14 moves along its exhaust stroke in the exhaust process and into the following intake stroke in the intake process as illustrated in FIG. 15B, in which intake valve 69 and valve 67A open and exhaust valve 71 closes. As piston 68 moves along its intake stroke in the intake process from its top position at the top or upper end 65A of cylinder 65 to its bottom position at the bottom or lower end 65B of cylinder 65, intake gas 75 is drawn into cylinder 65 through intake valve 69, which is cooler than the warm retained buffer gas 73 in buffer vessel 66. Because intake gas 75 in cylinder 65 taken in during the intake stroke of piston 68 is comparatively cooler than the buffer gas 73 maintained in buffer vessel 66, there is a pressure differential across cylinder 65 and buffer vessel 66 and the buffer gas 73 in buffer vessel 66 thus passes into cylinder 65 from through valve 67A of pipe 67 from buffer vessel 66 in the intake stroke of piston 68, which buffer gas 73 passing into cylinder 65 initially warms the intake gas 75 in cylinder 65 and also pre-pressurizes cylinder 65, in accordance with the principle of the invention. Again, buffer gas 73 flows from buffer vessel 66 to cylinder 65 through pipe 67 in the open position of valve 67A because buffer gas 73 in buffer vessel 66 is comparatively warmer than intake gas 75 in cylinder 65 and thus has higher pressure than intake gas 75 in cylinder 65.

The flow of buffer gas 73 from buffer vessel 66 to cylinder 65 through pipe 67 is exhaust gas buffer bypass surcharging, in accordance with the principle of the invention. Because buffer vessel 66 is relieved of a volume of the buffer gas 73 and cylinder 65 is provided or otherwise charged with a corresponding volume of buffer gas 73 from buffer vessel 66 in the buffer bypass surcharging, there is an initial warming of intake gas 75 in cylinder 65 and an initial pressure increase in cylinder 65 before piston 68 initiates its compression stroke, which warming of the intake gas 75 in cylinder 65 produces a pre-warming of intake gas 75 in cylinder 65 and which pressure increase produces a pressure pre-charging in cylinder 65 before piston 68 initiates its compression stroke.

With buffer vessel 66 relieved of a volume of buffer gas 73 and cylinder 65 charged with a corresponding volume of buffer gas 73 from buffer vessel 66 thereby pre-pressurizing cylinder 65 and also pre-warming intake gas 75 in cylinder 65, valve 67A closes isolating cylinder 65 from buffer vessel 66, and with intake and exhaust valves 69 and 71 also closed piston 68 initiates its compression stroke in the compression process moving upwardly away from the bottom of cylinder 65 to the top of cylinder 65. At this point, the volume of cylinder 65 is now approximately equal to full cylinder volume, and buffer vessel 66 is substantially relieved of buffer gas 73 and is cooled due to the pressure reduction in buffer vessel 66 due to the evacuation of buffer gas 73 in the buffer bypass surcharging. Piston 68 continues movement through its compression stroke in the compression process, and as piston 68 moves along its compression stroke in the compression process it compresses the gas, including the buffer gas, in cylinder 65, in which the initial warming of intake gas 75 in cylinder 65 and the pre-pressurization of intake gas 75 in cylinder 65 at the end of the prior intake stroke of piston 68 produced by the intake of the buffer gas 73 from buffer vessel 66 in the exhaust gas buffer bypass surcharging increases the resulting temperature of intake gas 75 in cylinder 65 and the resulting gas pressurization of the gas in cylinder 65 through the movement of piston 68 through its compression stroke in the compression process. At the top of the compression stroke of piston 68 in the compression process the temperature of intake gas 75 is increased and the pressure in cylinder 65 is increased thus by heat and the volume of buffer gas introduced into cylinder 65 resulting from the exhaust gas buffer bypass surcharging. Because heat and compression makes the explosion more powerful, this increased heat and pressure of intake gas 75 in cylinder 65 at the top of the compression stroke of piston 68 produces a more powerful explosion of the introduced gas in cylinder 65 thereby producing a more powerful, efficient, and complete combustion stroke of piston 68 and saves fuel, in accordance with the principle of the invention. At this point, piston 68 moves downwardly along its combustion stroke and valve 67A to pipe 67 to buffer vessel 66 opens in which the exhaust gas buffer bypass surcharging takes place from cylinder 65 to buffer vessel 66, whereby warm exhaust gas passes from cylinder 65 to buffer vessel 66 through pipe 67 relieving cylinder 65 of a volume of the warm exhaust gas and charging buffer vessel 66 with a volume of the exhaust gas from cylinder 65 and this process so continues through the next combustion cycle of piston 68. System 190 can be used in a multi-cylinder internal combustion engine, or a single cylinder internal combustion engine.

FIGS. 16A and 16B are schematic diagrams of stages of operation of system 190 of FIGS. 15A and 15B constructed with fuel injection features. In system 190, cylinder 65 includes a fuel injection system 76, and provides fuel injection into cylinder 65 in the compression stroke of piston 68 in the compression process as illustrated in FIG. 16B. Fuel injection system 76 provides for better and quicker fuel-gas mixing and warming up in cylinder 65 and better and more efficient and more powerful combustion in cylinder 65 and a more powerful combustion stroke of in piston 68 in the combustion process thereby increasing engine power. If desired, fuel injection system 76 can each be configured to inject merely air to provide further increased pressurization and better explosion in the combustion cycle thereby increasing engine power and saving fuel, in accordance with the principle of the invention.

The increased engine power produced by the provision of fuel injection system 76 can be used at selected times as needed, such as during times of acceleration, take-off, etc. As such, fuel injection system 76 may be inactive during normal engine run, and activated at specified cleaning times or when increased engine power is required. Activation of fuel injection system 76 can be made manually, such as through activation of a switch operatively coupled to fuel injection system 76, or by the engine's computer system working in conjunction with an actuator operatively coupled to the fuel injection system 76.

FIGS. 17A and 17B are schematic diagrams of stages of operation of system 190 of FIGS. 15A and 15B constructed with water injection features. In system 190, cylinder 65 includes a water injection system 77, and provides water injection into cylinder 65 in the compression stroke of piston 68 in the compression process as illustrated in FIG. 16B, which injected water instantly evaporates and converts to steam increasing the pressure in cylinder 65 thereby increasing the power of combustion in cylinder 65 improving the power of the combustion stroke of piston 68 thereby increasing engine power, in accordance with the principle of the invention. The steam produced from this embodiment of the invention also cleans cylinder 65 and piston 68, in accordance with the principle of the invention. For cleaning purposes, water injection may be provided at selected intervals, as needed. Again, the steam pressure increases the intake-gas pre-compression pressure and thus increases the power of the consecutive piston stroke in cylinder 65 and saves fuel, in accordance with the principle of the invention. The increased engine power produced by the provision of water injection system 77 can be used at selected times as needed, such as during times of acceleration, take-off, etc. As such, water injection system 77 may be inactive during normal engine run, and activated at specified cleaning times or when increased engine power is required. Activation of water injection system 77 can be made manually, such as through activation of a switch operatively coupled to water injection system 77, or by the engine's computer system working in conjunction with an actuator operatively coupled to the water injection system 77.

Attention is now turned to FIG. 18, which is a schematic diagram of the system of FIG. 12, in which conduit or pipe 53 of each of sides A and B of cylinders 51 and 52 of system 170 illustrated in FIG. 14 is replaced with a bypass manifold 78. The system in FIG. 18 is denoted at 250. Bypass manifolds 78 in sides A and B of cylinders 51 and 52 of system 250 are each greater in volume than the volume of pipes 53, respectively, of sides A and B of cylinders 51 and 52 in system 170 of FIG. 14.

The operation of pair of cylinders 51 and 52 in system 250 is now discussed from an initial starting position of pistons 54 and 55. The initial starting position of piston 54 consists of piston 54 positioned at the top of its compression stroke at the end of the compression process at maximum compression in cylinder 51 in preparation for ignition and movement of piston 54 into its combustion stroke in the combustion process, in which cylinder 51 is charged with a fuel/air mixture or ignition gas 79 which piston 54 has compressed, intake and exhaust valves 56 and 57 are closed, and yet valve 53A at cylinder 51 to bypass manifold 78 is open and valve 53B at cylinder 52 is closed, whereby ignition gas 79 is forced into bypass manifold 78 through open valve 53A providing bypass manifold 78 with a charge of uncombusted ignition bypass gas 81. The initial starting position of piston 55 consists of piston 55 approaching the top of its compression stroke at the end of the compression cycle in preparation for ignition and movement of piston 55 into its combustion stroke in the combustion process, in which piston 55 is compressing in cylinder 52 a charge of fuel/air mixture or ignition gas 83, intake and exhaust valves 59 and 58 are closed as is valve 53B between cylinder 52 and bypass manifold 78.

From this initial starting position of cylinders 51 and 52, valve 53B between cylinder 52 and bypass manifold 78 opens and the compressed ignition gas 79 in cylinder 51 ignites, which, in turn, ignites the ignition bypass gas 81 in bypass manifold 78 creating not only tremendous pressure in cylinder 51 driving piston 54 into its combustion stroke in the combustion process but also creating tremendous pressure in bypass manifold 78. At this moment of operation, the ignited ignition gas 79 is present in cylinder 51 and ignited ignition bypass gas 81 is formed in bypass manifold 78 and valve 53A between cylinder 51 and bypass manifold 78 closes. The tremendous pressure formed in bypass manifold 78 formed by the ignited ignition bypass gas 81 forcibly applies the ignited, and very hot, ignition bypass gas 81, which is essentially a plasma or plasma gas, into cylinder 52 through open valve 53B just as piston 55 reaches the top of its compression stroke. At the top of the compression stroke of piston 55, the forcible application of the ignited, and very hot, ignition bypass gas 81 increases the pressure of the already compressed ignition gas 83 in cylinder 52 and also ignites the compressed ignition gas 83 just as valve 53B between cylinder 52 and bypass manifold 78 closes forming an improved and more power ignition in cylinder 52 thereby producing a more powerful and efficient combustion stroke of piston 55 increasing engine power, in accordance with the principle of the invention. This transfer of ignition gas 79 from cylinder 51 to bypass manifold 78 to charge bypass manifold 78 with uncombusted ignition bypass gas 81 and the resulting transfer of ignited ignition bypass gas 81 to ignition gas 83 in cylinder 52 so continues between cylinders 51 and 52 and is ignition gas bypass surcharging or bypass jet or volume jet ignition or supraignition, in which system 250 is exemplary of a valve controlled double-cylinder interconnect bypass volume jet ignition system or supraignition system constructed and arranged in accordance with the principle of the invention. The ignition gas bypass surcharging cycle also takes place in conjunction with pair B of cylinders 51 and 52 in system 250, in which the ignition gas bypass surcharging or supraignition cycles between pairs A and B of cylinders 51 and 52, according to the principle of the invention. If desired, system 250 can be formed with fuel injection systems or water injection systems to provide still more powerful cylinder combustion, better cylinder combustion, and fuel savings, as discussed in previous embodiments of the invention.

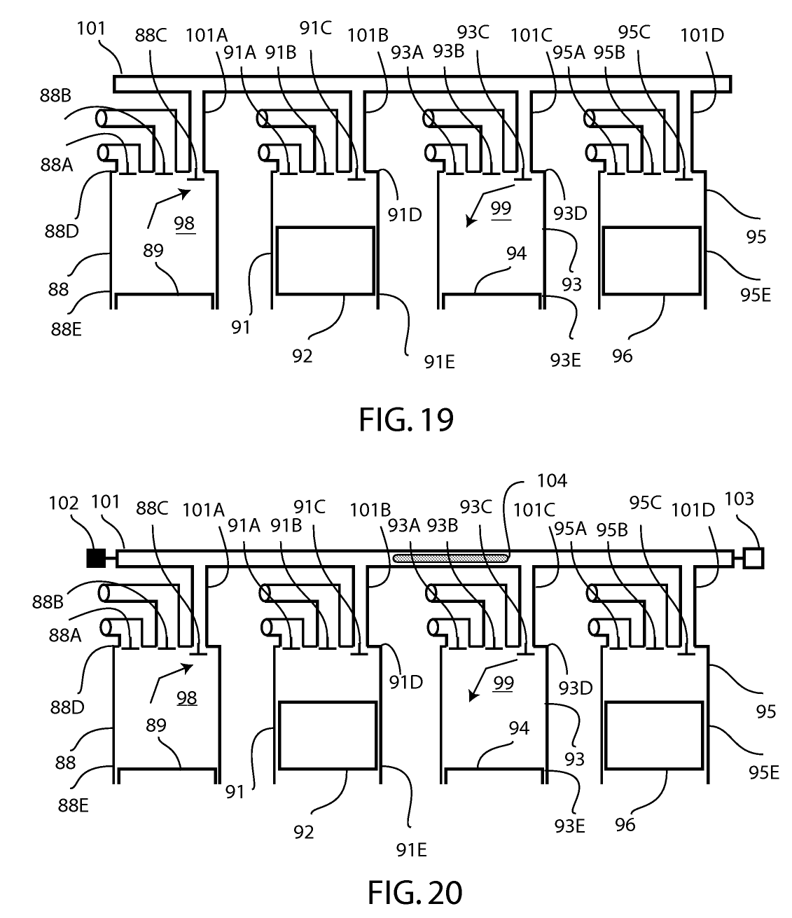

Reference is now made to FIG. 19, which is a schematic diagram of a valve controlled cylinder interconnect exhaust gas bypass surcharging system 270 of an internal combustion engine with common-conduit, manifold, or common-pipe multi-cylinder interconnect constructed and arranged in accordance with the principle of the invention. In this embodiment, system 270 is a four-cylinder system of an internal combustion engine. System 270 includes cylinders 88, 91, 93 and 95, and corresponding pistons 89, 92, 94 and 96, respectively, formed in a cylinder block or engine block. Pistons 89, 92, 94, and 96 each move along a combustion cycle in a combustion process consisting of the intake stroke in the intake process, the compression stroke in the compression process, the combustion stroke in the combustion process, and the exhaust stroke in the exhaust process. Cylinder 88 is associated with corresponding intake and exhaust valves 88A and 88B, whereby intake valve 88A opens to apply intake gas into cylinder 88 in the intake stroke of piston 89 in the intake process and exhaust valve 88B opens in the exhaust stroke of piston 89 in the exhaust process to apply exhaust gas from cylinder 88 to the tail pipe. Cylinder 91 is associated with corresponding intake and exhaust valves 91A and 91B, whereby intake valve 91A opens to apply intake gas into cylinder 91 in the intake stroke of piston 92 in the intake process and exhaust valve 91B opens in the exhaust stroke of piston 92 in the exhaust process to apply exhaust gas from cylinder 91 to the tail pipe. Cylinder 93 is associated with corresponding intake and exhaust valves 93A and 93B, whereby intake valve 93A opens to apply intake gas into cylinder 93 in the intake stroke of piston 94 in the intake process and exhaust valve 93B opens in the exhaust stroke of piston 94 in the exhaust process to apply exhaust gas from cylinder 93 to the tail pipe. Cylinder 95 is associated with corresponding intake and exhaust valves 95A and 95B, whereby intake valve 95A opens to apply intake gas into cylinder 95 in the intake stroke of piston 96 in the intake process and exhaust valve 95B opens in the exhaust stroke of piston 96 in the exhaust process to apply exhaust gas from cylinder 95 to the tail pipe.

In system 270, a bypass conduit or pipe 101 is operatively coupled in gaseous communication to cylinders 88, 91, 93, and 95, thereby coupling cyclinders 88, 91, 93, and 95 in gaseous communication. In the present embodiment, a pipe 101A operatively couples pipe 101 to the top or upper end 88D of cylinder 88 in gaseous communication, a pipe 101B operatively couples pipe 101 to the top or upper end 91D of cylinder 91 in gaseous communication, a pipe 101B operatively couples pipe 101 to the top or upper end 93D of cylinder 93 in gaseous communication, and a pipe 101D operatively couples pipe 101 to the top or upper end 95D of cylinder 95 in gaseous communication. A bypass valve 88C is provided between the port opening into pipe 101A and cylinder 88, a bypass valve 91C is provided between the port opening into pipe 101B and cylinder 91, a bypass valve 93C is provided between the port opening into pipe 101C and cylinder 93, and a bypass valve 95C is provided between the port opening into pipe 101D and cylinder 95, which valves regulate or otherwise control gas flow between the cylinders, and between pipe 101 and the cylinders.

The operation of system 270 will be discussed from an initial starting position, in which piston 89 is positioned at the bottom of its combustion stroke at the bottom or lower end 88E of cylinder 88 in preparation for the exhaust stroke in the exhaust process, piston 92 is positioned at the top of its compression stroke at the top or upper end 91D of cylinder 91 at the end of the compression process in preparation for the combustion stroke of the combustion process, piston 94 is positioned at the bottom of its intake stroke of the intake process at the bottom or lower end 93E of cylinder 93 in preparation for the compression stroke of the compression process, and piston 96 is positioned at the top of its exhaust stroke at the top or upper end 95D of cylinder 95 at the end of the exhaust process in preparation for the intake stroke of the intake process. In the starting position of piston 89, combustion has occurred in cylinder 88 and warm exhaust gas denoted at 98 is produced from fuel combustion in cylinder 88, intake valve 88A to cylinder 88 is closed, exhaust valve 88B to cylinder 88 is open, and bypass valve 88C to pipe 101A in gaseous communication to pipe 101 is open. In the starting position of piston 92, compression of gas has occurred in preparation for ignition and intake, exhaust, and bypass valves 91A-91C are closed. In the starting position of piston 94, intake of intake gas has occurred in preparation for the compression stroke, intake and exhaust valves 93A and 93B are closed, and bypass valve 93C is open. In the starting position of piston 96, exhaust gas has been exhausted from cylinder 95, exhaust and bypass valves 95B and 95C are closed and intake valve 95A is preparing to open in preparation for the intake stroke of piston 96.

At the initial starting position of piston 89 at the end of the combustion stroke of the combustion cycle and the initial position of piston 94 at the end of the intake stroke of the intake process, exhaust gas 98 in cylinder 88 is warm and intake gas 99 in cylinder 93 is cold, which causes a pressure differential across cylinders 88 and 93 causing warm exhaust gas 98, or bypass gas, to pass into pipe 101A through bypass valve 88C, from pipe 101A into bypass conduit 101, from bypass conduit 101 into pipe 101C, and from pipe 101C into cylinder 93 through open bypass valve 93C, where the warm exhaust gas meets and mixes with cold intake gas 99 in cylinder 93, in accordance with the principle of the invention. A volume of the warm exhaust gas denoted at 98, which can be referred to as bypass gas, flows from cylinder 88 to cylinder 93 because the warm exhaust gas 98 in cylinder 88 has higher pressure than the cold intake gas 99 in cylinder 93. The flow of warm exhaust gas 98 from cylinder 88 to cylinder 93 is a form of surcharging consisting of exhaust gas bypass surcharging, in accordance with the principle of the invention.

At this point in the operation of cylinders 88 and 93, cylinder 88 is relieved of a volume of exhaust gas 98 or bypass gas, which is received by cylinder 93 via bypass conduit 101. Because cylinder 88 is relieved of a volume of exhaust gas 98 at the bottom of the combustion stroke of piston 89, there is an initial pressure reduction in cylinder 88 before piston 89 initiates its exhaust stroke in the exhaust process, which pressure reduction cools the exhaust gas 98 in cylinder 88 Because cylinder 93 is provided or otherwise charged with a volume of exhaust gas 98 from cylinder 88 via bypass conduit 101 at the bottom of the intake stroke of piston 94, which is a form of surcharging consisting of exhaust gas bypass surcharging, there is an initial pressure increase in cylinder 93 before piston 94 initiates its compression stroke in the compression process, which pressure increase produces a pressure pre-charging in cylinder 93 before piston 94 initiates its compression stroke. With cylinder 88 relieved of exhaust gas 98 with piston 89 at the bottom of the combustion stroke and with cylinder 93 charged with a corresponding volume of exhaust gas 98 from cylinder 88 thereby pre-pressurizing cylinder 93 and also warming the intake gas 99 in cylinder 93, bypass valves 88C and 93C close isolating cylinder 88 from cylinder 93 preventing gas flow therebetween, exhaust valve 88B is open and piston 89 initiates its exhaust stroke moving upwardly away from the bottom of cylinder 88 to the top of cylinder 88, and piston 94 initiates its compression stroke moving upwardly away from the bottom of cylinder 93 to the top of cylinder 93.

At this point, the volumes of both cylinders 88 and 93 are now approximately equal to full cylinder volume, and piston 89 continues movement through its exhaust stroke of the exhaust process and piston 94 continues movement through its compression stroke in the compression process. In the movement of piston 89 through its exhaust stroke in the exhaust process, the exhaust gas 98 in cylinder 88, which is precooled as a result of the pressure reduction in cylinder 88 produced by the exhaust gas bypass surcharging according to the principle of the invention, is exhausted through the corresponding exhaust valve 88B associated with cylinder 88 and into the tail pipe. As piston 94 moves along its compression stroke in the compression process it compresses the intake gas 99, including the bypass gas, in cylinder 93, in which the initial warming of the intake gas 99 in cylinder 93 and the pre-pressurization of the intake gas 99 in cylinder 93 at the end of the prior intake stroke of piston 94 produced by the intake of the volume of the warm exhaust gas 98 from cylinder 88 in the bypass surcharging increases the resulting temperature of the intake gas 99 in cylinder 93 and the resulting gas pressurization of the intake gas 99 in cylinder 93 through the movement of piston 94 through its compression stroke. At the top of the compression stroke of piston 94 the temperature of the intake gas 99 is increased and the pressure in cylinder 93 is increased thus by heat and the volume of bypass gas introduced into cylinder 93 resulting from the bypass surcharging. Because heat and compression make the explosion more powerful, this increased heat and pressure of the intake gas 99 in cylinder 93 at the top of the compression stroke of piston 94 in the compression process from the bypass surcharging produces a more powerful explosion of the introduced gas in cylinder 93 thereby producing a more powerful and efficient combustion stroke of piston 94 and saves fuel, in accordance with the principle of the invention. At this point, valves 88C and 93C isolating cylinder 88 from cylinder 93, exhaust valve 88B to cylinder 88 is closed and exhaust valve 93B to cylinder 93 is closed, intake valve 88A to cylinder 88 is open, intake valve 93A to cylinder 93 is closed, and piston 89 moves from its top position and downwardly along its intake stroke in the intake process intaking cold intake gas into cylinder 88, and piston 94 moves downwardly along its combustion stroke, whereby as pistons 89 and 94 approach their respective bottom positions bypass valves 88C and 93C to bypass conduit 101 open allowing warm exhaust gas to flow from cylinder 93 to cylinder 88 through bypass conduit 101 providing the bypass surcharging from cylinder 93 to cylinder 88, and this combustion process so continues between cylinders 88 and 93.

It is to be understood this bypass surcharging between cylinders 88 and 93 occurs in exactly the same manner between cylinders 91 and 95, wherein throughout the combustion cycles of pistons 89, 92, 93, and 95, bypass surcharging cycles between cylinders 88 and 93, and cylinders 92 and 95, in accordance with the principle of the invention. The exemplary benefits of the exhaust gas bypass surcharging in system 270 are those discussed above in the previous embodiments, and gas and diesel engines can be modified to use the structure specified by system 270.

FIG. 20 is a schematic diagram of system 270 of FIG. 19 constructed and arranged with a catalytic converter and with fuel and water injection systems, in accordance with the principle of the invention. In FIG. 20, a catalytic converter 104 is fitted in bypass conduit 101, which converts pollutants in the bypass gas passing therethrough between cylinders 88, 91, 93, and 95, such as carbon monoxide, unburned hydrocarbons, and oxides of nitrogen, into harmless compounds. Fuel injection system 102 is formed with bypass conduit 101, and injects fuel into bypass gas passing between cylinders 88, 91, 93, and 95 to improve engine power. Water injection system 103 is also formed with bypass conduit 101, and injects water into bypass gas passing between cylinders 88, 91, 93, and 95, which instantly evaporates and turns into steam to improve the power of combustion and the resulting engine power and saves fuel.

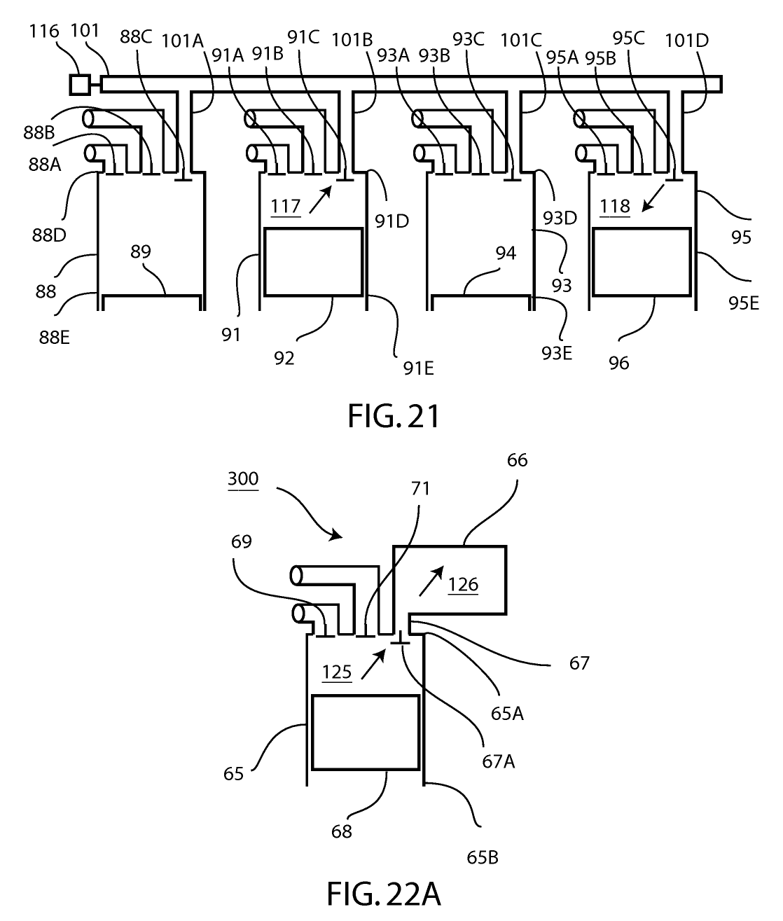

Attention is now turned to FIG. 21, which is a schematic diagram of the system of FIG. 19, in which the system in FIG. 21 is denoted generally at 290 and is configured for ignition gas bypass surcharging or bypass volume jet ignition or supraignition as discussed in conjunction with FIG. 18. The ignition gas bypass surcharging or supraignition occurs through bypass conduit 101 and cycles between cylinders 88 and 93, and cylinders 91 and 95. The operation of ignition gas bypass surcharging or supraignition in conjunction with system 290 will be discussed in conjunction with cylinders 91 and 95, with the understanding that the same ignition gas bypass surcharging occurs between cylinders 88 and 93.

The initial starting position of piston 92 consists of piston 92 positioned at the top of its compression stroke at the top or upper end 91D of cylinder 91 in the compression process at maximum compression in cylinder 91 in preparation for ignition and movement of piston 92 into its combustion stroke of the combustion process, in which cylinder 91 is charged with a fuel/air mixture or ignition gas 117 which piston 92 has compressed, intake and exhaust valves 91A and 91B are closed, and yet valve 91C at cylinder 91 to bypass conduit 101 is open and valve 95C at cylinder 95 is closed, whereby ignition gas 117 is forced into bypass conduit 101 through open valve 91C providing bypass conduit 101 with a charge of uncombusted bypass ignition gas. The initial starting position of piston 96 consists of piston 96 approaching the top of its compression stroke in the compression process in preparation for ignition and movement of piston 96 into its combustion stroke in the combustion process, in which piston 96 is compressing in cylinder 95 a charge of fuel/air mixture or ignition gas 118, intake and exhaust valves 95A and 95B are closed as is valve 95C between cylinder 95 and bypass conduit 101.

From this initial starting position of cylinders 91 and 95, valve 95C between cylinder 95 and bypass conduit 101 opens and the compressed ignition gas 117 in cylinder 91 ignites, which, in turn, ignites the bypass ignition gas in bypass conduit 101 creating not only tremendous pressure in cylinder 91 driving piston 92 into its combustion stroke but also creating tremendous pressure in bypass conduit 101. At this moment of operation, the ignited ignition gas 117 is present in cylinder 91 and ignited bypass ignition gas is formed in bypass conduit 101 and valve 91C between cylinder 91 and bypass conduit 101 closes. The tremendous pressure formed in bypass conduit 101 formed by the ignited bypass ignition gas forcibly applies the ignited, and very hot, ignition bypass gas 81 into cylinder 95 through open valve 95C just as piston 96 reaches the top of its compression stroke. At the top of the compression stroke of piston 96, the forcible application of the ignited, and very hot, bypass ignition gas increases the pressure of the already compressed ignition gas 118 in cylinder 95 and also ignites the compressed ignition gas 118 just as valve 95C between cylinder 95 and bypass conduit 101 closes forming an improved and more power ignition, i.e., jet ignition or supraignition, in cylinder 95 thereby producing a more powerful and efficient combustion stroke of piston 96 in the combustion process increasing engine power, in accordance with the principle of the invention. This transfer of ignition gas 117 from cylinder 91 to bypass conduit 101 to charge bypass conduit 101 with uncombusted bypass ignition gas and the resulting transfer of ignited bypass ignition gas to ignition gas 83 in cylinder 95 so continues between cylinders 91 and 95 and is ignition gas bypass surcharging or bypass volume jet ignition or supraignition, in which system 290 is exemplary of a common conduit or common pipe valve controlled double-cylinder interconnect bypass volume jet ignition or supraignition system constructed and arranged in accordance with the principle of the invention. The ignition gas bypass surcharging or supraignition cycle also takes place in conjunction with cylinders 88 and 93 in system 290, in which the ignition gas bypass surcharging cycles between cylinders 91 and 95, and cylinders 88 and 93, according to the principle of the invention. If desired, system 290 can be formed with fuel injection systems or water injection systems to provide still more power cylinder combustion, and cylinder pressure, which produces fuel savings.

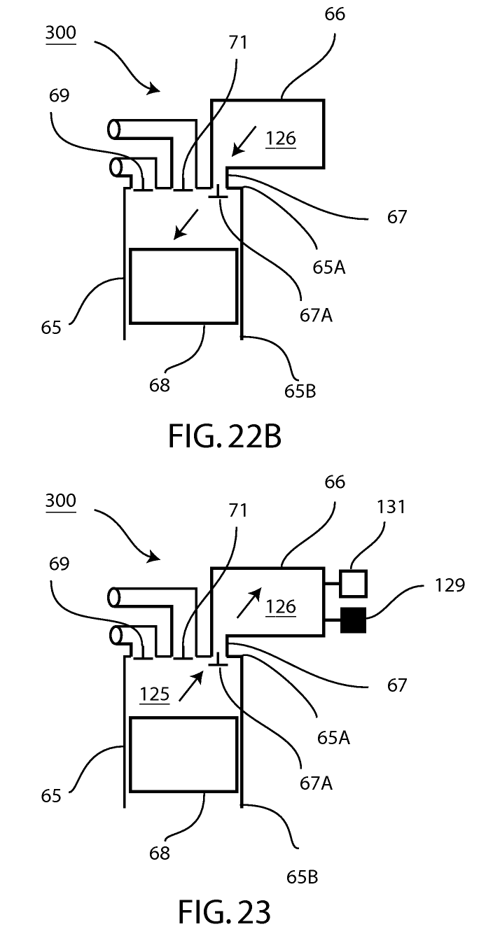

Attention is now directed to FIGS. 22A, 22B, and 23, in which FIGS. 22A and 22B are schematic diagrams of stages of operation of a single cylinder valve controlled ignition gas buffer bypass surcharging or volume jet ignition or supraignition system 300 of an internal combustion engine constructed and arranged in accordance with the principle of the invention, and FIG. 23 is a schematic diagram of system 300 of FIGS. 22A and 22B constructed with fuel and water injection features. Referencing FIG. 22A, in common with system 190 disclosed in conjunction with FIGS. 15A and 15B, system 300 shares cylinder 65 having top or upper end 65A and bottom or lower end 65B, piston 68, buffer vessel 66, pipe 67, valve 67A between pipe 67 and cylinder 65, intake valve 69, and exhaust valve 71. The operation of system 300 will be discussed from an initial starting position of piston 68, consisting of piston 68 positioned at the top of its compression stroke of the compression process at top or upper end 65A of cylinder 65 at maximum compression in cylinder 65 in preparation for ignition and movement of piston 68 into its combustion stroke of the combustion process, in which cylinder 65 is charged with a fuel/air mixture or ignition gas 125 which piston 68 has compressed, intake and exhaust valves 69 and 71 are closed, and yet valve 67A at cylinder 65 to buffer vessel 66 is open, whereby ignition gas 125 is forced into buffer vessel 66 through open valve 67A providing buffer vessel 66 with a charge of uncombusted bypass ignition gas denoted at 126.

From this initial starting position of cylinder 65, the compressed ignition gas 125 in cylinder 65 ignites, which, in turn, ignites the bypass ignition gas 126 in buffer vessel 66 creating not only tremendous pressure in cylinder 65 driving piston 68 into its combustion stroke in the combustion process but also creating tremendous pressure in buffer vessel 66. At this moment of operation the ignited ignition gas 125 is present in cylinder 65 and ignited bypass ignition gas 126 is formed in buffer vessel 66 and valve 67A between cylinder 65 and buffer vessel 66 closes thereby retaining under pressure the now very hot ignited bypass ignition gas 126 in buffer vessel 66. Piston 68 completes the compression stroke in the compression process, exhaust valve 71 opens and piston 68 proceeds through its exhaust stroke in the exhaust process exhausting the combusted gas out into the tail pipe, exhaust valve 71 closes and intake valve 69 opens and piston 68 moves through its intake stroke in the intake process taking in ignition gas into cylinder 65, and then intake valve 69 closes and piston 68 initiates its compression stroke. Valve 67A between pipe 67 and cylinder 65 opens just as piston 68 reaches the top of its compression stroke as illustrated in FIG. 22B. At the top of the compression stroke of piston 68 at the top or upper end 65A of cylinder 65 at the end of the compression process, the forcible application of the ignited, and very hot, bypass ignition gas 126 increases the pressure of the already compressed ignition gas in cylinder 65 and also ignites the compressed ignition gas just as valve 67A closes forming an improved and more power ignition in cylinder 65 thereby producing a more powerful and efficient combustion stroke of piston 68 increasing engine power and saves fuel, in accordance with the principle of the invention. This transfer of ignition gas 125 from cylinder 65 to buffer vessel 66 to charge buffer vessel 66 with uncombusted bypass ignition gas 126 and the resulting transfer of ignited bypass ignition gas 126 to the ignition gas in cylinder 65 formed from the subsequent intake stroke of piston 68 so continues and is single cylinder ignition gas buffer bypass surcharging or buffer bypass volume jet ignition or supraignition, in which system 300 is exemplary of a valve controlled single cylinder ignition gas buffer bypass surcharging or bypass volume jet ignition or supraignition system constructed and arranged in accordance with the principle of the invention.

If desired, system 300 can be furnished with a fuel injection system and/or a water injection system to increase cylinder combustion to provide a still more powerful combustion stroke in piston 68 and saves fuel, and this aspect of the invention is illustrated in FIG. 23. In FIG. 23, system 300 is illustrated with a fuel injection system 129 operatively coupled to buffer vessel 66 and a water injection system 131 operatively coupled to buffer vessel 66. In the operation of fuel injection system 129, fuel injection system 129 injects fuel into the ignited bypass ignition gas 126 in buffer vessel 66 just before valve 67A opens to inject the ignited bypass ignition gas 126. When fuel is injected into the ignited bypass ignition gas 126, it is instantly ignited by the ignited bypass ignition gas 126 which still further increases the pressure of the ignited ignition buffer-bypass gas 126 introduced into cylinder 65 when valve 67A opens, in accordance with the principle of the invention, which thereby increases the pressure in cylinder 65 making the resulting ignition in cylinder 65 more powerful still further increasing the power of the combustion stroke of piston 68 and further saves more fuel.

In the operation of water injection system 131, water injection system 131 injects water into the ignited bypass ignition gas 126 in buffer vessel 66 just before valve 67A opens to inject the ignited bypass ignition gas 126. When water is injected into the ignited bypass ignition gas 126, it is instantly vaporized and turns into steam when it comes into contact with the hot ignited bypass ignition gas 126 thereby increasing the pressure of the ignited ignition buffer-bypass gas 126 introduced into cylinder 65 when valve 67A opens, in accordance with the principle of the invention, which thereby increases the pressure in cylinder 65 making the resulting ignition in cylinder 65 more powerful still further increasing the power of the combustion stroke of piston 68 and further saves more fuel. As in prior embodiments, the steam cleans buffer vessel 66, cylinder 65, and piston 68.

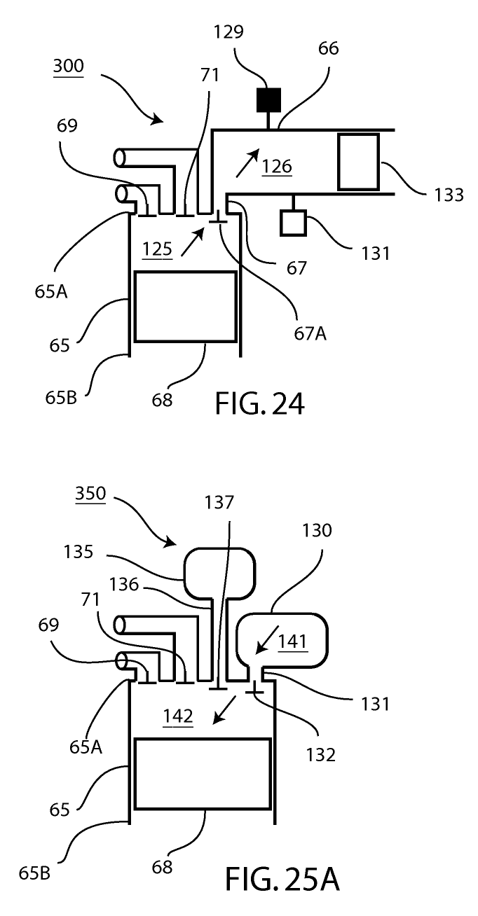

Adjustment of buffer vessel 66 can be made to adjust the resulting pressure in buffer vessel 66 in order to provide a selected power of the combustion stroke of piston 68 in cylinder 65 in the combustion process, and this aspect of the invention is illustrated in FIG. 24. In FIG. 24, and in common with the system disclosed in FIG. 9, system 300 in FIG. 24 is fashioned with a buffer closure piston 33. Piston 33 is formed in buffer vessel 66, and is adjustable, and is fixed in place, such as by one or more set screws or servo mechanisms of the like, at a specified location to define a selected volume of buffer vessel 66. Piston 33 is adjustable simply by releasing it from a given fixed location, moving it to a new location to define a desired volume of buffer vessel 66, and then securing it back in place. By adjusting piston 33, the volume of buffer vessel 66 may be adjusted as needed to provide a desired degree of buffer bypass surcharging in cylinder 65, in accordance with the principle of the invention.

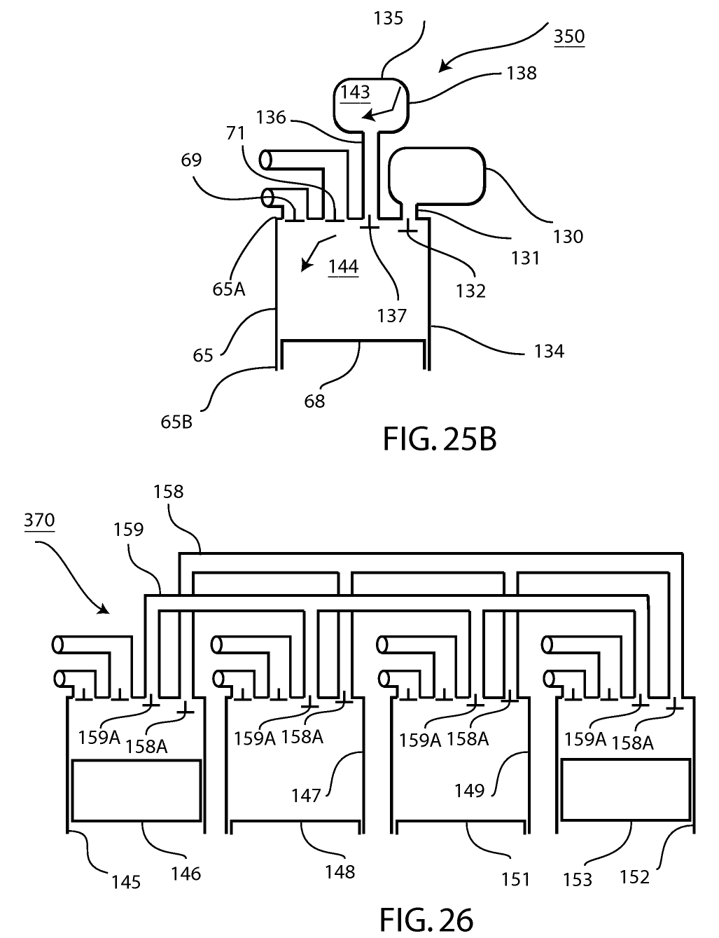

Attention is now directed to FIGS. 25A and 25B, which are schematic diagrams of stages of operation of a single cylinder valve controlled exhaust gas and ignition gas buffer bypass surcharging system 350 of an internal combustion engine. System 350 combines valve controlled exhaust gas buffer bypass surcharging as previously discussed in detail in conjunction with the system designated at 190, with valve controlled ignition gas buffer bypass surcharging or supraignition as previously discussed in detail in conjunction with the system denoted at 300. In common with system 300 discussed in conjunction with FIGS. 22A and 22B, system 350 shares cylinder 65, piston 68, intake valve 69, and exhaust valve 71. System additionally includes a first buffer vessel 130, a first pipe 131 coupling first buffer vessel 130 to cylinder 65 at the top or upper end 65A of cylinder 65 in gaseous communication, and a valve 132 at cylinder 65 between pipe 131 and cylinder 65 to regulate or otherwise control gas flow. System still further includes a second buffer vessel 135, a second pipe 136 coupling second buffer vessel 135 to cylinder 65 at the top or upper end of cylinder 65 in gaseous communication, and a valve 137 at cylinder 65 between pipe 136 and cylinder 65 to regulate or otherwise control gas flow.

The operation of system 350 is now discussed from an initial starting position of piston 68. The initial starting position of piston 68 consists of piston 68 positioned at the top of its compression stroke at maximum compression in cylinder 65 at the end of the compression process in preparation for ignition and movement of piston 68 into its combustion stroke in the combustion process, in which cylinder 65 is charged with a fuel/air mixture or ignition gas 142 which piston 68 has compressed, intake and exhaust valves 69 and 71 are closed, and yet first valve 132 at cylinder 65 to first buffer vessel 130 is open, whereby the ignition gas in cylinder 65 is forced into first buffer vessel 130 through open valve 132 providing first buffer vessel 130 with a charge of uncombusted bypass ignition gas 141. In the initial starting position of cylinder 65 in system 350, second valve 137 to second buffer vessel 135 is closed. System 350 is a valve controlled system.

From this initial starting position of cylinder 65, the compressed ignition gas 142 in cylinder 65 ignites, which, in turn, ignites the bypass ignition gas 141 in first buffer vessel 130 creating not only tremendous pressure in cylinder 65 driving piston 68 into its combustion stroke in the combustion process but also creating tremendous pressure in first buffer vessel 130. At this moment of operation the ignited ignition gas is present in cylinder 65 and ignited bypass ignition gas 141 is formed in first buffer vessel 130 and first valve 132 between cylinder 65 and first buffer vessel 130 closes thereby retaining under pressure the now very hot ignited bypass ignition gas 141 in first buffer vessel 130. Piston 68 completes is combustion stroke in the combustion process, exhaust valve 71 opens and second valve 137 opens to charge second buffer vessel 135 with warm exhaust gas in cylinder 65 and piston 68 initiates its exhaust stroke to exhaust the warm combusted exhaust gas out into the tail pipe.

In the exhaust stroke of piston 68, a volume of the warm exhaust or bypass gas in cylinder 65 flows from cylinder 65 to second buffer vessel 135 through pipe 136 because the warm exhaust gas in cylinder 65 has higher pressure than the pressure of the comparatively cool gas in second buffer vessel 135. The flow of warm exhaust gas from cylinder 65 to second buffer vessel 135 through second pipe 136 is exhaust gas buffer bypass surcharging, in accordance with the principle of the invention. The warm exhaust gas received by second buffer vessel 135 from cylinder 65 through pipe 136 is buffer gas 143 as denoted in FIG. 25B. Because cylinder 65 is relieved of a volume of exhaust gas at the bottom of the combustion stroke of piston 68 when second valve 137 to second buffer vessel 135 opens, there is an initial pressure reduction in cylinder 65 before piston 68 initiates its exhaust stroke, which pressure reduction cools the exhaust gas in cylinder 65.

With cylinder 65 relieved of a volume of warm exhaust gas 72 with piston 68 at the bottom of the combustion stroke and the end of the combustion process, second buffer vessel 135 is charged with a corresponding volume of warm exhaust gas or bypass gas 143 from cylinder 65. From this point, second valve 136 closes isolating cylinder 65 from second buffer vessel 135 thereby capturing and holding buffer gas 143 in second buffer vessel 135, intake valve 69 is closed and exhaust valve 71 opens and piston 68 continues its exhaust stroke in the exhaust process moving upwardly away from the bottom of cylinder 65 to the top of cylinder 65. The volume of cylinder 65 at this stage of operation is now approximately equal to full cylinder volume, and piston 68 continues movement through its exhaust stroke in the exhaust process.

In the movement of piston 68 through its exhaust stroke in the exhaust process, the exhaust gas in cylinder 65, which is precooled as a result of the pressure reduction in cylinder 65 produced by the buffer bypass surcharging according to the principle of the invention, is exhausted through the corresponding exhaust valve 71 associated with cylinder 65 and into the tail pipe. Piston 68 moves along its exhaust stroke in the exhaust process and into the following intake stroke in the intake process, in which intake valve 69 and valve 67A open and exhaust valve 71 closes. As piston 68 moves along its intake stroke in the intake process from its top position at the top or upper end 65A of cylinder 65 to its bottom position at the bottom or lower end 65B of cylinder 65, intake gas 144 illustrated in FIG. 25B is drawn into cylinder 65 through intake valve 69, which is cooler than the warm retained buffer gas 143 in second buffer vessel 135. Because intake gas 144 in cylinder 65 taken in during the intake stroke of piston 68 is comparatively cooler than the buffer gas 143 maintained in second buffer vessel 135, there is a pressure differential across cylinder 65 and second buffer vessel 135 and the buffer gas 143 in second buffer vessel 135 thus passes into cylinder 65 through second valve 137 of second pipe 136 from second buffer vessel 135 in the intake stroke of piston 68 in the intake process, which buffer gas 143 passing into cylinder 65 initially pre-warms the intake gas 144 in cylinder 65 and also pre-pressurizes cylinder 65 in buffer bypass surcharging, in accordance with the principle of the invention.

With second buffer vessel 135 relieved of a volume of buffer gas 143 and cylinder 65 charged with a corresponding volume of buffer gas 143 from second buffer vessel 135 thereby pre-pressurizing cylinder 65 and also pre-warming intake gas 144 in cylinder 65, second valve 137 closes isolating cylinder 65 from second buffer vessel 135, and with intake and exhaust and first valves 69, 71, and 132 also closed piston 68 initiates its compression stroke in the compression process moving upwardly away from the bottom of cylinder 65 to the top of cylinder 65. At this point, the volume of cylinder 65 is now approximately equal to full cylinder volume, and second buffer vessel 135 is substantially relieved of buffer gas 143 and is cooled due to the pressure reduction in second buffer vessel 135 due to the evacuation of buffer gas 143 in the buffer bypass surcharging. Piston 68 continues movement through its compression stroke, and as piston 68 moves along its compression stroke it compresses the gas, including the buffer gas, in cylinder 65, in which the initial warming of intake gas 144 in cylinder 65 and the pre-pressurization of intake gas 144 in cylinder 65 at the end of the prior intake stroke of piston 68 produced by the intake of the buffer gas 143 from second buffer vessel 135 in the buffer bypass surcharging increases the resulting temperature of intake gas 144 in cylinder 65 and the resulting gas pressurization of the gas in cylinder 65 through the movement of piston 68 through its compression stroke in the compression process. At the top of the compression stroke of piston 68 at the end of the compression process the temperature of intake gas 144 is increased and the pressure in cylinder 65 is increased thus by heat and the volume of buffer gas introduced into cylinder 65 resulting from the buffer bypass surcharging. Because heat and compression makes the explosion more powerful in the ignition process, this increased heat and pressure of intake gas 144 in cylinder 65 at the top of the compression stroke of piston 68 produces a more powerful explosion of the introduced gas in cylinder 65 thereby producing a more powerful and efficient combustion stroke of piston 68 in the combustion process and saves fuel, in accordance with the principle of the invention.

Just before piston 68 reaches the top of its compression stroke in the combustion process, first valve 132 between first pipe 131 and cylinder 65 opens as illustrated in FIG. 25A producing a forcible application of the ignited, and very hot, bypass ignition gas 141 into cylinder 65 from first bypass vessel 130, which characterizes ignition gas buffer bypass surcharging. At the top of the compression stroke of piston 68 at the end of the compression process, the forcible application of the ignited, and very hot, bypass ignition gas 141 increases the pressure of the already compressed ignition gas 144 in cylinder 65 and also ignites the compressed ignition gas 144 in its entire homogenous volume just as valve 132 closes in a supraignition process forming an improved and more yet more powerful ignition in cylinder 65 thereby producing a more powerful and efficient combustion stroke of piston 68 increasing engine power and saves fuel, in accordance with the principle of the invention.

Accordingly, in system 350 exhaust gas buffer bypass surcharging works in concert with ignition gas buffer bypass surcharging or supraignition to produce a more powerful combustion stroke in piston 68 and thus greater engine power. As in prior embodiments, system 350 can be furnished with fuel injection systems and/or water injection systems to improve cylinder combustion and engine power. This cycle of combustion coupled with buffer bypass surcharging and ignition gas buffer bypass surcharging or supraignition continues. System 350 can be used in a multi-cylinder internal combustion engine, or a single cylinder internal combustion engine, and can be used in diesel engines and in gasoline engines.

Buffer vessel 130 in conjunction with valve 132 is used in ignition gas buffer bypass surcharging or supraignition, and buffer vessel 135 in conjunction with valve 137 is used in exhaust gas buffer bypass surcharging. If desired, system 350 may be configured to operate in the ignition gas buffer bypass surcharging or supraignition mode to close valve 137 and also disable valve 137 operation and to enable valve 132 operation to provide ignition gas buffer bypass surcharging or supraignition, and in the exhaust gas buffer bypass surcharging mode to close valve 132 and also disable valve 132 operation and to enable valve 137 operation to provide exhaust gas buffer bypass surcharging. A switch may be used to toggle between the ignition gas buffer bypass surcharging mode and the exhaust gas buffer bypass surcharging mode.

FIG. 26 is a schematic diagram of a cylinder interconnect valve controlled exhaust gas and ignition gas buffer bypass surcharging or supraignition system 370 of an internal combustion engine constructed and arranged in accordance with the principle of the invention. System 370 is multi-cylinder system 370 incorporating valve controlled exhaust gas bypass surcharging with common conduit as discussed in conjunction with FIG. 19, and valve controlled ignition gas bypass surcharging or supraignition with common conduit as discussed in conjunction with FIG. 21, in accordance with the principle of the invention. System 370 has four cylinder or piston assemblies formed in a cylinder block or engine block, including cylinders 145, 147, 149 and 152 with four corresponding pistons 146, 148, 151 and 153, respectively. Cylinders 146, 148, 151, and 153 are each coupled in gaseous communication with a first bypass conduit 158 and to a second bypass conduit 159. A first valve 158A is formed between each of cylinders 146, 148, 151, and 153 and first common conduit 158, and a second valve 159A is formed between each of cylinders 146, 148, 151, and 153 and second common conduit 159. In this example, pistons 146 and 153 of cylinders 145 and 152 are at the top of their compression strokes in the compression processes, and pistons 148 and 151 of cylinders 147 and 149 are at the bottom of their combustion strokes in the combustion processes, in which second valves 159A of cylinders are open and exhaust gas bypass surcharging is occurring between cylinders 147 and 149, and ignition gas surcharging or supraignition is occurring between cylinders 145 and 152.

In this example, piston 148 is positioned at the bottom of its combustion stroke at the bottom or lower end of cylinder 147 at the end of the combustion process in preparation for the exhaust stroke in the exhaust process, and piston 151 is positioned at the bottom of its intake stroke at the bottom or lower end of cylinder 149 at the end of the intake process in preparation for the compression stroke in the compression process, in which second valves 159A of cylinders 147 and 149 work together to provide exhaust gas buffer-bypass surcharging through second conduit 159 from cylinder 147 to cylinder 149. Also in this example, piston 146 is positioned at the top of its compression stroke at the top or upper end of cylinder 145 at the end of the compression process at maximum compression in cylinder 145 in preparation for ignition and movement of piston 146 into its combustion stroke in the combustion process, and piston 153 is approaching the top of its compression stroke at the end of the compression process in preparation for ignition and movement of piston 153 into its combustion stroke in the combustion process, in which first valves 158A of cylinders 145 and 152 work together to provide ignition gas buffer bypass surcharging or supraignition through first conduit 158 from cylinder 145 to cylinder 152. The combustion cycles between the opposed pairs of cylinders in system 370 continues and the operation of valves 158A and 159A from the cylinders to first and second conduits 158 and 159 provides a cycling exhaust gas buffer bypass surcharging and ignition gas buffer bypass surcharging or supraignition between the opposed pairs of cylinders to provide increased engine power and saves fuel, in accordance with the principle of the invention.

Again, valve controlled exhaust gas bypass surcharging with common conduit is discussed previously in conjunction with FIG. 19, and valve controlled ignition gas bypass surcharging or supraignition with common conduit is discussed in conjunction with FIG. 21, and both discussions apply to system 370 in FIG. 26. The instruction provided by system 370 shows utilizing both processes of valve controlled exhaust gas bypass surcharging with common first conduit 159 coupled in gaseous communication to the various cylinders in system 370, and valve controlled ignition gas bypass surcharging or supraignition with common second conduit 159 coupled in gaseous communication to the various cylinders in system 370, in which when exhaust gas bypass surcharging is occurring between one pair of opposed cylinders ignition gas bypass surcharging or supraignition is occurring between the other pair of opposed cylinders. System 370 can be used with four cylinders, eight cylinders, twelve cylinders, sixteen cylinders, and so on.

If desired, system 370 may be configured to operate in the ignition gas buffer bypass surcharging or supraignition mode to close first valves 158A and also disable first valve 158A operation and to enable second valves 159A operation to provide ignition gas buffer bypass surcharging or supraignition through second conduit 159, and in the exhaust gas buffer bypass surcharging mode to close second valves 159A and also disable second valves 159A operation and to enable first valves 158A operation to provide exhaust gas buffer bypass surcharging through first conduit 158. A switch may be used to toggle between the ignition gas buffer bypass surcharging mode and the exhaust gas buffer bypass surcharging mode.

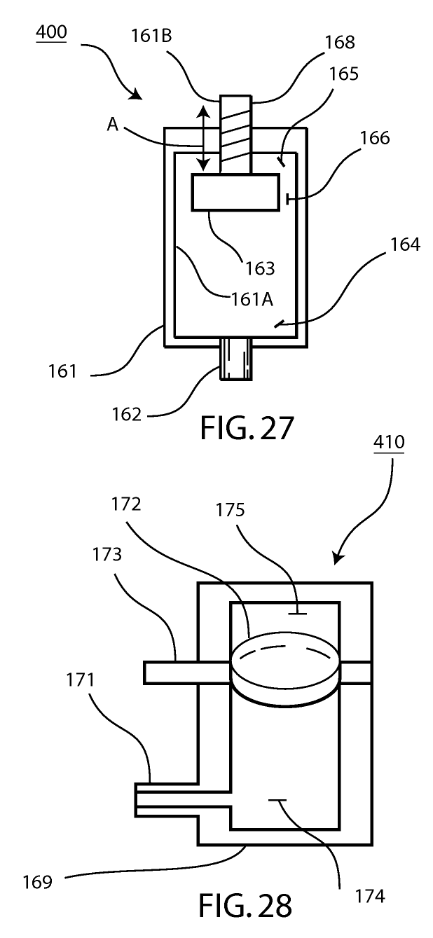

Attention is now turned to FIG. 27, in which there is illustrated a buffer choking assembly 400 constructed and arranged in accordance with the principle of the invention. Buffer choking assembly 400 is formed with or otherwise applied to or operatively coupled to a buffer vessel, and is used to alter the dynamic volume of a buffer vessel while leaving in the static volume intact. Buffer choking assembly 400 is for use in any of the buffer bypass surcharging systems using buffer vessel as disclosed herein. In this embodiment, buffer vessel 161 has a head-on inlet 162 through which hot or warm gas flows relative to buffer vessel 161 in charging buffer vessel 161 with gas and relieving buffer vessel 161 of gas. Buffer vessel 161 has a volume, and a piston 163 is situated in buffer vessel 161 dividing the volume of buffer vessel 161 into a first or front volume 164 and a second or back volume 165. Volumes 164 and 165 communicate through a small gap 166 formed between piston 163 and inner surface 161A of buffer vessel 161. Piston 163 is mounted to buffer vessel 161 for movement in reciprocal directions as indicated by the double arrowed line A to provide corresponding adjustment of volumes 164 and 165. In this example, piston 163 is secured to a threaded stem or shank 167, which is threadably received through a corresponding threaded opening 161B through buffer vessel 161, whereby rotation of shank 167 provides reciprocal adjustment of piston 163. Any suitable mechanism, including a servo motor, may be used to provide the reciprocal adjustment of piston 163 in buffer vessel 161. As bypass surcharging occurs in buffer vessel 161, gas passes between volumes 164 and 165 through gap 166. However, gap 166 restricts the flow of gas between volumes 164 and 165, which creates a chocking and cushioning effect on the gas flow through inlet 162 and to reduce noise, in accordance with the principle of the invention, which provides smooth operation and smooth engine operation.

Attention is now turned to FIG. 28, in which there is illustrated an alternate embodiment of a buffer chocking assembly 410, which is formed with or otherwise applied to or operatively coupled to a buffer vessel, and is used to alter the dynamic volume of a buffer vessel while leaving in the static volume intact. Buffer choking assembly 410 is useful with a buffer vessel for use in any of the buffer bypass surcharging systems using buffer vessel as disclosed herein. In this embodiment, a buffer vessel 169 includes a sideway inlet 171. Buffer vessel 169 has a volume, and a butterfly valve 172 carried by a shaft mounted to buffer vessel 169, which is similar to conventional butterfly valves formed with carburetor throttles, is formed in buffer vessel 169, which splits the volume of buffer vessel 169 into a first or front volume 174 and a second or rear volume 175. Butterfly valve 172 is adjusted to adjust volume 174 relative to volume 175 by rotating shaft 173. Through the adjustment of butterfly valve 172, selective restriction of the flow of gas between volumes 174 and 175 through butterfly valve 172 to create a delaying and chocking and cushioning effect on the gas flow through inlet 169 can be made.

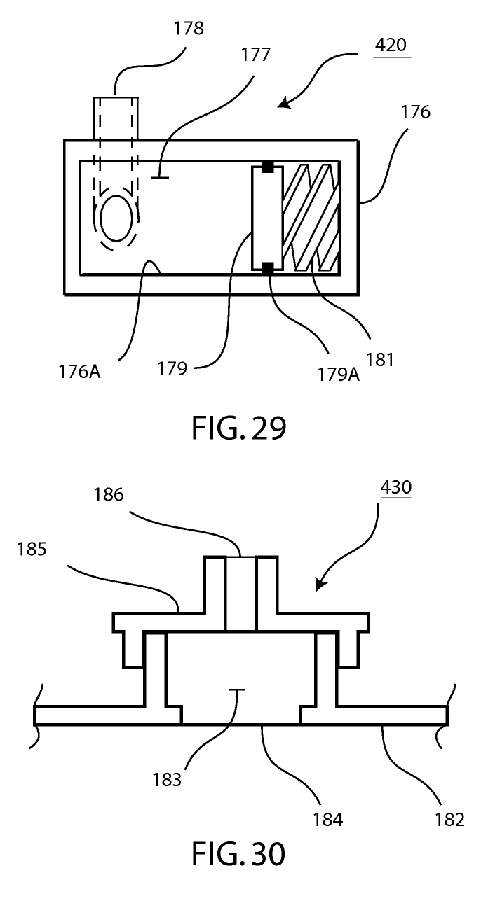

In FIG. 29 there is illustrated yet another embodiment of a buffer chocking assembly 420 to alter the static and dynamic volumes of a buffer vessel for use in any of the buffer bypass surcharging systems using buffer vessel as disclosed herein. In this embodiment, a buffer vessel 176, which has a volume 177, is formed with a tangential, also called centrifugal or swirl, inlet 178, through which hot or warm gas flows relative to the volume of buffer vessel 176. A piston 179 closes volume 177, and is formed with a seal 179A that sealingly engages the inner surface 176A of buffer vessel 176. A spring 181, such as a compression spring, is formed in buffer vessel 176 between piston 179 and buffer vessel 176. Spring 181 acts on piston 179 urging piston 179 toward inlet 178. Upon buffer gas charging in volume 177, the bias of spring 181 is overcome and piston 179 retreats away from inlet 178 increasing volume 177. Upon buffer gas discharging from volume 177 of buffer vessel 176, spring 181 acts on piston 179 urging piston 179 toward inlet 178 decreasing volume 177, which helps to accelerate the flow of gas from volume 177 through inlet 178 to forcibly exert the gas in volume 177 from buffer vessel 176 to thereby increase the resulting pressure in the cylinder coupled in gaseous communication to inlet 178.

A smolder plug assembly 430 that may be formed with a cylinder of a cylinder assembly is illustrated in FIG. 30. Smolder plug assembly 430 includes a cylinder head 182 that receives a smolder plug 183, which is formed of porous material, such as sintered powder metal or wire mesh, ceramic or other suitable material, which slowly lets through pressurized liquid fuel, which is a sweating of fuel or a fuel sweat. A cap 185 secures plug 183 to head 182, and is formed with an inlet 186 to let through pressurized fuel, which diffuses to the cylinder and smolders to provide increased ignition pressure in the corresponding piston combustion stroke to further increase the power of the combustion stroke in the combustion process and saves fuel.

Fueling of a cylinder with smolder plug assembly 430 can be intermittent or continuous, because gas compression in the cylinder works against fuel sweating-up to stopping it upon ignition gas or jet ignition, which produces extreme pressure. Upon exhaust, the sweating fuel has no time to mix with exhaust gas and thus may not pollute or cause fuel loss. Use of smolder plug assembly 430 eliminates the need for a carburetor or fuel injector and is less costly to operate and maintain. Smolder plug assembly 430 is similar to glow plugs in Stuart engines, and similar benefits can be expected, such as fuel flexibility and steadiness and economy and reliability. A smolder plug, according to the principle of the invention, can also be inserted into a supraignition chamber, in which fuel does not burn until it meets with air. Such a smolder plug application eliminates the need for fuel injection in diesel engines.

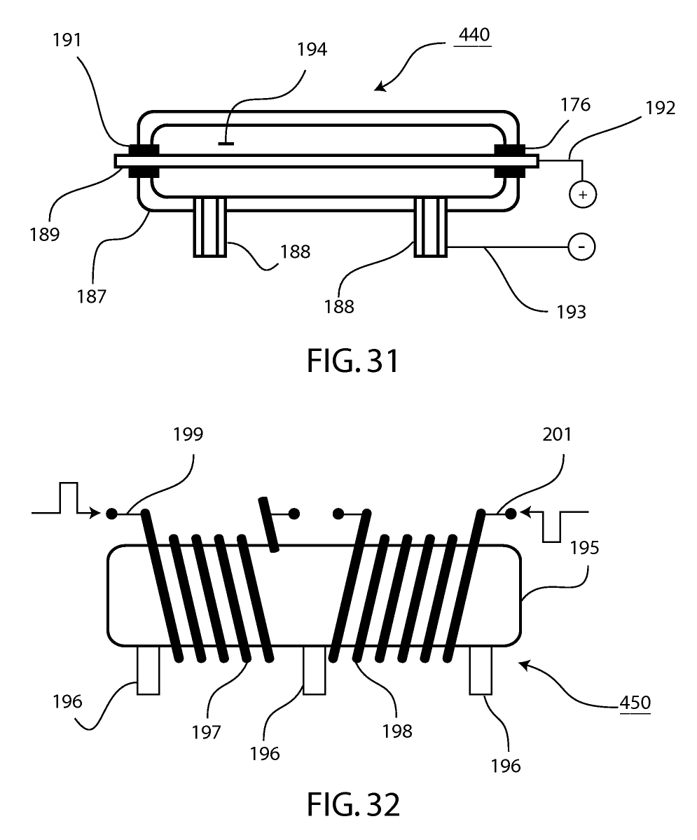

An ionized ignition gas buffer assembly 440 is illustrated in FIG. 31, which includes a buffer vessel 187 to be used in supraignition having two gas inlet/outlets 188 and a high voltage electrical rod 189 separated from buffer vessel 187 by insulators 191. Rod 189 receives static or pulsed positive voltage 192, such as from the vehicle battery, and buffer vessel 187 is grounded to the engine block of the vehicle with negative voltage 193. Hot ignition gas 194 is ionized upon passing through buffer vessel 187. Due to plasma ignition effect, the ionized ignition gas produced by assembly 440 improves ignition quality in the combustion process of the cylinder assembly to which gas buffer assembly 440 is coupled to in gaseous communication in supraignition, and the electrical power consumption of assembly 440 is marginal.

In FIG. 32 there is illustrated another embodiment of an ionized ignition gas buffer assembly 450, which achieves ionizing with electromagnets, in accordance with the principle of the invention. Buffer assembly 450 is to be used in supraignition and includes a buffer vessel 195 having three inlet/outlets 196 and left-handed coil 197 and right-handed coil 198. Coils 196 and 197 are insulated and receive pulsed currents 199 and 201, respectively, which are ON when gas moves in buffer vessel 195 ionizing the moving gas prior to application to a cylinder assembly in a supraignition process, and OFF when there is no gas movement in buffer vessel 195, such as between jet ignition cycles.

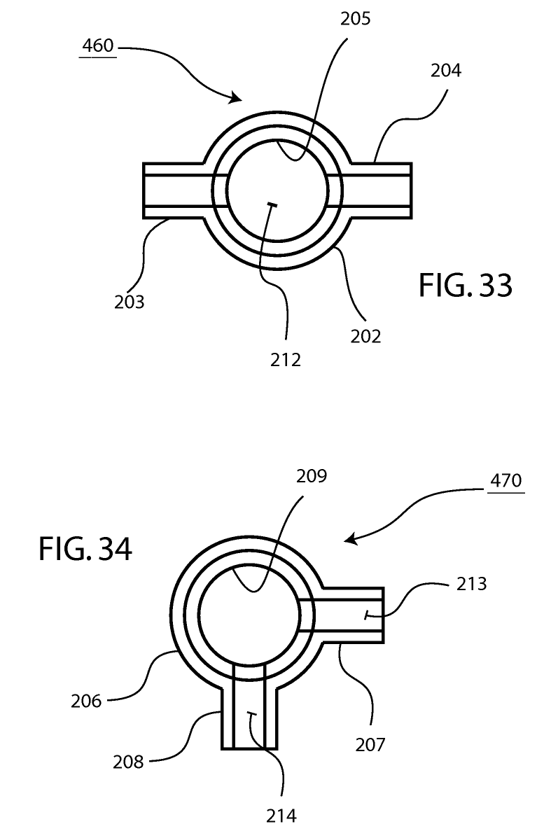

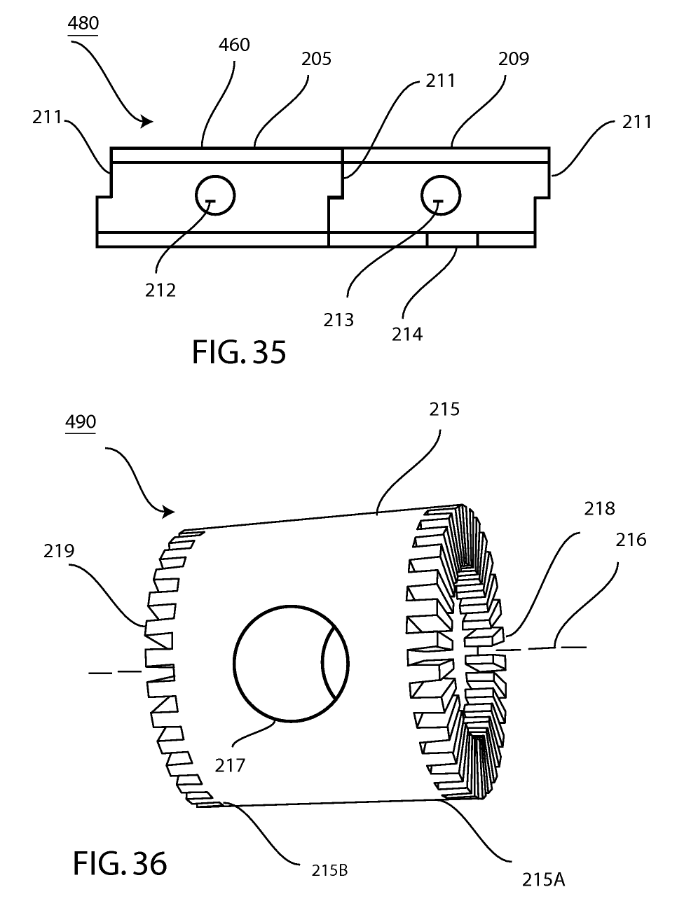

Surcharging and jet ignition or supraignition requires short valve opening time and does not produce high backpressure on the valves that could damage the valves or impair operation of the valves. To avoid stiff poppet valve springs and lobes on large cams typical of the valves used in conventional cylinder heads, valve inserts and stacked arrangements of valve inserts may be used in accordance with the principle of the invention in lieu of poppet valves. As a matter illustration and reference, FIG. 33 illustrates a 180 degree thru valve or valve insert 460, FIG. 34 illustrates a 90 degree corner valve or valve insert 470, and FIG. 35 is a valve insert stack assembly 480 consisting of a keyed attachment of valve inserts 460 and 470.

Referencing FIG. 33, valve 460 consists of a sleeve housing pipe 202, inlet pipe 203, outlet pipe 204 and valve insert 205 with two, 180 degree offset opposed through holes. Referencing FIG. 34, valve 470 consists of sleeve housing pipe 206, inlet pipe 208, outlet pipe 207 and valve insert 209 with two, 90 degree offset through holes. Stack assembly 480 in FIG. 35 consists of valve inserts 205 and 209 keyed together with recess groove 211 formed therebetween. Insert 205 has through-hole 212 and insert 209 has holes 213 and 214 formed 90° apart. By rotating stack assembly 480 by half of the crankshaft speed, valve 460 is suitable for use with stack assembly 480 in ignition gas surcharging or jet ignition surcharging or supraignition, and valve 470 is suitable for use with stack assembly 480 in buffer-bypass ignition and exhaust gas surcharging. Stack assembly 480 incorporates one key formed by groove 211. More than one key can be used, and, in fact, hundreds of keys can be useful. If desired, the entire stack assembly 480 can be adjusted. A single pipe with four insert stacks per cylinder over an engine block cylinder head can very well serve the need for valves and that such mechanism is much simple and less expensive than four poppet valves per cylinder on two common camshafts.

In FIG. 36 there is seen a perspective view of another embodiment of a valve insert 490 constructed and arranged in accordance with the principle of the invention including a cylindrical body 215 having a longitudinal axis 216 and opposed ends 215A and 215B. End 215A is formed with an annular array of equally sized and equally spaced apart teeth or keys 218, and end 215B is likewise formed with an annular array of equally sized and equally spaced apart teeth or keys 219 matching keys 218. Keys 218 and 219 allow for precision timing adjustment and a keyed connection to other similarly constructed valve inserts. A through hole 217 passes the gases when aligned with the holes in a corresponding sleeve in a stacked sleeve arrangement.

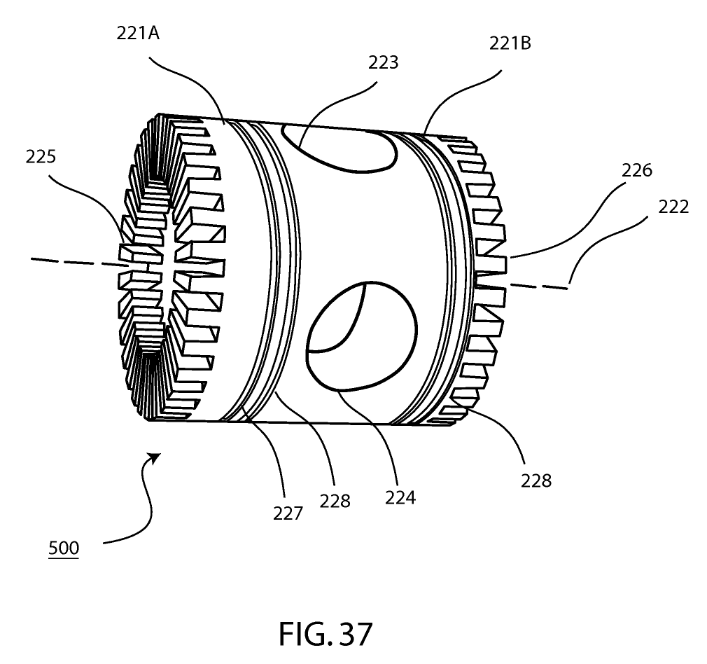

FIG. 37 illustrates a further embodiment of a valve insert 500 suitable for buffer ignition and buffer surcharging and with elongated, long slotted milled, holes for intake and exhaust operations. Valve insert 500 includes a cylindrical body 221 having longitudinal axis 222 and opposed ends 221A and 221B. End 221A is formed with an annular array of equally sized and equally spaced apart teeth or keys 225 and end 22B1 is formed with an annular array of equally sized and equally spaced apart teeth or keys 226 matching keys 225. Keys 225 and 226 also allow for precision timing adjustment. Holes 223 and 224 are formed in body 221 and are offset 90 degrees relative to each other. Ends 221A and 221B are each formed with annular keyways 227 and 228 formed to accept sealing ring inserts, similar to the one found on engine pistons.

Valve inserts constructed and arranged in accordance with the principle of the invention can be formed in a row over the cylinder heads of an internal combustion engine to form an effective valve system in lieu of conventional poppet valves, which can handle short and long valve openings as needed for the engine modifications set forth in this disclosure. Such valve systems provide smoother gas flow compared to conventional poppet valves, and do not choke gas flow and thus need no sophisticated porting design.

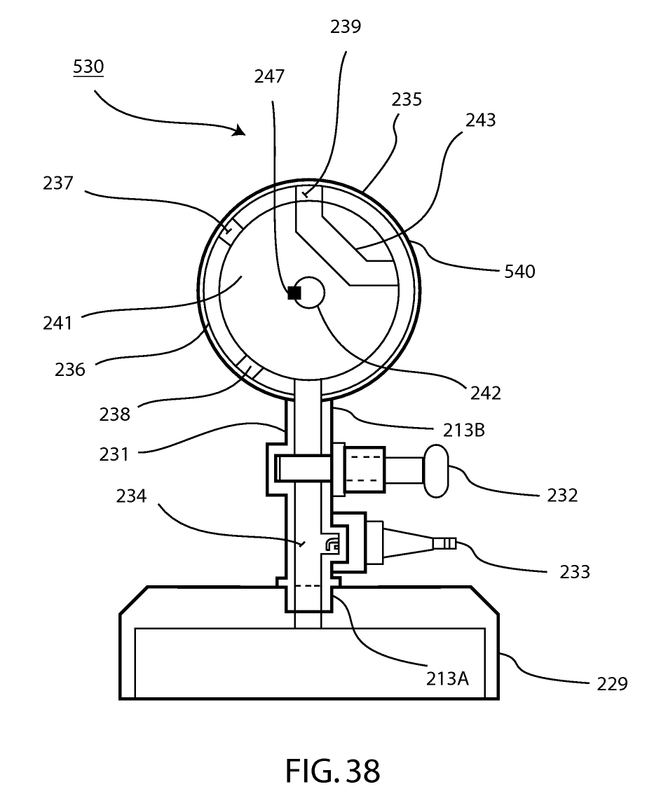

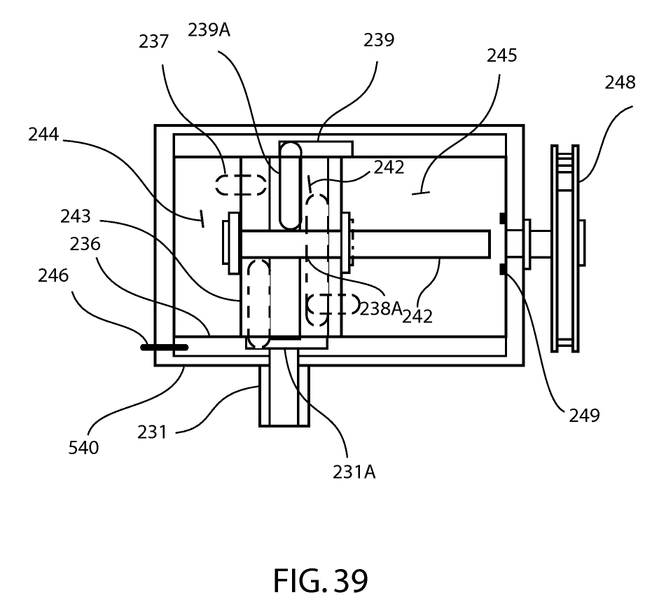

A schematic representation of a surcharge manifold assembly 530 for use with a cylinder assembly of an internal combustion engine is illustrated in FIG. 38. FIG. 39 is a longitudinal cross-sectional view of a rotary valve surcharge assembly 540 of surcharge manifold assembly 530 of FIG. 38. Retrofit assembly 530 takes the place of the spark plug of the cylinder assembly.

Referencing FIG. 38, a spark plug is removed from the spark plug receiving area formed in cylinder 229 forming part of the cylinder assembly. Surcharge manifold assembly 530 consists of a connecting conduit or pipe 231 having an end fitted into the receiving area formed in cylinder from which the spark plug was previously removed, and an opposing end coupled to rotary valve surcharge assembly 540. A valve 232 is formed in pipe 231 between housing 235 and cylinder, and is movable between a first position opening pipe 231 coupling housing 235 to cylinder in gaseous communication, and a closed position isolating housing 235 from cylinder. In this embodiment, valve 232 is a conventional, manually operated push-pull rod valve. If desired, valve 232 may be activated by a servo-mechanism or other automated device. In other embodiments, valve 232 can be provided as a ball valve or other suitable type of valve.

As mentioned above, valve 232 is movable between a first position closing pipe 231 and a second position opening pipe 231. In the closed position of valve 232 closing pipe 231, a small volume or space 234 in a lower portion of pipe 231 between valve 232 and cylinder head 229 communicates with and is effectively added to the volume of cylinder, which drops the compression ratio of cylinder by approximately 1-2%, in accordance with the principle of the invention. A conventional spark plug 233 is installed with conduit 231 between valve 232 and cylinder, communicates with volume 234, and functions to ignite compressed ignition gas in pipe 231 at volume 234. In the closed position of valve 232, retrofit assembly 530 is deactivated or not operational. In the open position of valve 232, retrofit assembly is activated or operational. In a particular embodiment, valve 232 is omitted thereby rendering retrofit assembly 530 constantly operational.

Rotary valve surcharge assembly 540 includes a housing sleeve 236 held within a cylindrical housing 235 together bounding a volume or chamber within which a rotary valve insert stack assembly 241 is positioned, which divides the volume or chamber into opposed hot and warm chambers 244 and 245 on either side of stack assembly 241 as illustrated in FIG. 39. Housing sleeve 236 is formed with bypass areas or slots 237, 238, and 239, which divert hot or warm gases from cylinder to either hot chamber 244 or warm chamber 245 in response to rotation of rotary valve stack 241.

Rotary valve stack 241 is fixed to shaft 242 driven for rotation by timing wheel 248 illustrated in FIG. 39. Timing wheel 248 is operatively coupled to the crank shaft of the engine, or other rotating shaft, such as with a belt, to rotate timing wheel 248, and thus shaft 242, in response to rotation of the crank shaft or other rotating shaft. In accordance with the principle of the invention, wheel 248 turns at a rate of rotation half that of the rate of rotation of the engine crank shaft.

Stack 241 has three valve inserts in the present embodiment. Referencing FIG. 39, in each of the three inserts of stack 241 a passageway 243 is formed, one to receive and hold or retain ignition gas for supraignition and two to receive and hold and retain exhaust gas for exhaust gas surcharging. Stack 241 also has a fourth segment, which closes stack 241. In other embodiments, in place of a stack a simple cylindrical boss can be directionally drilled to provide the required gas passages. The passages inlet and outlet orifices are approximately orthogonal and thus only once in every shaft 242 turn open and close. Locking pin 247, which is illustrated in FIG. 38, on shaft 242 and 246 in sleeve 236 allows for timing adjustment. A sealing ring ensures air tightness of chamber 245 and thereby of assemblies 540 and 530. Stack 241 outside and sleeve 236 inside can be simply honed and not sealed. If gas escapes between the honed surfaces, it would still remain enclosed and thus engine performance would not be compromised.

Chambers 244 and 245 of surcharge assembly 540 receive and retain gases from cylinder 229 via pipe 231 in response to rotation of stack 241 in concert with operation of the associated cylinder assembly along the combustion cycle consisting of the intake, compression, combustion, and exhaust processes. Chambers 244 and 245 of surcharge assembly 540 receive and retain gases from cylinder 229 via pipe 231 in different stages of operation of the combustion cycle of the cylinder assembly and at different temperatures. As the cylinder assembly cycles through the stages of the combustion cycle, stack 241 rotates cyclically intaking exhaust and ignition gases in the respective chambers 244 and 245 and cyclically applying retained exhaust and ignition gases into cylinder 229 of the cylinder assembly in a cyclic rhythm of ignition gas surcharging or jet ignition and exhaust gas surcharging or supraignition, the exemplary details and benefits of which are discussed previously in this disclosure.

As matter of example of the operation of surcharge manifold assembly 530, at and around a piston top dead center position (not shown) in cylinder 229 at the end of the compression stroke of the compression process, hot retained exhaust gas, just ignited in the previous cycle, rushes in and passes through from chamber 244 to slot 237 and groove 234 and slot 231A and pipe 231 into cylinder 229, which ignites the ignition gas in cylinder. Upon ignition, the exhaust gas jet ignition, i.e., the now ignited gas mixture as fresh exhaust gas, rushes back in reverse order through the same pipe, groove and slot, where it remains retained for the next cycle, in accordance with the principle of the invention. During this ignition, as well as before, during the compression and expansion processes warm retained exhaust gas remains in chamber 245. Spark plug 233 may be left on firing without significantly modifying this ignition process, or may be shut off shortly after engine startup.

Slightly after the bottom dead center position of the piston (not shown) in cylinder 229, just after the intake valve is closed, warm retained exhaust gas rushes from chamber 245 through slot 239 and groove 239A and slot 231A and pipe 231 into cylinder 229 where the air-fuel mixture mixes with the exhaust gas and gets compressed as well. Shortly after this discharge of chamber 245, groove 239A is no longer aligned with slot 239 and thus the discharge ceases as the compression cycle commences. The charge of chamber 245 with fresh warm expanded exhaust gas is at the end of the expansion process similar to the described discharging, but now in reverse order and through slot 238 and groove 238A. This discharge and charge is the process of surcharging.

Surcharge manifold assembly 530 is configured for use with a single cylinder of a single cylinder assembly. Surcharge manifold assembly, including surcharge assembly 540, can be expanded to service multiple cylinders of a multiple cylinder assembly. Such an expanded assembly can use surcharge chambers common to adjacent cylinders, provided that in such the pistons reach bottom dead center concurrently and in one the compression process begins, while in the other the combustion process is ending. Using extra rotary valve stacks, the ignition chambers of such an assembly can also be coupled together. Such couplings save space and weight. Instead of feeding rotary valve 245 via slot 231A and pipe 231, the segments of valve 241 can be given access independently and each such feed line can have ball valve to open or close or choke gas flow as needed. Such triple valve could substitute valve 232 and could be operated by a servo-mechanism or the like. Such operation could regulate exhaust gas recycling ratio at ignition and surcharge.

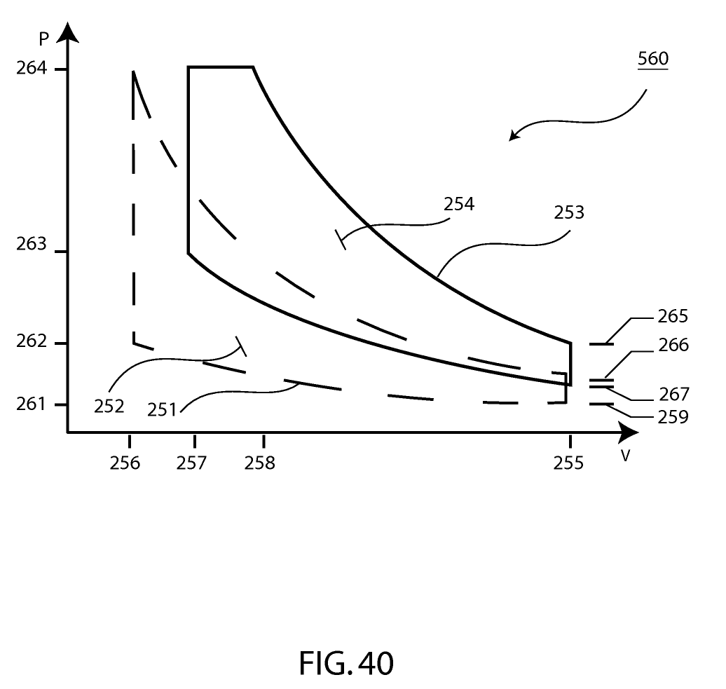

FIG. 40 is a graphical representation illustrating a comparison between a diagram 251 representing a constant volume ignition pressure vs. volume (P-V) Otto cycle of a spark ignition engine, and a diagram 253 representing a pressure vs. volume (P-V) Seiliger cycle of operation of the same engine modified with ignition gas surcharging or supraignition and exhaust gas surcharging.

The constant volume ignition cycle illustrated by diagram 251 starts 255 at full cylinder volume and intake pressure 259, which is about the same as atmospheric pressure 261. The piston compresses the intake air-fuel mixture volume 256 and pressure 262, when a spark ignites the compressed air-fuel mixture adding heat and pressure at constant volume 256, up to pressure 264. The burning gas expands up to volume 255 driving down the piston in the combustion process, and looses pressure down to pressure 266. During the consecutive exhaust and intake strokes in the exhaust and intake processes, in which the volume goes down to volume 256 and then back to volume 255 at around pressure 261, the pressure is reduced to pressure 259 and the cycle starts over. This cycle takes two crank shaft revolutions and four strokes of the piston in the present embodiment, including the intake stroke, the compression stroke, the compression stroke, and the exhaust stroke. The area bound by diagram 251 is the useful work of the described cycle, and the compression ratio is the ratio of volume 255 to volume 256. The fuel consumption is proportional to the difference in pressures 264 and pressure 262. The charging/discharging loop between points 255,259 and points 256,259 is not shown, and typically neglected, for having negligible negative area.

An internal combustion engine modified according to the principle of the invention operates at peak cylinder pressure 264. The mixed cycle starts at volume 255 at pressure 266, because surcharging from pressure 265 raises the starting pressure to pressure 259, which is approximately the average pressure of pressure 265 and pressure 259. The intake air-fuel mixture mixes with the expanded exhaust gas retained in the previous cycle and thus gets warmer. Then the piston compresses this mixture down to volume 257 in the compression process, where the mixture obtains pressure 263. While the piston is compressing down to volume 256, since now the ignition valve is open, the ignition chamber volume adds to the cylinder volume thereby dropping the compression ratio. At this instant, the fresh mixture ignites and at constant volume 257 and cylinder pressure reaches pressure 264. Since the ignition valve is still open, the fuel keeps burning until the cylinder volume reaches volume 258, while the cylinder pressure remains at pressure 264. During this constant pressure burning, the mixture burns out and gets hot and converts exhaust gas. The difference between volumes 256 and 257 is about the same as that of volumes 257 and 258. The expansion of the exhaust gas starts upon ignition valve closing at volume 258 and continues volume 255 and pressure 265 are reached. During expansion in the combustion process the exhaust gas rapidly cools from hot to warm. Here surcharging takes place and the cycle starts over. The area 254 enclosed by diagram 253 is the same or larger than area 252 enclosed by diagram 251. The fuel consumption is now proportional to the difference in pressures 264 and 263, which clearly shows fuel saving. Depending on the timing of the ignition valve, the difference between volumes 258 and 257 can be reduced to zero, in which case, diagram 253 illustrating a Seiliger loop degrades to an Otto loop as represented by diagram 251. When Otto loop results before and after engine modification, the loop areas of diagrams 251 and 253 are about the same and engine efficiency is not improved significantly. However, other benefits, such as clean emission and stronger torque, are achieved. Again, the charging-discharging loop, the surcharging loop and the ignition loop between points 257,264 and 256,264 are not shown for having negligible area or for cancelling each other (surcharging loop beyond volume 255). The diesel combustion cycle similarly converts to a Seiliger or Otto cycle. FIG. 40 illustrates the pressure vs. volume (P-V) cycles in an idealized representation, with sharp corners for emphasizing constant volume and constant pressure thermodynamic processes. Measured pressure vs. volume (P-V) loop plots, however, have well rounded corners. Water of fuel injection can maintain the constant pressure 264 as desired.

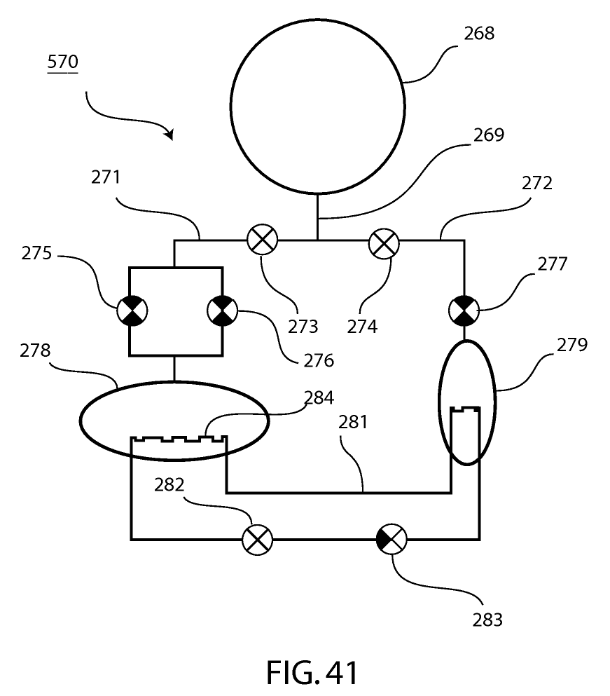

Reference is now made to FIG. 41, which is diagrammatic illustration of a surcharging system 570 including a heat pump operatively coupled between surcharging and ignition vessels, in accordance with the principle of the invention. In this embodiment, a heat pump is provided, which pumps or otherwise transfers heat from surcharging vessel 278 to ignition vessel 279 to reduce heat loss from ignition gas during its retainment and cools recycled surcharging gas, both of which beneficially contribute to engine operation and efficiency.

In FIG. 41, a cylinder assembly is represented including a cylinder 268 incorporates a reciprocating piston (not shown). Conduit or pipe 269 is connected to cylinder 268 at the compressed cylinder volume space to allow passage of gases. Pipe 269 branches off to two corresponding lines including surcharging line 271 and ignition line 272. Shut off valves 273 and 274 are formed in lines 271 and 272, respectively, to open and close the respective flows of surcharging and ignition gases. Pipes 271 and 272 are connected and terminate in surcharging vessel 278 and ignition vessel 279, respectively. The inflow to vessel 278 is controlled by valve 275 and the outflow from vessel 278 is controlled by valve 276. Similarly, flows to and from vessel 279 are controlled by valve 277. Valves 275, 276 and 277 are timed and can be mechanically driven poppet or rotary valves, driven by the engine's crankshaft, or can be electromechanical valves synchronized with the engine's piston stroke. The volume of vessel 278 is comparable to the uncompressed cylinder volume and the volume of vessel 279 is comparable to the compressed cylinder volume.

The heat pump is coupled to vessels 278 and 279, and consists of heat exchangers 284 and 285 coupled to a closed loop cooling liquid line 281, shutoff valve 282, and pump-and-valve unit 283. Heat exchanger 284 is associated with vessel 278, and heat exchanger 285 is associated with vessel 279. Unit 283 operates to pump fluid through line 281 to circulate fluid between heat exchangers 284 and 285. Unit 283 may be driven by the engine's crankshaft or by an electric motor, which takes energy to run from the engine.

The direct drive of valves 275, 276, 277 and pump 283 is inherently automatic requiring no process control with sensors, processors, and actuators. The common closure of valves 273 and 274 shuts off the process of surcharging and recycled gas ignition. Closure of one of these valves shuts off only the respective process.

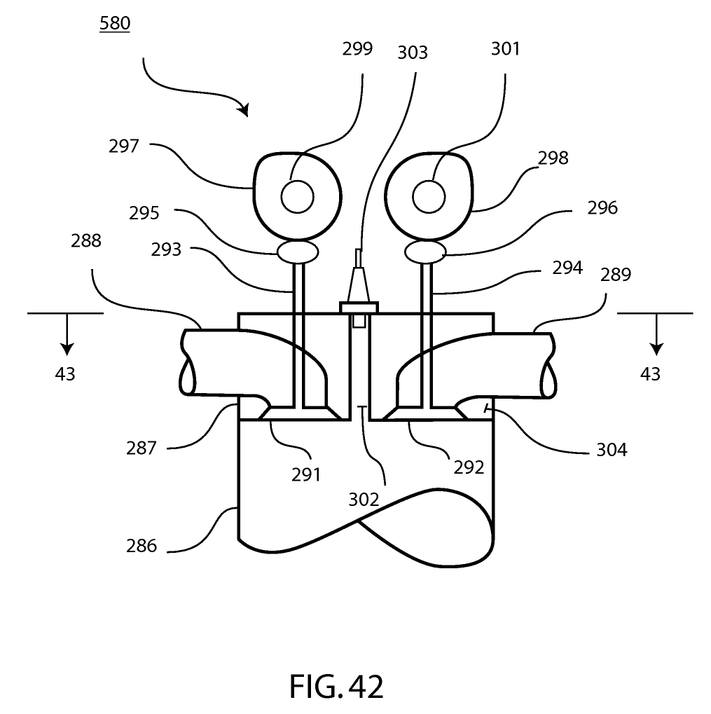

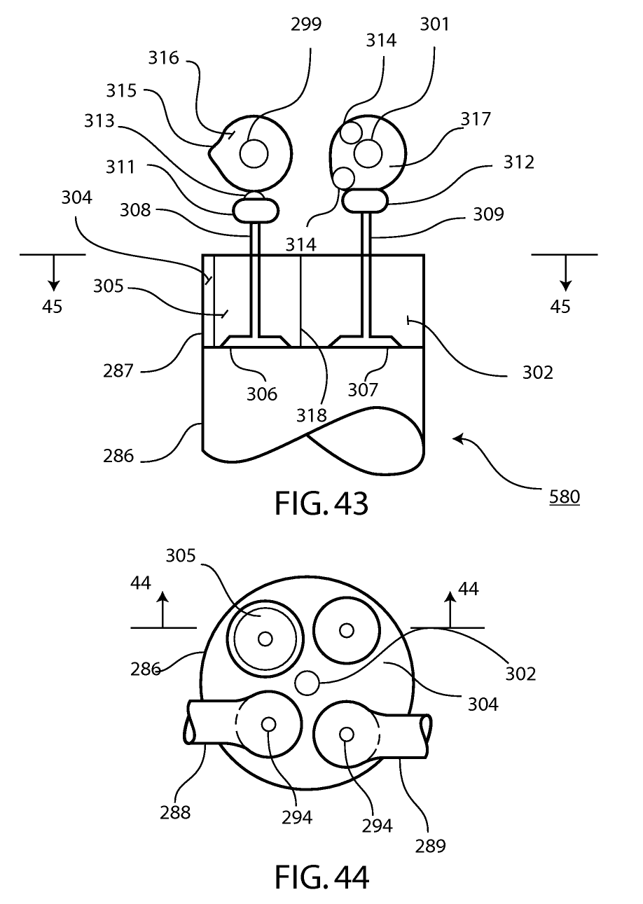

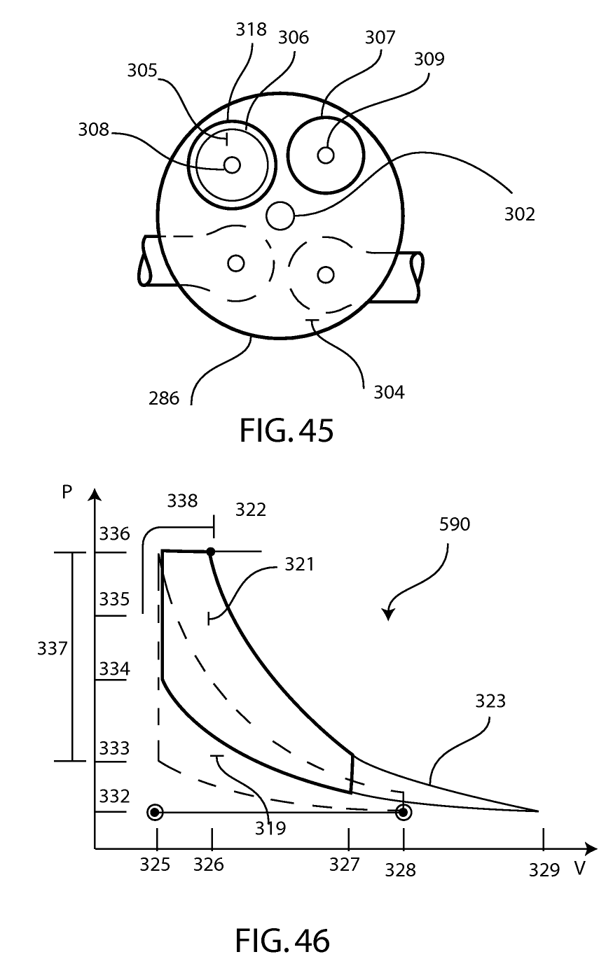

A cylinder head system 580 of an internal combustion engine is illustrated in FIG. 42, which is formed with a nested surcharging and ignition or supraignition chamber constructed and arranged in accordance with the principle of the invention, FIG. 43 is a sectional view taken along line 43-43 of FIG. 42; FIG. 44 is a sectional view taken along line 44-44 of FIG. 43, and FIG. 45 is a sectional view taken along line 45-45 of FIG. 44. Cylinder head system 580 is a modification to a conventional cylinder head, which incorporates added poppet valves for surcharging, and gas ignition control in supraignition processes. This engine modification is simple, easy to manufacture, inexpensive, and is useful in new engine construction and engine retrofitting.

Referencing FIGS. 42-45 in relevant part, cylinder 286 of a cylinder assembly is capped with cylinder head 287 constructed and arranged in accordance with the principle of the invention, forming an ignition chamber 305 nested in surcharging chamber 304. Head 287 is formed with intake port 288 and exhaust port 289, which may be heat insulated or cooled inside head 287. In this embodiment, wall 318 separates surcharging chamber 304 from ignition chamber 305. Wall 318 may be heat insulated if desired, which depends on the heat exchange configuration that is desired between surcharging chamber 304 and ignition chamber 305. Common poppet valves (not shown) control gas exchange between cylinder 286 and ports 288 and 289. These valves are open during a half stroke of the engine's overhead crank shafts 299 and 301, which corresponds to a 90° cam angle on the cam shafts, which turns with half crankshaft speed. Specifically, the valve assembly under cam shaft 299 to control intake includes valve head 291 formed in a lower end of valve stem 293 having an opposed upper end capped with tippet 295 and cam 297 affixed to crank shaft 299. Under cam shaft 301, the valve assembly to control exhaust includes valve head 292 formed in a lower end of valve stem 294 having an opposed upper end capped with tippet 296 and cam 298 affixed to crank shaft 301. A conduit or tube 302 passes through chamber 304 and receives spark plug 303 operative to produce gas ignition in cylinder 286.

Adjacent to cams 297 and 298 a gas ignition valve assembly and a surcharging valve assembly controls the gas ignition and the surcharging of the modified engine. These valves are also poppet valves actuated or otherwise moved by cams, which have larger diameters and their protrusions are circumferentially short and rather sinusoidal thereby warranting roller insertion between the cam and the tippet. The roller can be either in the cam or in the tippet, and FIG. 43 is illustrative of this aspect.

In FIG. 44, the ignition valve assembly under crank shaft 299 to control gas ignition between cylinder 286 and ignition chamber 305 includes valve head 306 formed in the lower end of valve stem 308 having an upper end formed with a tippet 311 formed with a ball socket in which is positioned ball 313, and cam 316, formed with protrusion 315, affixed to cam shaft 299. The surcharge valve assembly under crank shaft 301 to control surcharging and gas communication between cylinder 286 and surcharging chamber 304 includes valve head 307 formed in a lower end of valve stem 309 having an opposed upper end formed with tippet 312 and cam 317, formed with two pin rollers 314, affixed to cam shaft 301. Chamber 304 is circular in a preferred embodiment, but may be square or rectangular if desired, or formed of some other desired shape.

Because poppet valves make rotary valves an historical curiosity, it is expected that assembly 580 will be the norm in internal combustion engine modification. Assembly 580 can be formed with water and/or fuel injection features according to prior disclosures of the invention. The surcharging chamber volume is limited to the uncompressed cylinder volume and the ignition chamber volume is limited to the compressed cylinder volume. Typical added chamber volumes are about half of these limit volumes. Head 287 is cooled the same way as cylinder 286. An internal combustion engine modified with assembly 580 produces approximately 15-30% more power from the engine as compared to the same engine unmodified. As such, a new engine constructed with assembly 580 can be made smaller and lighter than an unmodified engine, which provides an engine that is more efficient, uses less fuel, and that saves in maintenance costs.

A pressure vs. volume (P-V) diagram 590 is illustrated in FIG. 46, illustrating fuel consumption characteristics of an internal combustion engine modified according to the teachings of the invention. Diagram 590 is illustrative of the performance gain and workings of an engine modified according to the teachings of the invention, which uses approximately 50% less fuel and emits approximately 90% less toxic emissions as compared to a comparable unmodified engine. Diagram 590 is plotted in the pressure vs. volume (P-V) coordinate system. The dotted loop bounding area 319 illustrates the performance of an unmodified petrol engine, and solid loop bounding area 321 illustrates the performance of the same engine modified according to the principle of the invention. Appendages 322 and 323 represent gas ignition or supraignition and surcharging respectively. Empty circles in the diagram in FIG. 46 indicate valve openings and full circles indicate valve closings.

The piston reciprocates between volume 328 at the bottom dead center piston position and volume 325 at the top dead center piston position. Thus, the compression ratio is V₃₂₈/V₃₂₅ for both engines. Area 319 is equal to area 321. Thus, the useful work of both engines is the same. The peak pressure P₃₃₆ is also the same for both engines, but maximum torque of loop 321 is higher than that of loop 319. Area 319 represents an Otto cycle and area 321 represents a Seiliger cycle. Thus, the modified engine is more thermally efficient than the unmodified one, but only marginally. However, the modified engine is far more fuel efficient, because heat input 388 of the modified engine is half of heat input of 337 of the unmodified engine. Heat input 377 is added only at constant volume V₃₂₅, but heat input 338 is added first at constant volume V₃₂₅, and thereafter at constant pressure P₃₃₆ For comparison, the two processes are described next in detail, including the unmodified and modified engine processes.

The unmodified engine starts its cycle with intake valve opening at V₃₂₅, P₃₃₂, which is at atmospheric pressure at the top dead center position of the piston. The pressure P₃₃₂ can be higher than atmospheric, if the engine is supercharged, for instant with an air pump or turbine driven by the engine or by an electric motor powered by the engine's battery. As the piston lowers and reaches its bottom dead center position, the cylinder is filled with swept volume, V₃₂₈-V₃₂₅, and most of the remaining exhaust gas in the dead volume, V₃₂₅-V₃₂₄, is replaced as well with fresh air or ignition gas, i.e., a fuel/air mix. Under this example, V₃₂₄=0. Then the intake valve closes and the engine's intake stroke in the intake process is now completed. As the piston now rises starting its compression stroke in the compression process, the induction air or air-fuel mix gets compressed by the piston up to volume V₃₂₅ and pressure P₃₃₃ and its temperature rises somewhat. If only air was sucked in during the first stroke, fuel is directly injected into the cylinder intermittently before this stroke is over. The compression stroke at the top dead center position of the piston is now considered completed. Then the spark ignites the air-fuel mix and thus, at constant volume V₃₂₅, upon instant burning of the fuel in the mix, adding heat 337 to the system, the cylinder pressure jumps from P₃₃₃ to P₃₃₆. Note that heat 377 is directly proportional to the pressure difference P₃₃₆-P₃₃₃ and that the mix can be lean to rich controlled by the gas pedal. At this point, the piston initiates its combustion stroke in the expansion or combustion process power the engine. The combustion stroke of the expansion or combustion process starts at V₃₂₅, P₃₃₆ and ends at V₃₂₈ at an exhaust pressure higher than pressure P₃₃₂ but lower than pressure P₃₃₃. Then, exhaust valve opens and exhaust pressure quickly drops to atmospheric, while heat is removed from the engine at constant volume V₃₂₈, and the exhaust stroke of the piston in the exhaust process commences with the rising of the piston. This cycle ends at the top dead center position of the piston, where the exhaust valve closes and the intake valve opens and the next combustion cycle commences.

The modified engine also starts its combustion cycle with intake valve opening at V₃₂₅, P₃₃₂, which is at atmospheric pressure at the top dead center position of the piston. Note that exhaust is slightly above and intake is slightly under atmospheric pressure for naturally aspirated engines. Again, pressure P₃₃₂ can be higher than atmospheric, if the engine is supercharged. As the piston reaches its bottom dead center position, the cylinder is filled with swept volume, V₃₂₈-V₃₂₅, and most of the remaining exhaust gas in the dead volume, V₃₂₅-V₃₂₄, is replaced with fresh air or air-fuel mix. The engine's intake stroke in the intake process is now completed. At the bottom dead center position of the piston, the surcharging valve opens and lets warm retained exhaust gas flow from the surcharge chamber into the cylinder. Since the surcharging chamber has volume V₃₂₉-V₃₂₈, the common volume now is volume V₃₂₉. The pressure in the cylinder quickly rises due to pressure equalization. The fresh intake air or air-fuel mix now gets pre-compressed. It does not get much warmer though, since there is insufficient time for an appreciable amount of heat exchange during surcharging. Pressure in gases always builds up much quicker than temperature, since gases, having their molecules far apart, are bad heat conductors.

As the piston now rises in the start of the compression stroke in the compression cycle, the surcharging valve closes at volume V₃₂₇ of cylinder and the inducted air or air-fuel mix, mixed with recycled exhaust gas, gets further compressed, now by the piston alone, up to volume V₃₂₅ and pressure P₃₃₄, while its temperature rises somewhat. If only air was sucked in during the first stroke, fuel is directly injected into the cylinder intermittently before this stroke is over. At the top dead center position of the piston and the end of the compression stroke of the piston in the compression process, gas ignition valve opens at volume V₃₂₅ and pressure P₃₃₄. Hot gas, retained from the previous cycle at pressure P₃₃₆, now rushes into the cylinder from the gas-ignition chamber, which has a volume V₃₂₆-V₃₂₅. Instantly, pressure equalization takes place in the common volume V₃₂₆ and common pressure P₃₃₅, in which common pressure P₃₃₅ is the average pressure of pressures P₃₃₄ and P₃₃₆, and it is over the self ignition pressure of the mix. Pressure P₃₃₄ is below the self ignition pressure. The mix here is mostly lean, as to the induced self ignition jumps the cylinder temperature to only pressure P₃₃₆. At this point the piston commences the combustion or expansion stroke in the combustion process with pulsed fuel injection, which adds heat 338 and which is maintained to keep the cylinder pressure at pressure P₃₃₆ until the gas ignition valve closes at the lowered position of piston corresponding to volume V₃₂₆. This combustion stroke of the piston powers the modified engine. Since adding heat at constant pressure is approximately 7/5^{th} times more efficient than adding heat at constant volume of diatomic gases, heat 388 is half of heat 337, leading to a 50% fuel savings.

Before the burning gas fully expands, at volume V₃₂₇, surcharge valve opens to fill up the surcharging chamber with exhaust gas, which upon closing of the surcharge valve at volume V₃₂₈ is retained for the next cycle. Then, still at volume V₃₂₈, the exhaust valve opens and the piston commences the exhaust stroke in the exhaust process with the piston pushing out exhaust gases as the piston moves from is bottom dead center position to its top dead center position. Then, at volume V₃₂₅ and pressure P₃₂₂ the exhaust valve closes, the exhaust stroke of the piston in the exhaust process ends and the intake valve opens again and the next four process combustion cycle commences.

Note that the valve timing scheme is idealized here (neglecting valve timing leads, lags and overlaps) and the pressure equalization ratios may be different, depending on chambers to cylinder volume ratios. Consequently, the fuel saving ratio may vary as well. For instance, if one of ordinary skills accepts the practical limits of surcharge chamber volume to full cylinder volume 0.5 and gas-ignition chamber to dead cylinder volume 1.0, then the theoretical fuel saving is 4/7=57%. Note also that early direct fuel injection results in a homogenous mix and is advantageous in the upper engine load range. Late direct ignition is advantageous in the part load range and allows for very lean operation, which alone saves fuel, due to the associated “de-throttling” benefit on the combustion process. Thus, the just described direct-injection-gas-ignition (DIGI) modified engine takes advantage of both effects raising the fuel savings limit to 60%. Since fuel savings depends on engine load (or driving conditions of a vehicle), the actual fuel saving is 40-60%. Finally, it is to be noted that the constant pressure part of heat 338 can be added by pulse injecting diesel oil, rather than gasoline. However, dual fuel engines have certain inconveniences associated with the dual fuel tank needed, so the further savings, due to dual fuel usage, may not worth implementing. Supercharging, however, raises volumetric efficiency, resulting in modified engines that are smaller and lighter than unmodified engines and yet that have the same or better operational characteristics as larger and heavier comparable unmodified engines. Implementation of turbo-charging makes an internal combustion engine modified in accordance with the teachings of the invention is unnecessary. Furthermore, an engine modified according to the teachings of the invention runs best and most efficiently after it is warmed up, so engine idle-stop operation is not recommended.

Soot emission is negligible in normally operated petrol engines. The nitric oxide emission rate is highly sensitive to temperature and pressure, which however remains the same before and after engine modification. The exhaust gas recycling dilutes the ignition gas charge resulting in a substantial reduction in nitric oxide emissions for each combustion cycle. After Heywood, the nitric oxide production rate is 2400 exp (−0.113x), where x is the dilution ratio in % due to exhaust gas recycling. That yields to 93.4%, 97.3% and 99.6% nitric oxide emission reduction for dilution ratios of 25%, 33% and 50% respectively. Considering the above described surcharging and gas-ignition chambers volumetric ratio limits, the engine modification practically eliminates (reduces by 99.6%) nitric oxide emission and as a corollary, all toxic exhaust gas emissions.

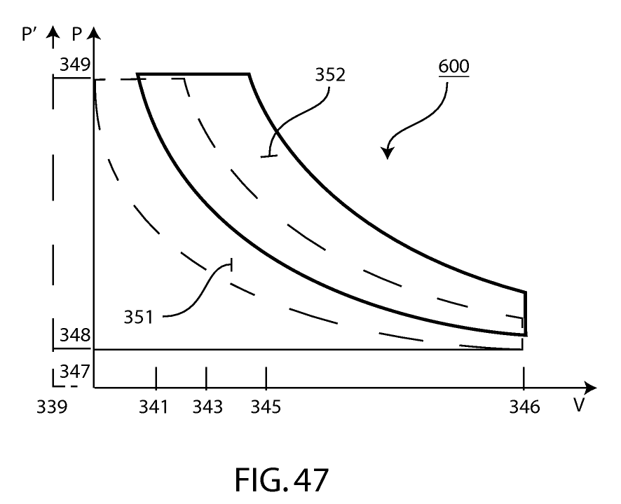

FIG. 47 is a pressure vs. volume (P-V) diagram 600 of performance characteristics of a diesel engine modified according to the principle of the invention. Diagram 600 is plotted in the pressure vs. volume (P-V), P-V, coordinate system. Area 351 bound by the dotted loop illustrates the unmodified diesel engine's performance on the P′-V plane, and area 352 bound by the solid loop illustrates a modified diesel engine's performance on the P-V plane. Ordinate P′ is shifted by the dead volume V₃₄₁-V₃₃₉ and the piston stroke is not reduced by this modification leaving the swept volume V₃₄₆-V₃₄₁ intact. Since surcharging ads and removes about the same energy, its related appendage loops are omitted for clarity. For simplicity, the workings of the classical Diesel process are not explained here in detail, rather the similarities and differences before and after modification is pointed out. Valve operations are not shown either.

The modified engine's dead volume is reduced to zero. However, when piston compresses the cylinder volume V₃₄₆ to volume V₃₄₂, the gas-ignition valve opens and ads to this volume V₃₄₂ the gas-ignition chamber's volume V₃₄₂-V₃₄₁, which is the same as the dead volume of the unmodified engine. This way, while the piston keeps pushing, the cylinder pressure does not escape to infinity, but remains at the pressure P₃₄₉ peak level. The gas-ignition chamber has about pressure P₃₄₉ at all times during warmed up engine operation. The piston now reaches its top dead center position then returns towards its bottom dead center position. In this movement, when the cylinder volume is reduced to volume V₃₄₂, the gas-ignition valve closes and the pulsed fuel, such as oil, injection starts until the volume V₃₄₅ is reached. Since volume V₃₄₅-V₃₄₂ is the same as volume V₃₄₃-V₃₄₁, there is no fuel savings here. However, due to the dilution effect of the exhaust gas recycling at both the gas-ignition and the surcharging, great cleaner burning benefits are gained and the increase in torque is considerable. Again, pressure P₃₄₈ can be atmospheric or elevated by supercharging, but not by turbo-charging. Note that in this idealized operation small valve timing advances and retarding and overlaps are neglected, and that fuel injection is to commence just before gas-ignition valve closing.

For diesels engines, carbon monoxide and soot emissions are controlled similarly to the way described above for modified petrol engines. Substituting to Heywood's equation above, one can conclude that the diesel engine modification practically eliminates (reduces by more than 99%) soot, white smoke and carbon dioxide and nitric oxide emissions.

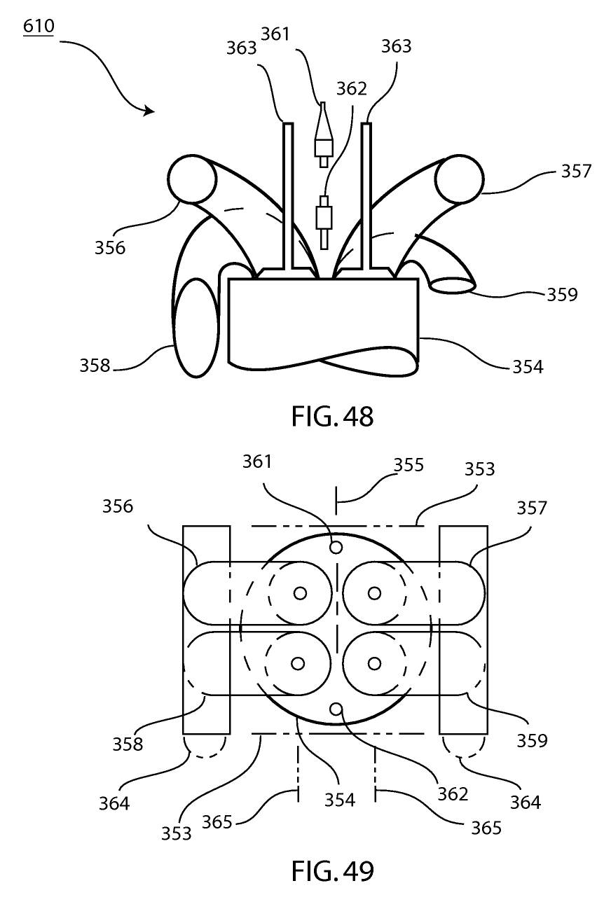

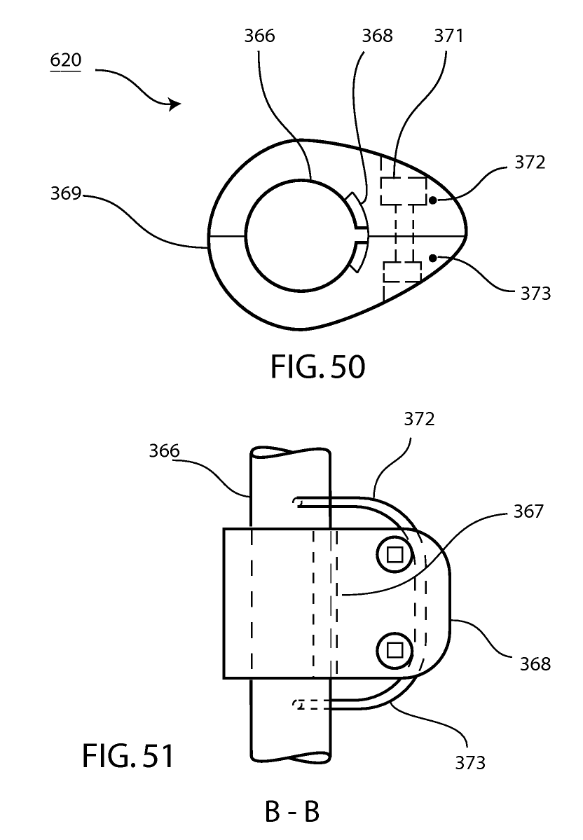

Attention is now directed to FIG. 48, which is schematic diagram of manifold cylinder assembly 610, and to FIG. 49, which is a schematic top plan view of manifold cylindered assembly 610. Assembly 610 is modular, meaning that it can be repeated to form and I-4 or V-8 engine block with head and common manifolds. Since the 4-valve cylinder head is common and popular, this embodiment may be the simplest, least intrusive and more economical engine modification according to the teachings of this invention. This structure represents an embodiment to carry out the processes illustrated in FIG. 46 and in FIG. 47. To make the 2-camshaft configuration work, a modification of the cams operating the buffer manifolds is provided in the embodiment illustrated in FIGS. 50 and 51.

Referencing FIGS. 48 and 49 in relevant part, mate lines 353 match consecutive modules of assembly 610 along centerline 355. Cylinder head 354 includes intake manifold 356, exhaust manifold 357, surcharging buffer manifold 358, gas ignition buffer manifold 359, glow plug or spark plug 361 and fuel injector 362, which is hooked up on a common rail centered to line 355. The manifolds include common poppet valves 363, which are operated by a common cam mechanism along the camshaft centerlines 365. Buffer manifolds 358 and 359 are capped at inline assembly ends with caps 364.

Attention is now directed to FIG. 50, which is a schematic top plan view of a modified cam assembly 620 to provide short duration surcharge and gas-ignition valve openings, and to FIG. 51, which is a schematic side view of the modified cam assembly of FIG. 50. Modified cam assembly 620 enables operation of assembly 610, and is a swivel cam assembly that swivels forward and backward, before and after maximum gap, respectively, reducing valve opening time. The swiveling motion is restored by springs or the like.

In the present embodiment, crank shaft 366 has a local key 367, which is capable of moving radially in keyway 368 formed in split swivel cam 369, which is joined by a rigid connector or fastener 371, such as a bolt, rivet, or the like, which is flush with cam 369 outer surface. Cam 369 is split in two parts, encircles crank shaft 366, and fastener 371 serves the additional function securing the two parts of cam 366 together. Once cam 369 hits the valve stem tippet, cam 369 rotates back on crank shaft 366 until key 367 engages and the valve starts opening. Once the maximum opening is reached, cam 369 swivels backward. In this operation, the valve opening time is reduced compared to that of the fixed cam of the same geometry. This allows that all four valves and cam profiles over the cylinder are the same. Spring 372 acts on cam 369 and restores cam 369 from back swivel movement and spring 373 acts on cam 369 and restores cam 369 from forward swivel movement. Springs 372 and 373 are set in a groove formed in cam 369 and in respective bores in crank shaft 366. If keyway 368 is closed sideways, entrapped air acts as a damper to reduce the nose of assembly 620 in operation.

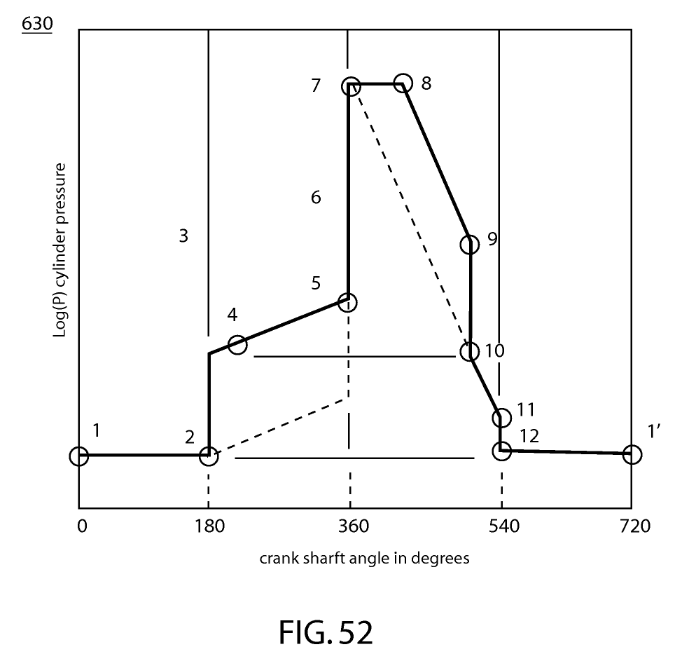

A diagram 630 of cylinder pressure to crank angle in a combustion cycle including surcharging, gas ignition and direct injection is illustrated in FIG. 52. Diagram 630 represents surcharge and gas ignition valve timing to enable the operation of the embodiment depicted in FIGS. 50 and 51. That is, diagram 630 illustrates the cylinder pressure of a modified four-valve, four-stroke engine, which employs surcharging, gas ignition or supraignition at constant volume and direct injection at constant pressure with heavy full lines. For reference, the unmodified spark ignition engine pressures are marked by thin dotted line.

At the top dead center position of the piston, suction, i.e., induction, starts at point 1 and ends at point 2 at atmospheric pressure if the engine is naturally aspirated or at a higher pressure if the engine is supercharged. Air or air-fuel mix can be sucked into the cylinder in this stroke in the intake process. At the bottom dead center position of the piston, surcharging starts at point 2 and ends at point 4. The pressure equalizing is idealized as an instantaneous jump at point 3. Compression takes place between points 4 and 5 in the compression process followed by gas ignition between points 5 and 8 in the combustion process with instantaneous pressure equalizing at point 6 at the top dead center position of the piston. The fuel which was entrained during suction or injected during compression in the compression process is burning at constant volume between points 6 and 7 in the combustion process. High frequency pulse direct fuel injection in droplet train follows at constant pressure between points 7 and 8. Expansion in the combustion process takes place between points 8 and 11, which includes the surcharging between points 9 and 11 considering an instant pressure drop between points 9 and 10. At the bottom dead center position of the piston, exhaust takes place between points 11 and 1′ in the exhaust process with an instantaneous pressure drop between points 11 and 12, and at point 1 this process is repeated in the next combustion cycle (1=1′ match points). Pressure drop 9-10 is equal to pressure jump 2-3 at surcharging. Pressure drop 7-6 is equal to pressure jump 5-6 at gas ignition, which is also equal to the pressure jump due to constant volume heat addition. Volume jumps 3-4 and 10-11 are also substantially equal and otherwise similar to volume jump 7-8. The intake valve opens at point 1 and closes at point 2. The surcharge valve first opens at point 2 and closes at point 4 and second time opens at point 9 and closes at point 11. The gas ignition valve opens at point 5 and closes at point 8. Finally, the exhaust valve opens at point 12 and closes at point 1′.

Expansion 7-10 of the unmodified engine gives much less torque than expansion 7-11 of the modified one even if the work of these two engines is the same. The torque is proportional to the pressure at 450 degree crank angle. Also, pressure jump 2-3 can come from supercharging, in which case surcharging may be redundant. In that case, line 1-2 will shift up to line 3-4, eliminating line 2-3, and point 8 and a point above 11 will connect, eliminating lines 8-9, 9-10 and 10-11 and extending line 11-12. At pressure drops and jumps, there is insufficient time for the cylinder gas temperature to fall or rise significantly.

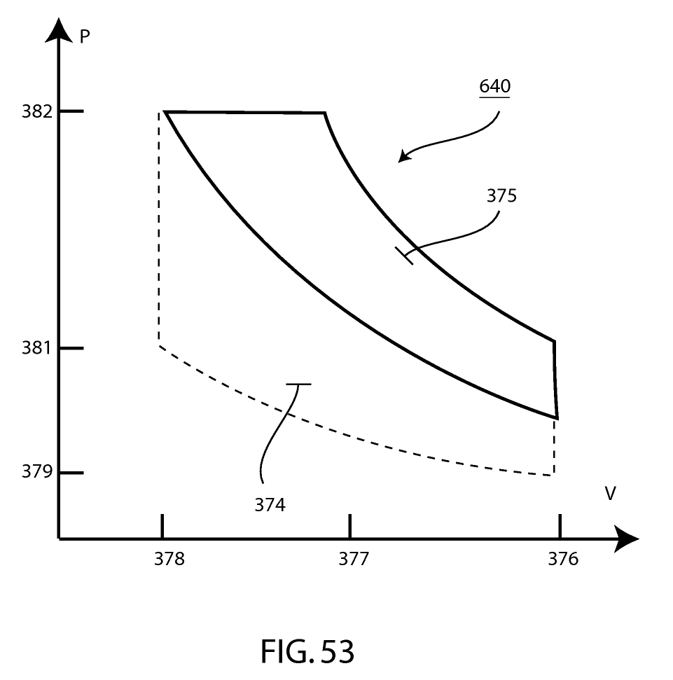

A pressure vs. volume (P-V) diagram 640 of a surcharging process is illustrated in FIG. 53. Diagram 640 represents a complete dieselization of a petrol engine by employing surcharging in conjunction with direct injection only after the piston reaches its top dead center position at the end of the compression process. When a surcharging chamber or buffer vessel volume is equal to the full cylinder volume V₃₇₆ and the engine aspirates only air, just like in diesel engine oil injection or petroleum injection begins and is maintained between cylinder volumes V₃₇₈ and V₃₇₇ at pressure P₃₈₂, which is the maximum cylinder pressure. The piston pushes up the aspirated atmospheric pressure P₃₇₉ to pressure P₃₈₁ if the engine is not surcharged. Spark ignition then jumps the pressure to pressure P₃₈₂. However, when the engine is surcharged, the compression curve of the surcharges engine will be identical to the expansion curve of the non-supercharged one terminating and originating respectively at peak pressure P₃₈₂. The resulting loop areas of loop 374 for the non-surcharged engine and loop 375 for the surcharged one then have the same area. As such, the two engines will have the same power, but the surcharged engine will have much higher torque while allowing for a smaller and lighter engine design and an associated fuel savings. The modified, i.e., surcharged, engine can save 50% fuel and still give 100% more power and 125% more torque. Supercharging can further help to reduce engine weight, but not turbocharging. Such engine modification needs only 3 valves. Gas-ignition or supraignition may be added to the surcharging process illustrated in FIG. 53, if so desired. A dieselized engine modified to run according to the surcharging process illustrated and described in conjunction with FIG. 53 also runs cooler or near to the same temperature as the unmodified spark engine counterpart.

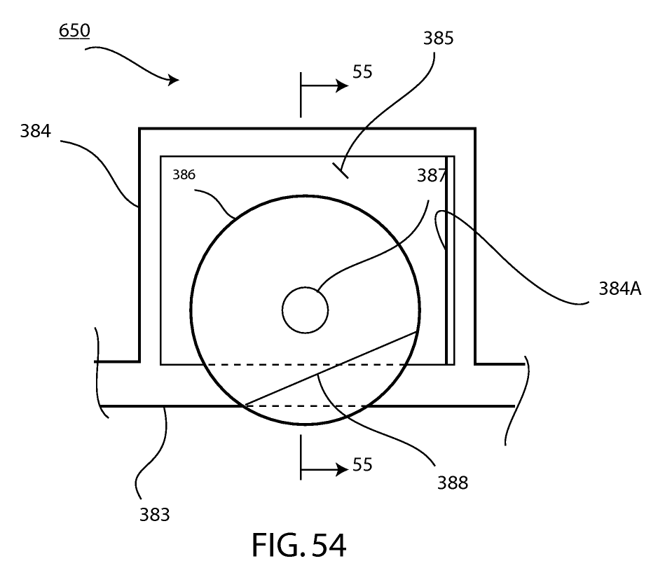

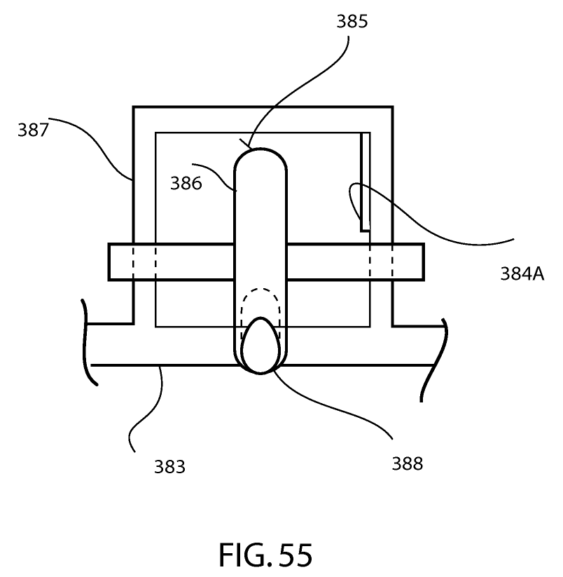

Reference is now made in relevant part to FIG. 54, which is a schematic diagram of a surcharge or gas-ignition valve assembly 650 constructed and arranged in accordance with the principle of the invention, and to FIG. 55, which is a sectional view taken along line 55-55 of FIG. 54. Assembly 650 a rotary valve, which is useful in surcharge or gas-ignition or supraignition systems constructed and arranged in accordance with the principle of the invention. Cylinder head 383 is the base of assembly 650 upon which chamber 384 is formed having a buffering volume 386 to receive and hold or otherwise retain buffer gas, whether in the form of exhaust gas in exhaust gas buffer bypassing or ignition gas in supraignition. Rotary valve 386 runs on axel 387, and rotates at half the crankshaft speed and commands valve opening through passage 388. Assembly 650 is a counterclockwise rotating valve in the present example, which is halfway open. Groove head 383 and the outer surface of valve 386 are easy to precision ground. The small gap between these at engine startup is affordable, since volume 385 does not communicate with outside air. The design yet needs to minimize temperature difference of head 388 and valve 386. Flat valve edge and straight cut passage is optional.

To ensure a hot surface in supraignition chambers, ceramic inserts can be used in the supraignition chambers, such as ceramic insert 384B or ceramic liner 384A. Should the pressure in chamber 384 drop below jet pressure, the retained heat of the ceramics will still ignite the surcharged and compressed ignition gas or fuel-air mixture. Ceramic inserts act in supraignition chambers as glow plugs in diesel engines.

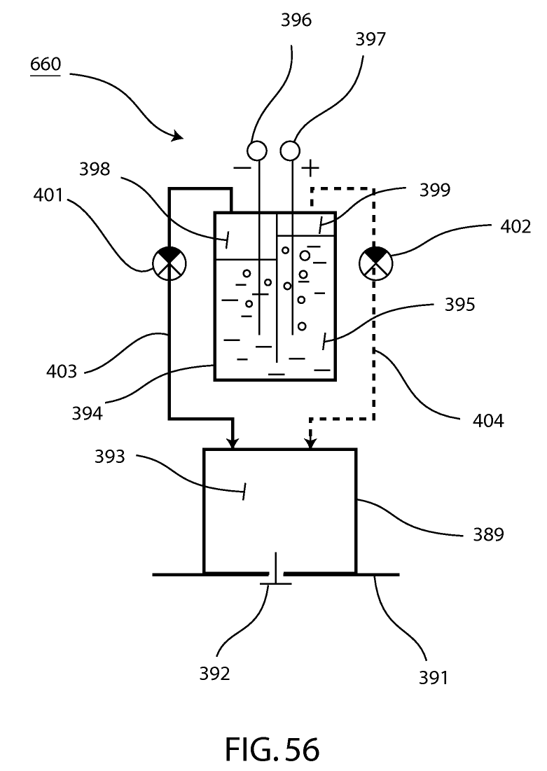

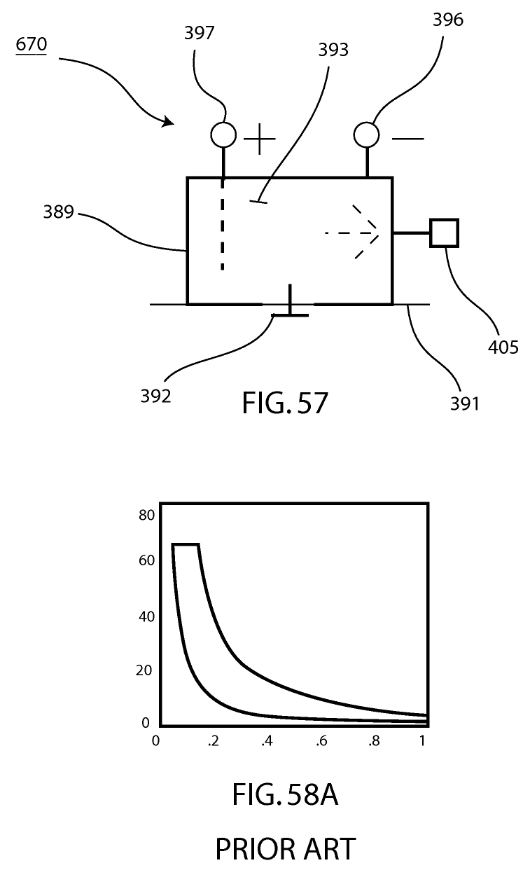

Attention is now directed to FIG. 56, which is a schematic representation of a buffer chamber with a hydrogenating and/or oxygenating systems, constructed and arranged in accordance with the principle of the invention. Hydrogen and/or oxygen entrainment to surcharging and/or gas-ignition or supraignition processes is beneficial in ensuring gas-ignition or just increasing power while saving on fuel. In particular, gas ignition can take place only if the pressure in the gas-ignition chamber is sufficiently high and higher at ignition valve opening than closing. One way to assure that is injecting water after valve closing or before valve opening or any time during valve closure. The water will instantly evaporate to high pressure superheated steam, providing for the high pressure need. That will be illustrated next in FIG. 57. Another way to assure the required high pressure is to entrain to the ignition chamber hydrogen after the ignition valve closed and oxygen before the same valve opens. However this sequence can be reversed. Concurrent hydrogen and oxygen entrainment is not advisable, yet practical. The non-concurrent H₂—O₂ assistance is illustrated in buffer chamber assembly 660 comprising an ignition chamber 389 and a water-splitting H₂—O₂ generator tank 394 as main system components.

Chamber 389 is part of cylinder head 391. Ignition valve 392 allows gas communication of ignition chamber volume 393 and the cylinder volume. Tank 394 contains water 395 with or without some electrolyte such as salt or acid in small quantities. Two electrodes are submerged into water 395, namely, cathode 396 and anode 397. Tank 394 is split to two compartments, but with communicating liquid content. Once the current-say from the engine's battery-is turned on, during engine run only, hydrogen forms in the compartment receiving cathode 396 and oxygen in the compartment receiving anode 397. The H₂ formation rate is twice as that of the O₂ one. Pump 401 forces the H₂ through pipe line 403 to chamber 389 and pump 402 forces O₂ through pipe line 404 to chamber 389. Pumps 401 and 402 are needed to be positively locking, to prevent high pressure ignition chamber gas entering into tank 394. Lobe pumps and external gear pumps are suitable. The dotted line 404 indicates that the two gas-pumping is preferably non-concurrent. Also that in other engine operation, only H₂ entrainment is preferred, in which case the O₂ is let out from the system. Furthermore, it also indicates that H₂ may be entrained into the ignition or supraignition chamber or vessel and O₂ into the surcharging chamber or vessel in modified engines as per the teachings of this invention. Note that the typical concerns of retaining and transporting of hydrogen is moot in this short circuit system, which stops H₂—O₂ generation after the engine is stopped and in which the H₂ or O₂ leaking into the cylinder volume does not represent any problem or danger.

FIG. 57 is a schematic representation of a buffer chamber assembly 670 with a steam electrolysis or thermolysis system, constructed and arranged in accordance with the principle of the invention. Buffer chamber 670 includes an ignition chamber 389 with supplemental steam electrolytic pressure generation system. The sufficient overpressure, which capable to ignite the homogenous compressed charge of the cylinder, can be achieved by steam formed by water injection, called thermolysis, which happens spontaneously above 2500° C. with water braking down to H₂ and O₂. That pressure can be further increased or just achieved independently with steam electrolysis, which is also called High-temperature electrolysis (HTE), which is most efficient between 100-850° C. and works on higher temperatures as well. At higher temperatures, the peak efficiency of 65% reduces to 35%, which is still extremely economical, being at or above the typical ICE efficiency range. Fuel and oxidant is generated this way from inexpensive water assisting the IC process. Because, water is consumable and the steam and vapor leaves the engine, this system is not a real IC-steam engine combination and thus has no lubrication problem.

Chamber 389 is part of cylinder head 391. Ignition valve 392 allows gas communication of ignition chamber volume 393 and the cylinder volume. Two electrodes are used, namely, cathode 396 and anode 397. Anode 397 is electrically insulated at its passage into chamber 389 and has high surface area, such as perforated plate or wire mesh or porous metal. Cathode 396 is grounded to the engines battery, which supplies voltage and current to electrodes 396 and 397. The generated hydrogen and oxygen burns back into water vapor or steam, which finally leaves the engine during the exhaust cycle. If surcharging is employed, part of it however remains recirculated with the retained exhaust gas. Note that the inner surface of chamber 389 is part of electrode 396 and thus may need special coating. The so formed electrodes may require special materials customary in HTE such as nickel-cermet, mixed oxide of lanthanum, strontium and cobalt. However, simple inexpensive stainless steel may suffice. Finally note that steam electrolysis and thermolysis require high heat and thus work only after engine warm-up. Also that these processes serve only as assist processes for power boost and are not sufficient alone to greatly reduce fuel consumption of the ICE. For instance, one cannot expect to run the ICE on water alone, even if sufficiently hot. The water to steam conversion removes heat from the engine, which would result in quick engine cooling off below vapor formation temperature. Yet, that heat reduction cools the engine and helps overall.

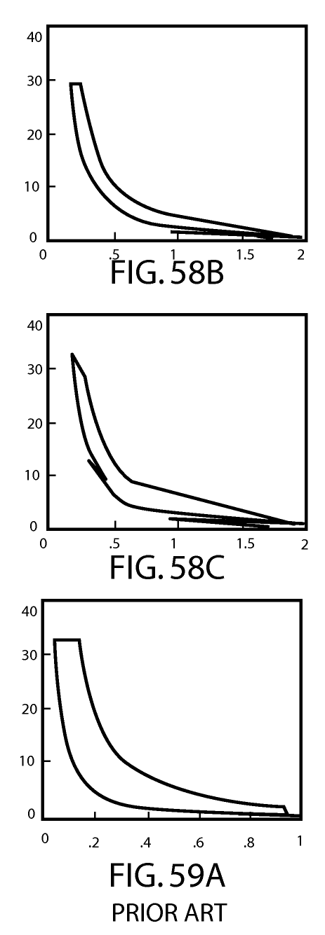

As a matter of illustration and reference, FIG. 58A is a prior art pressure vs. volume (P-V) plot of the combustion cycle of a conventional four stroke diesel engine in which the volume (V) is normalized to full cylinder volume and P is scaled in atmosphere, whereas FIG. 58B is a pressure vs. volume (P-V) plot of the same four stroke diesel engine plotted in FIG. 58A yet modified with surcharging according to the principle of the invention, and FIG. 58C is a pressure vs. volume (P-V) plot of the same four stroke diesel engine plotted in FIG. 58A yet modified with surcharging and supraignition according to the principle of the invention. Clearly, the plots in FIGS. 58B and 58C each represents a clearly more efficient combustion cycle as compared to the prior art plot of FIG. 58A. Again, surcharging, like supraignition, resulted in over 60% fuel savings, peak pressure and temperature reduction and power increase, without loss of torque, and results in over 99% reduction in polluting exhaust gas emission and in some engine efficiency increase.

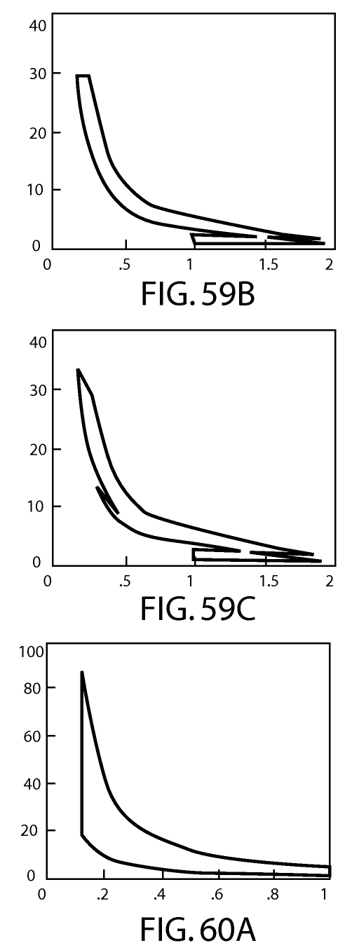

As a matter of illustration and reference, FIG. 59A is a prior art pressure vs. volume (P-V) plot of the combustion cycle of a conventional two stroke diesel engine in which the volume (V) is normalized to full cylinder volume and P is scaled in atmosphere, whereas FIG. 59B is a pressure vs. volume (P-V) plot of the same two stroke diesel engine plotted in FIG. 59A yet modified with surcharging according to the principle of the invention, and FIG. 59C is a pressure vs. volume (P-V) plot of the same two stroke diesel engine plotted in FIG. 59A yet modified with surcharging and supraignition according to the principle of the invention. Clearly, the plots in FIGS. 59B and 59C each represents a clearly more efficient combustion cycle as compared to the prior art plot of FIG. 59A. Again, surcharging, like supraignition, resulted in over 60% fuel savings, peak pressure and temperature reduction and power increase, without loss of torque, and results in over 99% reduction in polluting exhaust gas emission and in some engine efficiency increase.

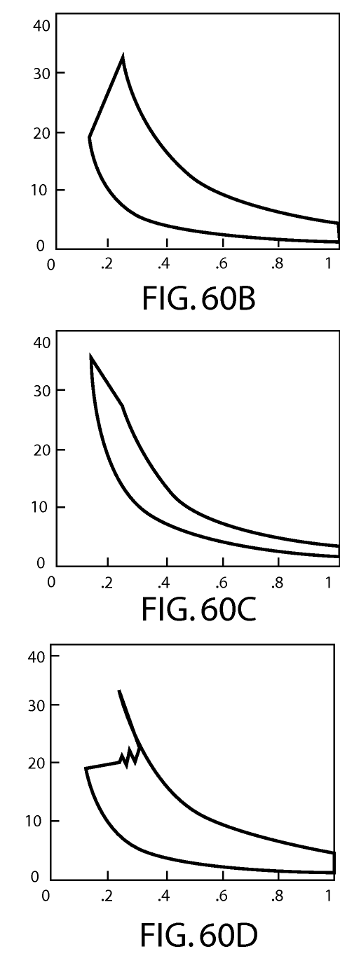

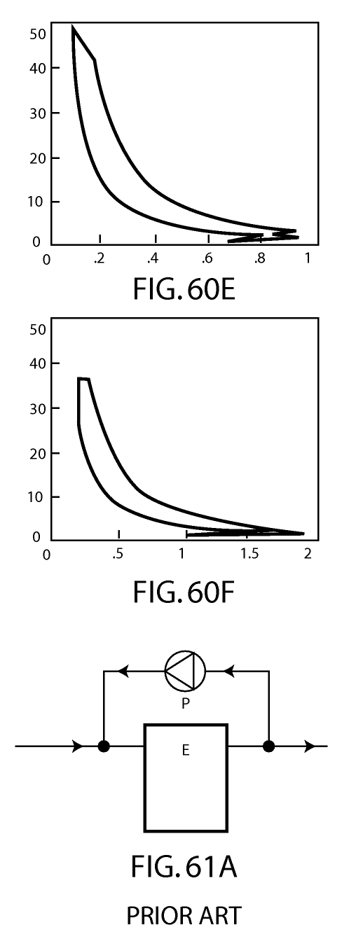

As a matter of illustration and reference, FIG. 60A is a prior art pressure vs. volume (P-V) plot of the combustion cycle of a conventional four stroke petrol engine in which the volume (V) is normalized to full cylinder volume and P is scaled in atmosphere, whereas FIG. 60B is a pressure vs. volume (P-V) plot of the same four stroke petrol engine plotted in FIG. 60A yet modified with surcharging according to the principle of the invention, FIG. 60C is a pressure vs. volume (P-V) plot of the same four stroke petrol engine plotted in FIG. 60A yet modified with supraignition and one shot of fuel injection into the ignition chamber according to the principle of the invention, FIG. 60D is a pressure vs. volume (P-V) plot of the same four stroke petrol engine plotted in FIG. 60A yet modified with supraignition and multiple shots of fuel injection into the ignition chamber according to the principle of the invention, FIG. 60E is a pressure vs. volume (P-V) plot of the same four stroke petrol engine plotted in FIG. 60A yet modified with surcharging and supraignition according to the principle of the invention, and FIG. 60F is a pressure vs. volume (P-V) plot of the same four stroke petrol engine plotted in FIG. 60A yet modified with surcharging and duel or mixed ignition. Clearly, the plots in FIGS. 60B-60F each represents a clearly more efficient combustion cycle as compared to the prior art plot of FIG. 60A. Again, surcharging, like supraignition, resulted in the present examples in approximately 33-66% fuel savings, and over 99% reduction in polluting emissions without loss in power, torque or engine efficiency. Pressure, temperature, noise and engine wear are also reduced. Although not illustrated, the benefits of engine modifications are similar for 2-stoke Otto engines.

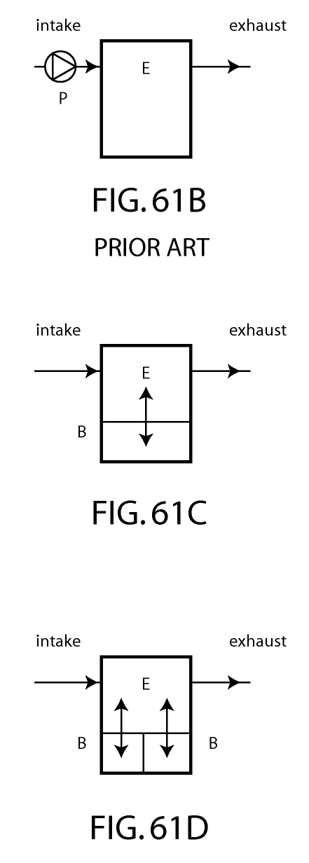

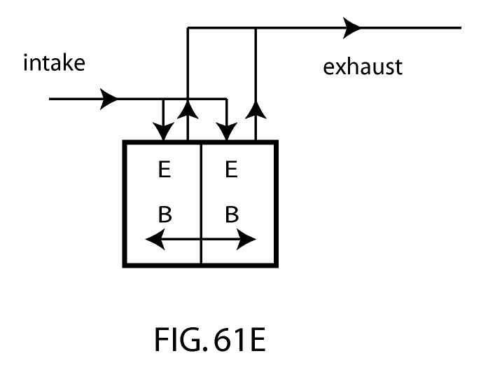

FIG. 61A is a prior art diagrammatic representation of an internal combustion engine with turbocharging, FIG. 61B is a prior art diagrammatic representation of an internal combustion engine with supercharging according to the principle of the invention, FIG. 61C is a diagrammatic representation of an internal combustion engine modified with an internal buffer for use in surcharging and supraignition in accordance with the principle of the invention, FIG. 61D is a diagrammatic representation of an internal combustion engine modified with internal buffers for use in surcharging and supraignition in accordance with the principle of the invention, and FIG. 61E is a diagrammatic representation of an internal combustion engines each having an internal buffer for use in surcharging and supraignition in accordance with the principle of the invention, whereby the engines are buffers to one another. The engines diagrammed in FIGS. 61A-61E are generally representative of two and four stroke internal combustion engines. In FIGS. 61A-61E, circled triangles represent gas pumps, label E identifies engines, label P identifies pumps, label B identifies buffers or buffer chambers, and intake gas and exhaust gas are spelled out and their directions of flow are indicated by arrows.

In FIG. 61A, an exhaust gas return line is formed with a pump, which is driven by the exhaust gas pressure and boosts the intake pressure as well as dilutes intake gas. The pump is a turbine with common shaft with a compressor or blower. The exhaust gas drives the turbine, which powers the compressor. The turbine and the compressor are isolated, so the exhaust gas does not communicate with the intake gas. However, through a bypass line, some of the exhaust gas is allowed to re-circulate to the engine if the system is so configured. The amount of exhaust gas return is controlled by a vacuum or flap valve. Since the exhaust pressure needs to overcome a threshold pressure to dive the turbine and the compressor, turbochargers have an inconvenient turbo-lag. Turbocharging is external to the engine, i.e., to the engine block or cylinder block, and harvests exhaust gas pressure. Depending on the configuration it may also harvest exhaust gas for diluting combustion to reduce polluting emissions. The turbo pump thus does not scavenge engine power. The engine remains intact, unmodified.

In FIG. 61B, a pump is associated with an intake line to boost the intake gas pressure. The pump is driven by the engine and thus it scavenges engine power. Supercharging is also external to the engine, leaving the engine intact or unmodified. Some supercharged engines recycle some portion of the exhaust gas via a bypass line, which forms a control valve. Such exhaust gas return superchargers are rare however. When a blower or air pump is used in the intake line of a two stroke engine, it does not boost charge pressure, because in such engines the intake and exhaust is concurrent or greatly overlapping. Instead, such a blower assists in speeding up and completing scavenging at around atmospheric pressure and thus such engine is not considered to be supercharged. Supercharged engines have no turbo-lag.

Both turbo and supercharging as illustrated in FIGS. 61A and 61B, respectively, increases charge pressure and thereby intake air density, raising the volumetric efficiency of the engine and only thereby boosting the power to engine weight ratio without resulting in any fuel savings.

In FIG. 61C there is an internal buffer for either surcharging or supraignition. A portion of the exhaust gas is retained in the buffer and at some point of the compression or combustion processes let to communicate with the engine's ignition gas charge. Surcharging and supraignition are thus internal to the engine, i.e., to the engine block or cylinder block, leaving the intake and exhaust intact or unmodified. Surcharging boosts and supraignition—depending on configuration—boosts or drops compressed gas pressure inside the engine, without adding more air for combustion. However, both allow decreasing compression ratio by adding more dead volume and thereby both increases volumetric efficiency, resulting in boosting the power to engine weight ratio without resulting in any fuel savings thereof. However, great fuel saving is achieved by the reduced need to increase pressure by fuel burning due to the pressure boosted by such buffering.

In FIG. 61D, there are two internal buffers or buffer chambers, one of which is used in surcharging and the other of which is used in supraignition. Again, the buffering and the exhaust gas return are internal to the engine and the benefits are the same as described above.

In FIG. 61E, the engines each have an internal buffer for use in surcharging and supraignition in accordance with the principle of the invention, whereby the engines are buffers to one another. Again, the buffering and the exhaust gas return are internal to the engine and the benefits are the same as described above.

While the always present dead volume and intake and exhaust valve timing overlap re-circulates some exhaust gas, this marginal exhaust gas return is considered natural to an engine and such engine is not called an exhaust gas return assisted engine. When no external boost is given to the intake gas by turbo or supercharging, the engine is considered naturally aspirated. Surcharged and supraignited engines are also naturally aspirated engines. However, a supercharger compressor can boost intake pressure of 4-stroke engines and blowers can assist in scavenging of 2-stroke engines with surcharging or supraignition. Since buffering results in high internal exhaust gas return rate, turbo-charging is redundant and may be even counterproductive in these exemplary engines with internal modifications by buffering.

In summary, the following 19 new technologies (NT) have been disclosed as selective components of the proposed Kemeny engines: a) ported bypass surcharging (PPSC), b) valved bypass surcharging (VPSC), c) ported buffer surcharging (PBSC), d) valved buffer surcharging (VBSC), e) bypass volume jet ignition (PVJI), f) buffer-volume jet ignition (BVJI), g) in-bypass fuel-injection (PFI), h) in-buffer fuel-injection (BFI), i) in-bypass water-injection (PWI), j) in-buffer water-injection (BWI), k) volume-adjusted buffering (VAB), l) relief buffering (RB), m) volume-adjusted relief-buffering (VARB), n) choked buffering (CB), o) throttled buffering (TB), p) pressurized elastic buffering (EB), and q) sweating-smoldering fueling (SF), r) ignition gas ionizing (IGI), s) rotary sleeve valve stacking (RSVS). The engines are modifications of the 4-stroke Diesel or the Otto engines. NT a-f are basic and g-s are auxiliary.

The present invention is described above with reference to a preferred embodiment. However, those skilled in the art will recognize that changes and modifications may be made in the described embodiment without departing from the nature and scope of the present invention. For instance, fuel and/or water injection can be added to the relief buffer vessel or can accompany relief buffering by direct injection into the cylinder. Also, spark plug or hot rod or other means of startup ignition can be configured into any Kemeny engines. Also, the bypass valves can be replaced with electro-hydraulic valves, piezoelectric valves, solenoid valves, desmodromic valves, or other valves, without deviating from the teachings of this invention. Also, while the injection water is proposed as consumable, condensing it and recapturing at least in part is considered intuitive and therefore instructive over the teachings of this invention. Also, adding setscrew to buffer spring assist is considered instructive. Also, that one can rigidly fix a second disc to a spring loaded poppet valve, so that the ignition gas pushes against it and pushes it into a socket recessed into the upper wall of the ignition chamber, thereby preventing the ignition gas pushing the valve back towards the cylinder, when the cylinder pressure drops near to atmospheric. Finally, while the piston positions are called out relative to plumb line as up or down, one can see that any spatial orientation is equally valid.

Various further changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. In first and second cylinder assemblies of an internal combustion engine each to repeatedly carry out a combustion cycle including intake, compression, combustion, and exhaust processes, improvements therein comprising a surcharging system comprising the first cylinder assembly coupled to the second cylinder assembly in gaseous communication to apply a charge of exhaust gas produced from a first combustion cycle of the first cylinder assembly to a compression process of a second combustion cycle of the second cylinder assembly.

2. The improvements according to claim 1, further comprising means isolating the first cylinder assembly from the second cylinder assembly in the exhaust process of the first cylinder assembly and the compression process of the second cylinder assembly.

3. The improvements according to claim 2, wherein the means consists of at least one valve formed between the first and second cylinder assemblies movable between a first position permitting application of the charge of exhaust gas produced from the first combustion cycle of the first cylinder assembly to the compression process of the second combustion cycle of the second cylinder assembly, and a second position isolating the first cylinder assembly from the second cylinder assembly in the exhaust process of the first cylinder assembly and the compression process of the second cylinder assembly.

4. The improvements according to claim 1, further comprising a fuel injection system to inject ignition gas into the second cylinder assembly.

5. The improvements according to claim 1, further comprising a water injection system to inject water into the second cylinder assembly.

6. In first and second cylinder assemblies of an internal combustion engine each to repeatedly carry out a combustion cycle including intake, compression, combustion, and exhaust processes, improvements therein comprising a supraignition system comprising the first cylinder assembly coupled to the second cylinder assembly in gaseous communication to apply a charge of ignition gas from the first cylinder assembly produced during a first combustion cycle of the first cylinder assembly to a compression process of a second combustion cycle of the second cylinder assembly.

7. The improvements according to claim 6, further comprising means isolating the first cylinder assembly from the second cylinder assembly in the combustion process of the second cylinder assembly.

8. The improvements according to claim 7, wherein the means consists of at least one valve formed between the first and second cylinder assemblies movable between a first position permitting application of the charge of ignition gas from the first cylinder assembly produced during the first combustion cycle of the first cylinder assembly to the compression process of the second combustion cycle of the second cylinder assembly, and a second position isolating the first cylinder assembly from the second cylinder assembly in the combustion process of the second cylinder assembly.

9. The improvements according to claim 6, further comprising a fuel injection system to inject ignition gas into the second cylinder assembly.

10. The improvements according to claim 6, further comprising a water injection system to inject water into the second cylinder assembly.

11. In a cylinder assembly of an internal combustion engine to repeatedly carry out a combustion cycle including intake, compression, combustion, and exhaust processes, improvements therein comprising a buffer surcharging system comprising a buffer vessel coupled in gaseous communication with the cylinder assembly to receive and retain a charge of exhaust gas produced from a first combustion cycle of the first cylinder assembly, and apply the retained charge of exhaust gas to the compression process of a second combustion cycle of the cylinder assembly.

12. The improvements according to claim 11, further comprising a fuel injection system to inject ignition gas into the cylinder assembly.

13. The improvements according to claim 11, further comprising a water injection system to inject water into the cylinder assembly.

14. The improvements according to claim 11, further comprising a fuel injection system to inject ignition gas into the buffer vessel.

15. The improvements according to claim 11, further comprising a water injection system to inject water into the buffer vessel.

16. The improvements according to claim 11, further comprising the buffer vessel bounding a volume, and a buffer closure piston adjustably mounted with the buffer vessel to adjust the volume of the buffer vessel.

17. The improvements according to claim 11, further comprising a valve formed between the buffer vessel and the cylinder assembly movable between a first position coupling the buffer vessel in gaseous communication with the cylinder assembly and a second position isolating the buffer vessel from the cylinder assembly.

18. In a cylinder assembly of an internal combustion engine repeatedly carry out a combustion cycle including intake, compression, combustion, and exhaust processes, improvements therein comprising a supraignition buffer system comprising a buffer vessel coupled to the cylinder assembly in gaseous communication to receive and retain a charge of ignition gas of high pressure and temperature produced from a first combustion cycle of the cylinder assembly, and apply the retained charge of ignition gas to the combustion process of a second combustion cycle of the cylinder assembly.

19. The improvements according to claim 18, further comprising a fuel injection system to inject ignition gas into the cylinder assembly.

20. The improvements according to claim 18, further comprising a water injection system to inject water into the cylinder assembly.

21. The improvements according to claim 18, further comprising a fuel injection system to inject ignition gas into the buffer vessel.

22. The improvements according to claim 18, further comprising a water injection system to inject water into the buffer vessel.

23. The improvements according to claim 18, further comprising the buffer vessel bounding a volume, and a buffer closure piston adjustably mounted with the buffer vessel to adjust the volume of the buffer vessel.

24. The improvements according to claim 18, further comprising a valve formed between the buffer vessel and the cylinder assembly movable between a first position coupling the buffer vessel in gaseous communication with the cylinder assembly and a second position isolating the buffer vessel from the cylinder assembly.
